(19) United States
(12) Patent Application Publication
(10) Pub. No.: US 2008/0057336 A1
(43) Pub. Date: Mar. 6, 2008

(54) Surface-Treated Metal Materials, Method of Treating the Surfaces Thereof, Resin-Coated Metal Materials, Cans and Can Lids

(75) Inventors: Wataru Kurokawa, Yokohama-shi (JP); Hiroshi Matsubayashi, Yokohama-shi (JP); Mitsuhide Aihara, Yokohama-shi (JP); Shigeya Takahashi, Yokohama-shi (JP); Masanobu Matsubara, Yokohama-shi (JP); Masatoshi Ishida, Kudomatsu-shi (JP); Norimasa Maida, Kudomatsu-shi (JP)

Correspondence Address: SUGHRUE MION, PLLC, 2100 PENNSYLVANIA AVENUE, N.W., SUITE 800, WASHINGTON, DC, 20037, US

(73) Assignees: TOYO SEIKAN KAISHA, LTD, Chiyoda-ku (JP); TOYO KOHAN CO,, LTD., Chiyoda-ku (JP)

(21) Appl. No.: 11/571,133

(22) PCT Filed: Jun. 22, 2004
(86) PCT No.: PCT/JP05/11877

§ 371 Date: Dec. 21, 2006

(30) Foreign Application Priority Data
Jun. 22, 2004 (JP) 2004-183516
Jun. 22, 2004 (JP) 2004-183544

(51) Int. Cl. B32B 15/20; C25D 3/54

(52) U.S. Cl. 428/639; 205/261

(57) ABSTRACT

A surface-treated metal material having, formed on the surface of a metal base member, an inorganic surface-treating layer that contains inorganic components or, further, having an organic surface-treating layer formed on the inorganic surface-treating layer, the inorganic surface-treating layer containing at least M (M is at least one of Ti, Zr or Al), O and F. The organic surface-treating layer comprises a silane coupling agent containing Si in an amount of 0.8 to 30 mg/m² or a phenol-type water-soluble organic compound. The surface treatment without using chromium can be applied to various metal base members featuring excellent environmental friendliness, excellent resistance against discoloration even when applied to tin-plated steel plates, and offering excellent characteristics such as the close adhesion to the organic resin coating, adhesive property, corrosion resistance and dent resistance. Owing to the cathodic treatment in an aqueous solution, further, the surface-treated metal material can be produced at a high speed, easily and at a low cost.

### TECHNICAL FIELD

The present invention relates to surface-treated metal materials and to a method of treating the surfaces thereof. More specifically, the invention relates to surface-treated metal materials which do not use chromium featuring excellent environmental friendliness and having excellent properties such as close adhesion to an organic resin coating, adhesive property, corrosion resistance, dent resistance and wear resistance, to a method of treating the surfaces of the surface-treated metal materials, to resin-coated metal materials obtained by coating the surface-treated metal materials with a resin, to metal cans and can lids formed by using these resin-coated metal materials.

### BACKGROUND ART

There have heretofore been known a chromate treatment, a phosphate treatment, a treatment with a silane coupling agent and an anodic oxidation treatment as treatments for improving close adhesion of an organic film to metal materials such as steel sheet, zinc-plated steel sheet, aluminum-plated steel sheet, zinc alloy sheet, tin-plated steel sheet, aluminum foil, aluminum alloy sheet and magnesium alloy sheet, and as treatments for joining a metal material to a metal material of the same kind or of a different kind by using an adhesive.

The metal materials utilizing these treatments have been widely used in such fields as household electric appliances, building materials, vehicles, aircraft and containers. Among them, those treated with chromate have been most widely used owing to their excellent corrosion resistance and close adhesion.

From the standpoint of treating methods, the chromate treatments can be roughly divided into those of the formation type (reaction type, application type) and those of the electrolytic type. From the standpoint of the formed coatings, on the other hand, the chromate treatments can be roughly divided into those of the type which permit trace amounts of hexavalent chromium to remain in the final products to efficiently utilize the self-restoring effect and those of the type that do not permit hexavalent chromium to remain in the final products.

Concerning the chromate treatments of the type that permit trace amounts of hexavalent chromium to remain in the final products, it has been pointed out that hexavalent chromium is highly probable to elute out into the environment such as the soil after the disposal. Therefore, it is the trend chiefly in European countries to ban the chromate treatments. Further, in the chromate treatments of either type, the treating solution contains hexavalent chromium which is a toxic substance arousing various environmental problems. Namely, it becomes necessary to perfectly treat the drain water of the hexavalent chromium-containing treating solution and the vented air thereof so will not to be drained to the exterior. Therefore, a huge sum of cost is necessary for constructing the facilities for treating the drain water and the vented air, and for the disposal treatment. Besides, the regulations have been tightened on transporting the sludge of drain water and on the vented air. Therefore, it has been urged to develop a non-chromium surface treatment to substitute for the traditional chromate treatments.

A metal sheet for metal containers has, as a matter of course, been subjected to the chromate treatment of the type that does not permit hexavalent chromium to remain in the final products and has, further, been coated with an organic resin or the like. For example, there have been used a tin-plated steel sheet which is subjected to the cathodic electrolysis in an aqueous solution of sodium dichromate, a steel sheet which is subjected to the cathodic treatment in a fluoride-containing aqueous solution of anhydrous chromic acid, and an aluminum alloy which is treated with the chromic phosphate is further coated with an organic resin.

As a non-chromium surface treatment for a metal sheet of the type of aluminum alloy, a coating has, in practice, been formed comprising chiefly an oxide of zirconium and/or titanium on the surface by using an acidic treating solution containing zirconium, titanium or a compound thereof as well as phosphate and a fluoride and having a pH of about 1.0 to 4.0. There has further been placed in practical use the non-chromium surface treatment without at all forming the coating depending upon the compatibility with the organic resin (see JP-A-52-131937).

In recent years, a precoated material coated with a polyester resin has been widely used from the standpoint of sanitation of the metal containers and flavor-retaining property. When the polyester resin is used, however, water permeates through as compared with the conventionally used epoxyphenol coating or the acrylic epoxy coating. Besides, the precoating of the polyester resin imposes limitation on the content concerning close adhesion and Corrosion resistance unless the chromate treatment is conducted. Further, when aluminum coated with the polyester resin is used as an aluminum lid material, there still remains a problem in that adhesion is not satisfactory despite the chromate treatment is effected.

That is, the cans and can lids coated with the polyester resin, which are examples of the worked products of precoated materials, offer an advantage of utilizing the precoated metal sheet as a starting material accompanied, however, by such problems as a decrease in the close adhesion of the polyester resin at the highly worked portions such as can wall portions and score portions of can lids, corrosion starting with the portions where the polyester resin is cracked due to a shock such as when the can has fallen, a decrease in the close adhesion during the retort sterilization, and inducing corrosion due to permeation of ions depending upon the components of the content though the polyester coating itself has no defect, which are different from the problems of the traditional production method according to which the surfaces were treated after the can has been formed, and were post-coated with the coating material.

On the other hand, metal lids such as can lids are, so far, using a precoated material obtained by coil-coating the coating material. From the standpoint of retaining flavor of the content and sanitation, however, studies have been vigorously conducted in an attempt to utilize the precoated material which is coated with the polyester resin. Easy-to-open can lids coated with the polyester resin permit the occurrence of delamination, i.e., exfoliation of the resin from the metal near the score opening due to a decrease in the adhesion to the polyester resin and drawing of the resin, i.e., feathering of the resin at the opening being induced thereby. In particular, the can lid immediately after the retort sterilization is accompanied by a problem of defective opening due to a decrease in the adhesion to the resin.

From the above point of view, there have further been proposed non-chromium surface treatments of the aluminum alloy-type metal sheets, such as a method of forming an organic/inorganic composite coating containing an organic compound using carbon as a chief component, a phosphorus compound and a zirconium or titanium compound (JP-A-11-229156), a method of forming a surface-treating layer chiefly comprising an inorganic material on the surface of an aluminum base member and forming thereon an organic surface-treating layer comprising chiefly an aqueous phenol resin (JP-A-2001-121648), and anodic oxidation treatments from the standpoint of chiefly using as lid members (JP-A-11-91034, JP-A-2002-266099, JP-A-2005-059471, JP-A-2005-059472). There have further been proposed treatments by using a polyacrylic acid and a zirconium compound (JP-A-06-322552 and a journal “Light Metals”, 1990, pp. 298-304).

There has been further proposed a method of forming a titanium oxide coating by effecting the electrolytic precipitation on a base sheet in an aqueous solution containing nitric acid ions, a peroxide and complexing agent and having a pH of larger than 3.0 (JP-A-11-158691).

On the other hand, many of the non-chromium surface treatments of the steel sheets have been proposed for the steel sheets for automobiles and steel sheets for household appliances, and studies have been conducted concerning vanadate coating, tungstate coating, zirconate coating, tannate coating and silicate coating (journal “Material Stage,”, 2004, Vol. 4, No. 7, pp. 4-38). Most of the non-chromium treatments for the steel sheets for containers are those using the tin-plated steel sheet as an underlying material. For example, there have been proposed a steel sheet coated with a layer of a silane coupling agent after the tin plating and a resin-coated steel sheet (JP-A-2002-113809, JP-A-2002-285354, JP-A-2003-231989, JP-A-2004-345214), a coating comprising chiefly any one of Ti, Mo or V and a substance stemming from phosphoric acid and/or a phosphate after having been plated with tin (JP-A-2001-73185), and a method of forming a composite oxide film of tungsten and tin by subjecting a base member of tin to a cathodic periodical electrolysis in a sodium tungstate solution (journal “Thin Solid Films”, 72, 2, 1980, pp. 237-246). As a non-chromium treatment that can be applied to the aluminum sheet as well as to the steel sheet and that can be utilized for the containers, there has been proposed a surface-treated metal material containing Zr, O and F as chief components but without containing phosphoric acid ions (JP-A-2005-97712).

### DISCLOSURE OF THE INVENTION

According to the method of forming an organic/inorganic composite coating containing an organic compound having carbon as a chief component, a phosphorus compound and a zirconium or titanium compound, the close adhesion improves to some extent but the corrosion resistance is not sufficient. According to the method of forming a surface-treating layer comprising chiefly an inorganic material on the surface of the aluminum base material and forming an organic surface-treating layer comprising chiefly an aqueous phenol resin thereon, the close adhesion and corrosion resistance are both improved to some extent accompanied, however, by such problems as an increased number of steps and complex treatment of waste liquor after the chemical solution was used.

According to the method that utilizes the anodic oxidation treatment, further, the primary close adhesion is favorable but the close adhesion drops due to the retort sterilization treatment after the food or the beverage is packed. Besides, there remain such problems as an increased cost for the heat-exchanging facility for cooling the treating solution and for a power source of a large capacity, and requiring a high running cost consuming large amounts of electric power for the treatment.

Further, when the thickness of the base member itself is small like an aluminum foil, the base member dissolves during the anodic oxidation treatment or the anodic oxide film which can be poorly worked occupies an increased proportion causing a decrease in the flexibility of the foil.

In treating the aluminum material with a polyacrylic acid and a zirconium compound, the formed coating is an organic/inorganic composite coating, and the treating method is basically the application-type treatment, leaving a problem with respect to wettability and close adhesion to the metallic base member during the high-speed treatment.

Further, many of the prior arts use metal sheets which are limited to aluminum alloy sheets, and are not capable of solving the problems of metal materials as a whole.

When the titanium oxide coating is formed by the cathodic electrolysis as disclosed in the above JP-A-11-158691, the coating can be formed at a higher speed than that of the conventional formation treatment developing, however, the polarization of concentration near the cathode. As a result, therefore, the precipitation is impaired making it difficult to efficiently form the titanium oxide coating.

A conventional method of forming Al₂O₃ or ZrO₂ on the surface of the metal material by PVD or CVD can be employed from the standpoint of treating a variety kinds of materials. However, the above method must establish a vacuum condition requiring an increased facility cost and, besides, making it difficult to conduct the treatment at a high speed resulting in a further increased cost. It is, further, difficult to maintain the close adhesion between the metal sheet and the treated film or to maintain the corrosion resistance after the working. Similarly, even by using the method of forming an oxide film by heat-drying after the organic zirconium compound is applied by the wet method, it is difficult to maintain the close adhesion between the metal sheet and the treated film or to maintain the corrosion resistance after the working.

The surface treatment comprising Zr, O and F as chief components but without containing phosphoric acid ions, can be used for both the aluminum sheet and the steel sheet. When applied to the tin-plated steel sheet, however, a tin oxide film readily grows causing discoloration accompanying the passage of time after the treatment and due to heating.

It is, therefore, an object of the present invention to provide a surface-treated metal material which does not use chromium featuring excellent environmental friendliness, which can be applied to various materials features excellent discoloration resistance even when the metal material is a tin-plated steel sheet and, further, featuring excellent properties such as the close adhesion to an organic resin coating, adhesive property, corrosion resistance and dent resistance, and a method of treating the surfaces of the above surface-treated metal materials.

Another object of the present invention is to provide a method of treating the surfaces easily and at a decreased cost relying upon a high-speed treatment using an aqueous solution.

A further object of the present invention is to provide metal cans and can lids featuring excellent close adhesion, corrosion resistance and dent resistance resulting from the use of a resin-coated metal material obtained by coating the above surface-treated metal material with an organic resin and, particularly, a polyester resin.

A still further object of the present invention is to provide a method of treatment which forms a coating comprising chiefly Al and O, and can be utilized for iron and aluminum which are metals much used as structural materials, featuring excellent environmental friendliness from the standpoint of both quality and quantity.

According to the present invention, there is provided a surface-treated metal material having, formed on the surface of a metal base member, a surface-treating layer that contains inorganic components, the inorganic surface-treating layer containing at least Ti, O and F but without containing phosphoric acid ions.

In the surface-treated metal material according to a first aspect of the invention, it is desired that:

### 1. The surface-treating layer contains Zr;

### 2. The atomic ratio of P and M (M is Ti or Ti and Zr) contained in the most surface portion of the surface-treating layer is 0≦P/M<0.6;

### 3. The atomic ratio of O and M (M is Ti or Ti and Zr) contained in the most surface portion of the surface-treating layer is 1<O/M<10; and

### 4. The atomic ratio of F and M (M is Ti or Ti and Zr) contained in the most surface portion of the surface-treating layer is 0.1<F/M<2.5.

According to the present invention, there is provided a surface-treated metal material having, formed on the surface of a metal base member, a surface-treating layer that contains inorganic components, the inorganic surface-treating layer containing at least Ti and/or Zr, O and F and, further containing SiO₂ particles but without containing phosphoric acid ions.

According to the present invention, there is provided a surface-treated metal material having, formed on the surface of a metal base member, a surface-treating layer (A) that contains inorganic components and an organic surface-treating layer (B) that contains organic components, the inorganic surface-treating layer (A) containing M (M is Ti and/or Zr), O and F.

In the surface-treated metal material according to a third aspect of the invention, it is desired that:

### 1. The inorganic surface-treating layer (A) contains no phosphoric acid ion;

### 2. The atomic ratio of P and M (M is Ti and/or Zr) contained in the most surface portion of the inorganic surface-treating layer (A) is 0≦P/M<0.6;

### 3. The atomic ratio of O and M (M is Ti and/or Zr) contained in the most surface portion of the inorganic surface-treating layer (A) is 1<O/M<10;

### 4. The atomic ratio of F and M (M is Ti and/or Zr) contained in the most surface portion of the inorganic surface-treating layer (A) is 0.1<F/M<2.5;

### 5. The inorganic surface-treating layer (A) contains SiO₂ particles;

### 6. The organic surface-treating layer (B) is a silane coupling agent treating layer containing Si in an amount of 0.8 to 30 mg/m²; and

### 7. The organic surface-treating layer (B) is an organic surface-treating layer comprising a phenol-type water-soluble organic compound.

According to the present invention, there is provided a method of treating the surfaces of a metal base member by forming an inorganic coating on the surfaces of the metal base member by the cathodic treatment in an aqueous solution containing Ti and F, and having a phosphoric acid ion concentration calculated as PO₄ of smaller than 0.003 mols/liter.

According to a first method of treating the surfaces of the invention, it is desired that:

### 1. The aqueous solution contains Zr;

### 2. The aqueous solution contains M (M is Ti or Ti and Zr) in an amount of 0.010 to 0.050 mols/liter and F in an amount of 0.03 to 0.35 mols/liter as bath concentrations;

### 3. The aqueous solution contains water-dispersing silica; and

### 4. The cathodic treatment is intermittently conducted.

According to the present invention, further, there is provided a method of treating the surfaces of a metal base member by forming an inorganic coating on the surfaces of the metal base member by the cathodic treatment in an aqueous solution containing Zr, F and water-dispersing silica, and having a phosphoric acid ion concentration calculated as PO₄ of smaller than 0.003 mols/liter.

According to a second method of treating the surfaces of the invention, it is desired that:

### 1. The aqueous solution contains Zr in an amount of 0.010 to 0.050 mols/liter and Fin an amount of 0.03 to 0.35 mols/liter as bath concentrations; and

### 2. The cathodic treatment is intermittently conducted.

According to the present invention, there is further provided a surface-treated metal material having, formed on the surface of a metal base member (excluding the case when the metal base member is Al), an inorganic surface-treating layer that contains at least Al and O.

In the surface-treated metal material according to a fourth aspect of the present invention, it is desired that:

### 1. The inorganic surface-treating layer contains a hydroxide of aluminum or an oxyhydroxide thereof;

### 2. The inorganic surface-treating layer contains at least one of Zr or Ti;

### 3. The atomic ratio of O and M (M is Al or Al and at least one of Ti or Zr) contained in the most surface portion of the inorganic surface-treating layer is 1<O/M<5.5;

### 4. The atomic ratio of F and M (M is Al or Al and at least one of Ti or Zr) contained in the most surface portion of the inorganic surface-treating layer is F/M<2.5;

### 5. The atomic ratio of (P+S) and M (M is Al or Al and at least one of Ti or Zr) contained in the most surface portion of the inorganic surface-treating layer is (P+S)/M<0.25;

### 6. The inorganic surface-treating layer has a thickness, calculated as a weight film thickness of Al, of 5 to 100 mg/m²;

### 7. The metal base member is a surface-treated steel sheet having a plated layer containing one or more of tin, nickel, zinc and iron;

### 8. The metal base member has a surface exposure ratio of chief elements of smaller than 5%;

### 9. An organic surface treating layer comprising chiefly a silane coupling agent is formed in an amount calculated as Si of 0.8 to 30 mg/m² on the inorganic surface-treating layer; and

### 10. An organic surface-treating layer comprising chiefly a phenol-type water-soluble organic compound is formed on the inorganic surface-treating layer.

According to the present invention, there is further provided a surface-treated metal material having an inorganic surface-treating layer formed on the surface of a metal base member relying upon the precipitation from an aqueous solution by cathodic electrolysis, the inorganic surface-treating layer containing at least Al, O and F, and the atomic ratio of F and M (M is Al or Al and at least one of Ti or Zr) contained in the most surface portion of the inorganic surface-treating layer being 0.1<F/M.

According to the present invention, there is further provided a method of treating the surfaces of a metal base member by forming a coating containing a hydroxide of aluminum or an oxyhydroxide thereof on the surface of the metal base member by the cathodic treatment in an aqueous solution having an Al ion concentration in a range of 0.001 to 0.05 mols/liter. According to the third method of treating the surfaces, it is desired that the aqueous solution contains F ions.

According to the present invention, further, there is provided a resin-coated metal material obtained by coating at least one surface of a surface-treated metal material with an organic resin, the surface-treated metal material having, formed on the surface of a metal base member, an inorganic surface-treating layer containing Ti and/or Al, O and F. In the resin-coated metal material of the first aspect, the inorganic surface-treating layer may further contain Zr.

According to the present invention, there is further provided a resin-coated metal material obtained by coating at least one surface of a surface-treated metal material with an organic resin, the surface-treated metal material having an inorganic surface-treating layer containing at least any one of Ti, Zr or Al, as well as O and F, and having an organic surface-treating layer comprising chiefly a silane coupling agent formed in an amount, calculated the amount of Si, of 0.8 to 30 mg/m² on the inorganic surface-treating layer or having an organic surface-treating layer comprising chiefly a phenol-type water-soluble organic compound formed on the inorganic surface-treating layer.

According to the present invention, there are provided a metal can and a can lid formed by using the above resin-coated metal material.

According to the formation treatment and the anodic oxidation treatment which are the conventional methods of treating the surfaces of metal materials, sulfuric acid ions and phosphoric acid ions tend to be contained in the film due to the mechanism of forming the coating, and become constituent components in the formation treatment. It has been known that anions having large ionic radii such as anions in the film and, particularly, phosphoric acid ions tend to elute out under high-temperature and high-humidity conditions such as in the retort sterilization treatment. Anions that elute out from the coating cause a decrease in the close adhesion and adhesive property of the resin coating formed on the surface-treated metal material.

According to the present invention, the amount of ions, particularly, phosphoric acid ions and sulfuric acid ions in the inorganic surface-treating layer is controlled, or the atomic ratio of (P+S)/(Ti+Zr+Al) is controlled to effectively suppress the elution of anions from the treated coating even when subjected to the retort sterilization or even when preserved under high-temperature and high-humidity conditions. This effectively prevents a decrease in the close adhesion and adhesive property of the resin coating.

In the surface-treated metal material of the present invention, further, the inorganic surface-treating layer contains M (where M is at least any one of Ti, Zr Cr Al), O and F as chief constituent components making it possible to maintain the surface state of the treated layer and to maintain stability on the surface even under high-temperature and high-humidity environmental conditions. As a result, the corrosion resistance is maintained while suppressing a decrease in the close adhesion or adhesive property of the resin coating.

That is, when the inorganic surface-treating layer contains M and O as chief constituent components but does not contain F, it is presumed that the treating film has a structure MOx(OH)y.

Under high-temperature and high-humidity conditions, however, the hydroxyl groups are likely to be hydrated inducing a change in the structure of the treating layer to adversely affect various properties. When F is contained in a suitable amount, however, the hydroxyl groups are at least partly substituted with F to form a stable structure like MOx(OH)y-zFz, suppressing a change in the structure of the treating layer in a high-temperature and high-humidity environment and maintaining further improved stability on the surface.

According to the present invention, if the most surface portion of the inorganic surface-treating layer is analyzed by the X-ray photoelectric spectrometry (XPS) that will be described later, peaks N1s or F1s, S1s and P1s are often detected. This means the presence of anionic components such as of nitric acid, fluorine, sulfuric acid and phosphoric acid. From the results of analysis, it has been known that phosphoric acid ions and sulfuric acid ions are easily taken in by the coating components and, particularly, phosphoric acid is present in large amounts. In preparing the treating bath, therefore, it is desired to give attention such as decreasing the ratio of the phosphoric acid-type agent and mixing other agents. According to the present invention as described above, phosphoric acid ions and sulfuric acid ions which are anions having large ionic radii are controlled to effectively suppress the elution of ions from the treated coating even when subjected to the retort sterilization or preserved under high-temperature and high-humidity conditions and, therefore, effectively preventing a decrease in the close adhesion or adhesive property of the resin coating.

In the surface-treated metal material of the present invention, further, it is desired that an organic surface-treating layer (B) and, particularly, an organic surface-treating layer (B-1) comprising chiefly a phenol-type water-soluble organic compound or a silane coupling agent treating layer (B-2) containing Si in an amount of 0.8 to 30 mg/m², is formed on the inorganic surface-treating layer (A).

The above inorganic surface-treating layer contributes chiefly to improving the corrosion resistance of the metal material while the organic surface-treating layer contributes chiefly to improving the close adhesion to the organic coating such as of a polyester resin. When these surface-treating layers are laminated in this order, excellent close adhesion to the organic resin coating and corrosion resistance are exhibited even when the metal can is subjected to severe working such as necking or riveting of the can lid.

When a container is formed by using the resin-coated metal material which has the silane coupling agent layer formed on the surface of the metal material and a polyester film formed on the phenol-type organic surface-treating layer, the most conspicuous effect is that in the step of heat-setting after forming, the silane coupling agent layer and the phenol-type organic surface-treating layer become compatible again with the polyester making it possible to obtain a re-adhering effect. That is, though the closely adhering force in the interface of the polyester and the metal drops due to the forming, the silane coupling agent layer and the phenol-type organic surface-treating layer become compatible with the polyester in the step of heat-setting without the need of heating to higher than the melting point of the polyester, and the closely adhering force is recovered.

If there is no inorganic surface-treating layer, it is difficult to suppress a change on the surface of the metal base member during the retorting, which is not desirable, either, from the standpoint of corrosion resistance. When there is formed the organic surface-treating layer comprising chiefly the phenol-type water-soluble organic compound or the silane coupling agent treating layer, there are obtained the effect for improving the close adhesion to the organic coating such as of a polyester resin and the effect for recovering the closely adhering force owing to the organic surface-treating layer, and the surface-treated metal material can be used even if anions having large ionic radii are eluted out under high-temperature and high-humidity conditions. It is, however, most desired that the inorganic surface-treating layer contains none of anions having large ionic radii, such as sulfuric acid ions or phosphoric ions, as a matter of course.

In the surface-treated metal material of the invention, further, the inorganic surface-treating layer may be formed on the organic surface-treating layer comprising chiefly the phenol-type water-soluble organic compound.

Since the closely adhering force is recovered by the above-mentioned mechanism, the inorganic surface-treating layer does not necessarily have to be under the organic surface-treating layer. Namely, it is considered that when the inorganic surface-treating layer is formed on the organic surface-treating layer, the organic surface-treating layer appears through those portions of the inorganic surface-treating layer that are cracked during the forming, and the same effect is exhibited at the time of heat-set. However, if the inorganic surface-treating layer is formed on the organic surface-treating layer, it becomes necessary to form by electrolysis the inorganic surface-treating layer that exhibits excellent close adhesion under wet condition. Therefore, the electric conduction of the underlying organic surface-treating layer plays an important role. Concerning this point, the electric conduction can be easily maintained by forming a thin film by treating the phenol-type organic surface-treating layer by using a formation-treating agent such as phosphoric acid or hydrofluoric acid. The silane coupling agent layer, however, is difficult to control its thickness and, besides, it fails to exhibit its performance to a sufficient degree if its thickness is small. As the organic surface-treating layer formed under the inorganic surface-treating layer, therefore, there can be suitably used an organic coating comprising chiefly the phenol-type water-soluble organic compound.

In this case, the most surface portion becomes the inorganic surface-treating layer. The interior of the surface-treating layer close to the metal base member, however, contains the inorganic treating layer that has electrolytically precipitated into defective portions in the organic surface-treating layer or onto the coating having a small thickness, forming a portion where organic and inorganic matters are mixed together. Therefore, the inorganic surface-treating layer covers defective portions in the organic surface-treating layer contributing to improving the corrosion resistance of the metal material. If the inorganic surface-treating layer in the surface is cracked due to the working, the underlying organic surface-treating layer works to improve the close adhesion to the organic coating such as of the polyester resin. Therefore, excellent working adhesion to the organic resin coating and excellent corrosion resistance of the inorganic treating layer are exhibited even when the surface-treated metal material is subjected to the severe working such as necking of metal cans and riveting of can lids.

When the metal cans and can lids are formed by using the surface-treated metal material of the invention or by using the resin-coated metal material which is obtained by coating the surface-treated metal material with an organic resin and, particularly, a polyester resin, the close working adhesion of the polyester resin coating is maintained at the highly worked portions, the corrosion resistance (dent resistance) is improved despite the polyester resin coating is cracked due to shocks, the close adhesion is improved during the retort sterilization owing to the use of the resin-coated metal material which features excellent close adhesion and corrosion resistance. Besides, the corrosion caused by permeating ions is suppressed, and the easy-to-open can lid can be opened in an improved manner.

According to the method of treating the surfaces of the present invention, it is important to conduct the cathodic treatment in an aqueous solution containing Ti and/or Zr and F, having a phosphoric acid ion concentration calculated as PO₄ of smaller than 0.003 mols/liter and, more preferably, without containing phosphoric acid ions, or to conduct the cathodic treatment in an aqueous solution having an Al ion concentration in a range of 0.001 to 0.05 mols/liter and, preferably, containing F ions.

Relying upon the cathodic treatment, the coating can be quickly formed and the range of controlling the coating thickness can be greatly broadened as compared to forming the coating by the reaction-type method. Thus, it becomes possible to form the coating that meets the use. According to the conventional formation treatment based on the chemical reaction of the treating solution composition, on the other hand, limitation is imposed on the rate of forming the coating and, therefore, the coating thickness is limited when the treatment is conducted at an increased rate. However, the cathodic treatment that utilizes the electrolytic reaction makes it possible to form the coating at an increased rate.

According to the formation treatment and the anodic oxidation treatment, further, sulfuric acid ions and phosphoric acid ions tend to be introduced into the coating due to the mechanism of forming the coating, and turn into constituent components if the formation treatment is employed making it difficult to control the amount of anions as described above.

On the other hand, the cathodic treatment makes it possible to select various aqueous solutions and to use an aqueous solution of a fluoride or nitrate and, therefore, to form a coating controlling the amount of anions having large ionic radii, such as sulfuric acid ions or phosphoric acid ions.

According to the formation treatment and anodic oxidation treatment, further, metal elements of base member that is to be treated tend to be introduced into the coating due to the mechanism of forming the coating, which turn into constituent components if the formation treatment of the reaction type is employed. Therefore, the composition solution must be studied for every base member and must often be greatly varied depending upon the cases. According to the cathodic treatment, on the other hand, the bath composition may be varied to a minimum degree, and a wide range of adjustment is realized depending upon the electrolytic conditions making it possible to treat a variety of base members.

That is, the present invention can be applied to even such surface-treated steel sheets as tin-plated steel sheet and zinc-plated steel sheet in addition to aluminum sheet and steel sheet. By applying the invention to, for example, the zinc-plated steel sheet and the tin-plated steel sheet, there can be obtained such synergistic effects as preventing the corrosion of zinc and tin, the close adhesion and the corrosion resistance in the non-chromium surface treatment. The invention is capable of treating various kinds of base members to provide surface-treated steel sheets that can be used in a wider range of applications. In particular, when Al and O are contained as chief components, the tin oxide film does not grow even when the tin-plated steel sheet is treated and the color does not change even after the passage of time from the treatment or even through the heating, and the thus treated steel sheet can be used for obtaining metal sheets and metal cans having the above-mentioned properties and for obtaining can lids, as a matter of course.

By conducting the same surface treatment, further, it is allowed to avoid such a problem as galvanic corrosion that is often reported when different kinds of metal sheets such as aluminum and steel are used in combination (e.g., a combination of an aluminum lid and a steel can wall of a metal can).

According to the method of treating surfaces of a metal material of the invention, further, it is desired to intermittently conduct the cathodic treatment. That is, the electrolysis is not continuously conducted but, instead, a halting time is provided on the way of electrolysis and the O/M ratio in the surface-treating layer is controlled to more increase the precipitation efficiency than when the electrolysis is continuously controlled in order to accomplish the treatment maintaining a high quality and an increased rate.

In the method of treating the surfaces of metal materials of the invention, further, the electrolysis is conducted while stirring the bath and, particularly, blowing bubbles containing oxygen onto the surface of the cathode at a rate of 20 to 300 ml/min-cm to thereby improve uniformity in the coating thickness and to obtain a uniformly precipitated state over whole cathode surface without irregularity. That is, by conducting the electrolysis while blowing oxygen-containing bubbles onto the surface of the cathode, local polarization of concentration is suppressed and, at the same time, the O/M ratio in the surface-treating layer is controlled by bubbles containing oxygen to accomplish a uniform treatment maintaining a high quality.

In the present invention, the inorganic surface-treating layer contains any one of Ti, Zr or Al as well as O and F as chief constituent components there, however, F may be arbitrarily used when the metal material is Al), but may contain any combination of Ti+Zr, Al+Zr, Al+Ti or Al+Zr+Ti as constituent components. That is, they are capable of assuming a stable structure like MOx(OH)y-zFz and can hold a stable surface like Ti. When Ti, Zr and Al are contained in the above-mentioned combination, the atomic ratio of P and Ti, atomic ratio of O and Ti, atomic ratio of F and Ti and the concentration of Ti of the aqueous solution in the cathodic treatment, are all on the basis of the sum of Ti and Zr. Hereinafter, Ti, Zr and Al contained alone or contained in combination are often expressed as M.

### BRIEF DESCRIPTION OF THE DRAWINGS

FIG. 1 is a view measuring an inorganic surface-treating layer of a surface-treated metal material of the invention for its peaks O1s, Al2p and F1s by XPS;

FIG. 2 is a view measuring the inorganic surface-treating layer of the surface-treated metal material of the invention for its peak Al2p by XPS;

FIG. 3 is a diagram comparing a peak S1s by XPS of the inorganic surface-treating layer of the surface-treated metal sheet of the invention with a peak S1s by XPS of alumite anodically oxidized with sulfuric acid;

FIG. 4 is a diagram measuring the surface of the surface-treated metal material forming an organic surface-treating layer of the invention for its peak N1s by XPS;

FIG. 5 is a view illustrating a sectional structure of a surface-treated metal material of the invention;

FIG. 6 is a view illustrating another sectional structure of the surface-treated metal material of the invention;

FIG. 7 is a view illustrating a further sectional structure of the surface-treated metal material of the invention;

FIG. 8 is a view illustrating a still further sectional structure of the surface-treated metal material of the invention;

FIG. 9 is a diagram illustrating a relationship between the total electrolysis time and the weight film thickness of Ti;

FIG. 10 is a diagram illustrating a relationship between the total electrolysis time and the weight film thickness of

FIG. 11 is a diagram illustrating a relationship between the total electrolysis time and the weight film thickness of Al;

FIG. 12 is a view illustrating a sectional structure of a resin-coated metal material of the invention;

FIG. 13 is a view illustrating another sectional structure of the resin-coated metal material of the invention;

FIG. 14 is a side view illustrating a metal can of the invention;

FIG. 15 is a top view of an easy-to-open can lid of the invention; and

FIG. 16 is a sectional view of the easy-to-open can lid shown in FIG. 15.

### BEST MODE FOR CARRYING OUT THE INVENTION

### (Surface-Treated Metal Materials)

### <Inorganic Surface-Treating Layers Containing at Least One of Ti or Zr>

In the surface-treated metal material containing at least one of Ti or Zr of the invention as described above, one of the important features is that the inorganic surface-treating layer of the surface-treated metal material does not contain phosphoric acid. In the surface-treated metal material of the present invention as will become obvious from the results of Examples appearing later, no peak P2p due to phosphoric acid is recognized from the inorganic surface-treating layer as measured by using an X-ray photoelectric spectrometer (Examples 1 to 7, 10 to 13, 15 and 16).

In the surface-treated metal material of the invention, further, an important feature resides in that an atomic ratio of P and M (M is Ti and/or Zr) contained in the most surface portion of the inorganic surface-treating layer of the surface-treated metal material is in a range of 0≦P/M<0.6 and, more preferably, 0≦P/M<0.1. If P/M is not smaller than the above range, the coating contains much phosphoric acid or P as impurity component, and the close adhesion is not obtained to a sufficient degree.

It is, further, desired that the inorganic surface-treating layer of the surface-treated metal material of the invention contains Ti and/or Zr, O and F as chief constituent components and, particularly, the surface layer has a value O/M (N is Ti and/or Zr) in a range of 1 to 10 and, particularly, 1 to 5 in terms of an atomic ratio. If the value O/M is smaller than the above range, it becomes difficult to form the coating. If the value O/M exceeds the above range, on the other hand, the close adhesion is not obtained to a sufficient degree.

In the surface-treated metal material of the present invention, further, it is desired that a value of F/M (M is Ti and/or Zr) contained in the most surface portion of the inorganic surface-treating layer of the surface-treated metal material is in a range of 0.1 to 2.5 and, particularly, 0.5 to 2.0 in terms of an atomic ratio. If the value F/M is smaller than the above range, stable structures like TiOx(OH)y-zFz and ZrOx(OH)y-zFz described above are not assumed, and the adhesive property decreases in a high-temperature and high-humidity environment. If the value F/M is lager than the above range, on the other hand, the amount of anions becomes too large relative to M though their ionic radii may be small and, therefore, the adhesive property decreases.

In the surface-treated metal material of the present invention, further, it is desired that the inorganic surface-treating layer contains SiO₂ particles. It has heretofore been known that silica works to form a barrier coating against the invasion of corrosive factors and to retard the rate of corrosion of the steel sheets by holding the corrosive environment on the alkali side. In the present invention, further, water-dispersing silica is contained in the inorganic surface-treating layer so as to be bonded to oxygen atoms in the inorganic surface-treating layer and to stay therein as a chemically stable amorphous silicon oxide. Thus, a dense mesh structure of siloxane bonds can be formed in the inorganic surface-treating layer making it possible to form a stable coating.

When SiO₂ particles are contained in the inorganic surface-treating layer, it is desired that the surface covering ratio of Si contained in the most surface portion of the inorganic surface-treating layer of the surface-treated metal material is in a range of 10 to 30% and, particularly, 15 to 30% in terms of an atomic ratio. If the surface covering ratio of Si is smaller than the above range, it becomes difficult to form the coating. If the atomic concentration of Si exceeds the above range, on the other hand, the effect of forming the coating maintaining stability is not obtained to a sufficient degree despite the water-dispersing silica is blended.

Concerning the surface covering ratio of Si, principal elements serving as constituent components are measured by XPS like the measurement of the atomic ratio, and the atomic concentration of Si2p of when the whole components are set to be 100% is defined to be the surface covering ratio. Here, however, the concentration must be found after the contaminated layer is lightly removed by Ar sputtering until the atomic concentration of C becomes not larger than 10% like in the case of measuring the atomic ratio.

The atomic ratios of P/M, O/H and F/M can be found from the atomic concentrations obtained by using an analytical software by measuring peaks P2p, O1s, F1s, Ti3d and Zr3d by XPS. In the silica-dispersed samples, however, a dense silica film is formed on the most surface portion. To find the atomic ratio of O/M (M is Ti and/or Zr), therefore, a peak Si2p is measured at the same time, a concentration of O corresponding to SiO₂ is found from the atomic concentration of Si, the atomic concentrations of elements are calculated again by excluding the SiO₂ component from the whole components, and the atomic ratio of O/M (N is Ti and/or Zr) must be found again.

The surface-treated metal material used for the measurement is analyzed for its surface in its form if the surface thereof is clean. If the organic resin has been adhered or melt-adhered, the surface-treated metal material is immersed in boiled hydrogen peroxide water for several minutes to remove the organic resin layer.

As for a sample which is not clean or a sample from which the organic resin layer is removed as described above, the layer of C due to organic matters is subjected to the Ar sputtering to lightly remove the contaminated layer until the atomic concentration of C becomes not larger than 10% with respect to when the sum of principal elements such as C, O, F and M (M is Ti and/or Zr) is set to be 100% and, thereafter, the ratios P/M, O/M and F/M can be found. Further, after the background is removed, the peak areas may be found concerning the elements P, O, F and M (M is Ti and/or Zr) by an established method and, thereafter, the atomic concentrations of the elements are found by using relative sensitivity coefficients of the measuring device to thereby find P/M, O/M and F/N by calculation.

It is desired that the film thickness is from 5 to 300 mg/m² in terms of the weight film thickness of M (M is Ti or Ti and Zr). If the film thickness is smaller than 5 mg/m², it becomes difficult to form a uniform coating and the covering ratio is not sufficient. If the film thickness exceeds 300 mg/m², the adhesive property decreases through the working and is not desirable.

The film thickness of M (M is Ti and/or Zr) is determined by using a fluorescent X-ray analyzer placed in the market. First, a calibration curve representing a relationship between the film thickness of Ti and the X-ray intensity of Ti is formed from a plurality of samples of which the weight film thicknesses of Ti have been known. Thereafter, the X-ray intensity of Ti measured by using an unknown sample is converted into a weight film thickness based on the calibration curve. If Zr alone is contained, too, a calibration curve of Zr is formed in the same manner and from which the weight film thickness is calculated. Or, if Zr is contained together with Ti, the weight film thicknesses of Ti and Zr are added up together.

In the surface-treated metal material of the present invention, when the metal base material to be treated is an aluminum alloy-coated or aluminum-coated steel sheet which is subject to be easily scratched, fine particles of sizes of 10 to 100 nm may be precipitated on the surfaces to cover the surfaces of the metal material. The fine particles are considered to be fine oxide particles of chiefly M (M is Ti or Ti and Zr) which work to reform the surfaces of aluminum by cathodic electrolysis without requiring any particular pretreatment offering an effect of improving the scratch resistance and the wear resistance.

### <Inorganic Surface-Treating Layer Containing Al>

In the surface-treated metal material containing Al of the present invention as described above, one of the important features is that the inorganic surface-treating layer of the surface-treated metal material contains at least Al and O and, more desirably, contains F, too.

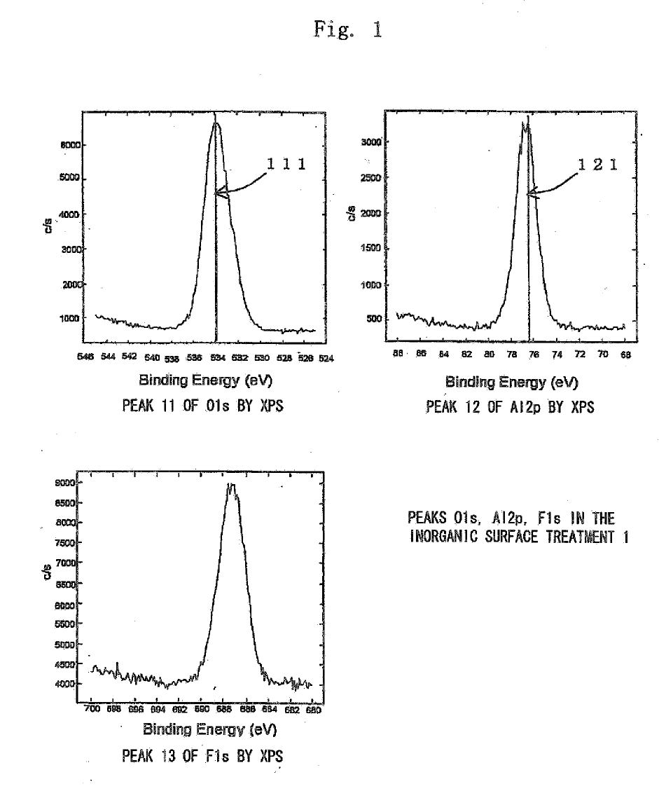

FIG. 1 shows a peak 2 of O1s, a peak 3 of Al2p and a peak 4 of F1s of the inorganic surface-treating layer 1 containing Al and O formed by the cathodic electrolysis according to the invention as measured by using an X-ray photoelectric spectrometer (XPS). Here, the inorganic surface-treating layer contains F in addition to Al and O.

Another important feature is that the surface-treated metal material contains a hydroxide or an oxyhydroxide of aluminum.

Described below are examples of the inorganic surface-treating layers containing a hydroxide or an oxyhydroxide of aluminum of the invention. First, the surface of the inorganic surface-treating layer is measured by XPS for its O1s, Al2p and C is due to contamination of the sample, to find peaks 11 and 12 of O1s and Al2p as shown in FIG. 1. Next, bound energy positions 111 and 121 of O1s and Al2p are so corrected that the bound energy position of C1s due to contamination of the sample becomes constant to thereby find normal bound energy positions.

By using the samples of steel sheets plated with tin in an amount of 1.3 g/m², reflow-treated, and coated with inorganic surface-treating layers maintaining weight film thicknesses of Al of 30, 40 and 80 mg/m² and the samples of an alumina sintered body and a rolled aluminum sheet as comparative examples, the bound energy positions of O1s and Al2p were found by the above method. Among them, the sample of Al 40 mg/m² was cathodically electrolyzed by using an aluminum nitrate bath while other samples were cathodically electrolyzed by using an aluminum sulfate bath. As for the comparative examples, the alumina sintered body is Al₂O₃ and it is considered that the surfaces of the rolled aluminum sheet are turning into an aluminum oxide. Here, in order to avoid the effect of adsorbed water, the comparative samples were heat-treated at 30° C. for one hour prior to taking measurements. The results were as shown in Table 1. The bound energy positions have been corrected by using a peak of C1s due to contamination of the sample. Table 1.

TABLE 1

Bound energy
measured by XPS

| | | O1s (eV) | Al2p (eV) |
|---|---|---|---|
| Materials of | Al 30 mg/m² | 532.1 | 74.9 |
| the invention | | | |
| Materials of | Al 40 mg/² | 531.8 | 75.4 |
| the invention | | | |
| Materials of | Al 80 mg/m² | 532.3 | 75.0 |
| the invention | | | |
| Comparative | Alumina sintred | 531.5 | 74.4 |
| materials | body | | |
| Comparative | Rolled Al sheet | 531.7 | 74.5 |
| materials | | | |

As shown in Table 1, the materials of the present invention have O1s which is higher by 0.1 to 0.8 eV than that of the comparative samples, and have Al2p which is shifted toward the high energy side by 0.4 to 1.0 eV, from which it is learned that the materials of the present invention do not contain an oxide but contain a hydroxide or an oxyhydroxide.

In the surface-treated metal material containing Al of the present invention, furthers an important feature is that the atomic ratio of 0 and M (M is Al or Al and at least one of Ti and Zr) contained in the most surface portion of the inorganic surface-treating layer is 1<O/M<5.5 and, more preferably, 1<O/M<3.5. It is difficult to form the inorganic surface-treating film having O/M which is not larger than the above range, i.e., which is not larger than 1.

If anionic components of large ionic radii are not almost contained, the ratio O/M lies in a range of 1<O/M<2.5. If the ratio is lying in a range of 2.5≦O/M<3.5, it is considered that anionic components such as phosphoric acid and sulfuric acid having large ionic radii are contained in the coating to some extent and if the ratio is lying in a range of 3.5≦O/M<5.5, the anionic components are contained in considerable amounts. Therefore, to maintain the adhesive property after the retort treatment when the ratio is lying in the range of 3.5≦O/M<5.5, it is desired to form the organic surface-treating layer such as the coupling agent treating layer on the inorganic surface-treating layer. Further, if 5.5<O/M which is beyond the above range, it is considered that the base material components are oxidized in addition to the elements included in M. That is, the tin layer on the surface of the tin sheet is oxidized eventually causing O/M to increase. In this case, the cohesive force is weak since the surface of tin itself has been oxidized, and the close adhesion is not obtained to a sufficient degree despite the organic surface-treating layer is provided.

In the surface-treated metal material of the present invention, further, it is desired that an atomic ratio of F and M (M is Al or Al and at least one of Ti and Zr) contained in the most surface portion of the inorganic surface-treating layer is smaller than 2.5 and, particularly, is not larger than 2.0.

It F/M is not smaller than 2.5, the amount of anions becomes too great relative to M though F may have a small ionic radius, causing a decrease in the close adhesion.

The atomic ratios O/M and F/M can be found from the atomic concentrations obtained by using an analytical software by measuring peaks present in the surface such as of C1s, O1s, F1s, Al2p, Ti3d and Zr3d by XPS.

The surface-treated metal material used for the measurement is analyzed for its surface in its form if the surface thereof is clean. If the organic resin has been adhered or melt-adhered, the surface-treated metal material is immersed in boiled hydrogen peroxide water for several minutes to remove the organic resin layer.

As for a sample which is not clean or a sample from which the organic resin layer is removed as described above, the contaminated layer is lightly removed by Ar sputtering until the atomic concentration of C1s becomes not larger than 10% with respect to the sum of principal elements constituting the surface such as Cr O, F, Al, Zr, Ti and metal base material elements, that is set to be 100% and, thereafter, the atomic ratios O/M and F/M are found. Further, after the background is removed, the peak areas may be found concerning the elements O, F and Al, Zr and Ti by an established method and, thereafter, the atomic concentrations of the elements are found by using relative sensitivity coefficients of the measuring device to thereby find O/M and F/M by calculation.

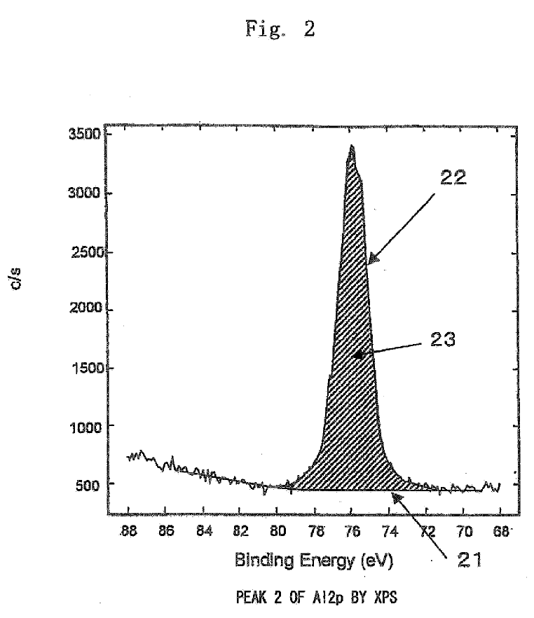

FIG. 2 shows a peak 2 of Al2p. A range surrounded by a reference line 21 of background and a peak 22 is a peak area 23. Here, attention must be given in drawing the background since the atomic ratio varies depending upon the manner of drawing the background, as a matter of course.

In its most desired form, further, the inorganic surface-treating layer of the invention does not contain anionic component having large ionic radius, such as phosphoric acid or sulfuric acid like the inorganic surface-treating layer comprising chiefly Ti and Zr. One of the features of the invention is that the atomic ratio of (P+S) and M (N is Al or Al and at least one of Ti or Zr) contained in the most surface portion of the inorganic surface-treating layer is controlled to be (P+S/M<0.25 and, more preferably, (P+S)/M<0.05.

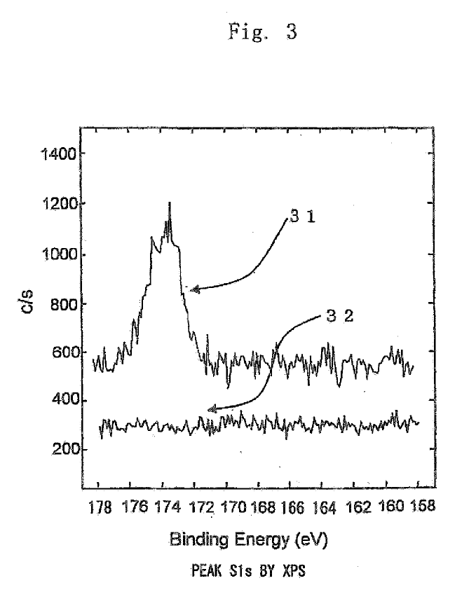

FIG. 3 compares a peak 31 of S1s in the most surface portion of alumite anodically oxidized with sulfuric acid as measured by XPS with a peak 32 of S1s in the most surface portion of the inorganic surface-treating layer of the invention. Similarly, a peak P2p and peaks present in the surface such as C1s, O1s, F1s, Al2p, Ti3d and Zr3d, are measured, and (P+S)/M is found from the atomic concentrations obtained by using the analytical software. In the samples of FIG. 3, a value of (P+S)/M is 0.0 in the present invention while it is 0.1 with the anodically oxidized alumite.

As for the film thickness, it is desired that the weight film thickness of Al is in a range of 5 to 100 mg/m². If the weight film thickness is smaller than 5 mg/m², it becomes difficult to form a uniform coating and the covering ratio is not sufficient. If the weight film thickness exceeds 100 mg/m², the close adhesion decreases through the working and is not desirable.

As for the method of measuring the weight film thickness, the film thickness can be determined by using a fluorescent X-ray analyzer placed in the market when Al is not the chief component of the metal base member. In this case, first, a calibration curve representing a relationship between the weight film thickness of Al and the X-ray intensity of Al is formed from a plurality of samples of which the weight film thicknesses of Al have been known. Thereafter, the X-ray intensity of Al measured by using an unknown sample is converted into a weight film thickness based on the calibration curve.

When the metal base member chiefly comprises Al, the metal base member is dissolved in an acid to extract the inorganic surface-treating layer. Thereafter, by using an energy dispersion-type X-ray analyzer attached to a transmission-type electron microscope, the weight film thickness is found from the calibration curve formed by using the X-ray intensity and a standard sample.

If the inorganic surface-treating layer contains at least one of Zr or Ti in addition to Al, the respective elements have different densities. It is, therefore, desired that the total weight film thickness of Al, Zr and Ti lies in a range of 5 to 300 mg/m².

In the present invention, further, when the metal base member having a plated layer is to be treated for its surfaces, it is desired that the surface exposure ratio of chief elements in the metal base member is less than 5% and, preferably, less than 3%.

If the exposure ratio of chief elements in the metal base member is larger than the above value, the corrosion resistance and the close adhesion are not satisfactory. In particular, in treating the surfaces on where metal tin is present, such as of tin plate, steel sheet thinly plated with tin or steel sheet very thinly plated with tin, if the surface exposure ratio of tin is not smaller than 5%, problems arouse concerning the corrosion resistance, close adhesion, resistance against acids and discoloration with the passage of timer exhibiting inferior appearance. The surface exposure ratio can be found from an atomic concentration obtained by using the analytical software by measuring peaks of principal elements present in the surface, such as C1s, P2p, O1s, F1s, S1s, Al2p, Ti3d, Zr3d, Sn2d and Fe2p by using XPS. Here, however, the peak Fe2p may often be overlapped on the peak Sn. In this case, the peaks must be separated.

### <Organic Surface-Treating Layers>

In the surface-treated metal material of the present invention, the organic-surface treating layer present together with the inorganic surface-treating layer is an organic coating comprising chiefly an organic component and, particularly, (i) a silane coupling agent treating layer containing Si in an amount of 0.8 to 30 mg/m² or (ii) a layer comprising chiefly a phenol-type water-soluble organic compound.

(i) Silane Coupling Agent Treating Layer.

In the surface-treated metal material of the present invention, it is particularly desired that a silane coupling agent treating layer containing Si in an amount of 0.8 to 30 mg/m² is further formed on the inorganic surface-treating layer.

The silane coupling agent forming the silane coupling agent treating layer has a reaction group that chemically bonds to a thermoplastic polyester resin and a reaction group that chemically bonds to the inorganic surface-treating layer. There can be used an organosilane having a reaction group such as amino group, epoxy group, methacryloxy group or mercapto group, and a hydrolyzing alkoxyl group such as methoxy group or ethoxy group, or a silane having an organic substituent such as methyl group, phenyl group, epoxy group or mercapto group, and a hydrolyzing alkoxy group.

Concrete examples of the silane coupling agent that can be preferably used in the invention include γ-APS (γ-aminopropyltrimethoxysilane), γ-APS (γ-glycidoxypropyltrimethoxysilane), BTSPA (bistrimethoxysilylpropylaminosilane), and N-(aminoethyl) γ-aminopropyltrimethoxysilane.

It is desired that the silane coupling agent treating layer contains Si in an amount of 0.8 to 30 mg/m² and, particularly, 3 to 15 mg/m². If the amount of Si is smaller than the above range, the effect of the organic surface-treating layer is poor, i.e., the effect is poor for improving the corrosion resistance and close adhesion. If the amount of Si is not smaller than the above range, the unreacted silane coupling agent undergoes the self-condensation, and the close work adhesion and corrosion resistance are not obtained to a sufficient degree.

It is particularly desired that the organic surface-treating layer which is the silane coupling agent treating layer is formed on the inorganic surface-treating layer that contains SiO₂ particles. In this case, it is desired that the surface covering ratio of Si contained in the most surface portion of the inorganic surface-treating layer of the surface-treated metal material is in a range of 10 to 30% and, particularly, 15 to 30% in terms of an atomic ratio. If the surface covering ratio of Si is smaller than the above range, it becomes difficult to form the coating. If the atomic concentration of Si exceeds the above range, on the other hand, the effect of forming the coating maintaining stability is not obtained to a sufficient degree despite the water-dispersing silica is blended.

Concerning the surface covering ratio of Si, principal elements serving as constituent components are measured by XPS like the measurement of the atomic ratio, and the atomic concentration of Si2p of when the whole components are set to be 100% is defined to be the surface covering ratio. Here, however, the concentration must be found after the contaminating layer is lightly removed by Ar sputtering until the atomic concentration of C becomes not larger than 10% like in the case of measuring the atomic ratio,

(ii) Layer Comprising Chiefly a Phenol-Type Water-Soluble Organic Compound.

In the surface-treated metal material of the present invention, it is particularly desired that a layer comprising chiefly a phenol-type water-soluble organic compound is present on the inorganic surface-treating layer.

It is desired that the phenol-type water-soluble organic compound is a phenol resin comprising recurring units represented by the following formula (1),

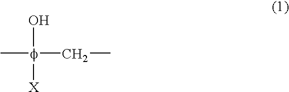

wherein φ is a benzene ring, X is a hydrogen atom or Z represented by the following formula (2),

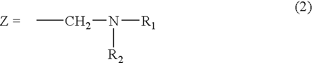

wherein R₁ and R₂ are alkyl groups with not more than 10 carbon atoms or hydroxyalkyl groups with not more than 10 carbon atoms, the introduction ratio of the group Z is desirable as repetition units of phenoric resin being 0.2 to 1.0 per a benzene ring.

Another example of the phenol-type water-soluble organic compound is a tannin. The tannin is also called tannic acid and stands for aromatic compounds of complex structures having a phenolic hydroxyl group in general.

As the tannin, there can be exemplified hamamelitannin, persimmon tannin, tea tannin, Chinese tannin, Turkish tannin, myrobalan tannin, divi-divi tannin, algarobillatannin, valonia tannin and catechin tannin. It is desired that the tannin has a number average molecular weight of not smaller than 200.

In the organic surface-treating layer comprising chiefly the phenol-type water-soluble organic compound, it is desired that the organic surface-treating layer contains the phenol-type water-soluble organic compound in an amount of 3 to 75 mg/m² and, particularly, 6 to 30 mg/m² calculated as carbon atoms. If the amount is smaller than the above range, the organic surface-treating coating exhibits inferior adhesion. If the amount is larger than the above range, on the other hand, the thickness of the organic surface-treating coating becomes unnecessarily large deteriorating the close adhesion and corrosion resistance.

Further, the organic surface-treating layer comprising chiefly the phenol-type water-soluble organic compound may be an organic/inorganic composite layer formed by using an organic compound comprising chiefly carbon and a surface-treating agent containing a phosphorous compound and a zirconium or titanium compound.

In the surface-treated metal material forming the organic surface-treating layer of the invention, further, it is desired that the most surface layer contains N.

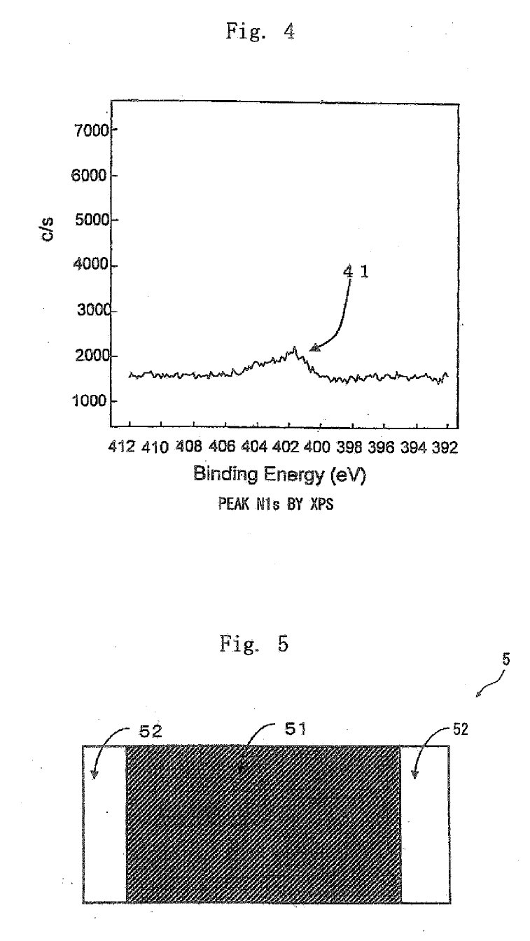

FIG. 4 shows a peak 41 N1s of the most surface layer of the surface-treated metal material having the silane coupling agent treating layer formed on the surface thereof as measured by XPS. As shown in FIG. 4, N is detected. N is similarly detected from the phenol-type water-soluble organic compound, too

### <Metal Base Members>

As the metal base member used in the invention, there can be used various surface-treated steel sheets and light metal sheets such as of aluminum. As the surface-treated steel sheet, there can be used a cold rolled steel sheet that is annealed followed by the secondary cold rolling and one or two or more kinds of surface treatments such as zinc plating, tin plating, nickel plating and aluminum plating. There can be further used an aluminum-clad steel sheet.

The plated layer may comprise a metal layer containing one or more of tin, nickel, zinc, iron and aluminum. Or, the plated layer may comprise a metal layer containing one or more of tin, nickel, zinc, iron and aluminum and an alloy layer containing two or more of tin, nickel, zinc, aluminum and iron. Or, the plated layer may comprise an alloy layer only containing two or more of tin, nickel, zinc, iron and aluminum.

A metal is formed by plating or cladding on the surface side of the metal base member in order to improve various properties such as corrosion resistance, wear resistance and electric conduction of the metal located on the center side, generally and in most of the cases, to improve the corrosion resistance. As the light metal sheet, an aluminum alloy is used in addition to the so-called pure aluminum. There is no particular limitation on the thickness of the metal plate. Though it may vary depending upon the kind of the metal, use of the container and the size thereof, the metal sheet, usually, has a thickness of 0.10 to 0.50 mm. In particular, the surface-treated steel sheet has a thickness of 0.10 to 0.30 mm and the light metal sheet has a thickness of 0.15 to 0.40 mm.

### <Structures of the Surface-Treated Metal Materials>

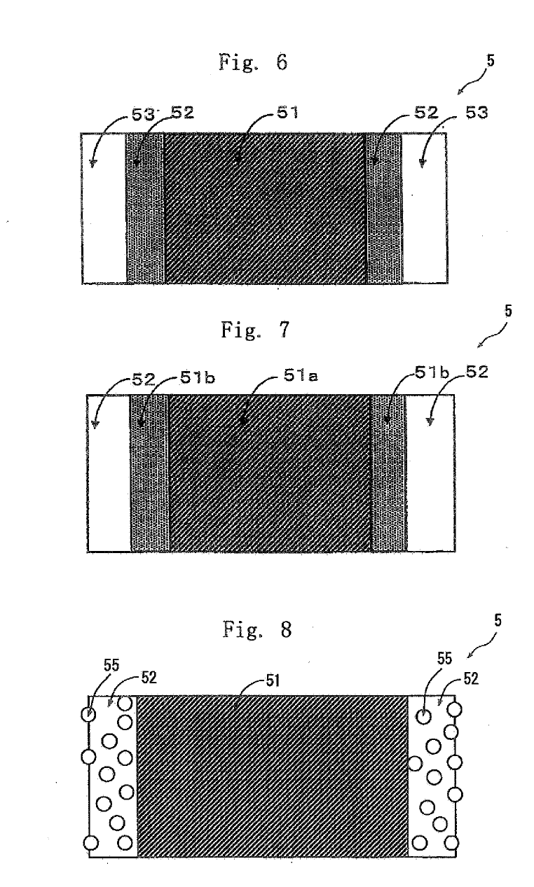

FIGS. 5 to 7 are sectional views illustrating the surface-treated metal materials of the present invention. The surface-treated metal material 5 shown in FIG. 5 includes a metal base member 51 and inorganic surface-treating layers 52 formed on the surfaces of the base member and containing M (at least any one of Ti, Zr or Al), O and F as essential components (here, however, F may be arbitrarily contained when the metal base member is Al). In an example of FIG. 6, organic surface-treating layers 53 comprising chiefly organic components are formed on the inorganic surface-treating layers 52 of FIG. 5.

The surface-treated metal material 5 shown in FIG. 7 is the same as that of FIG. 5 with respect to having the inorganic surface-treating layer 52 containing M (at least any one of Ti, Zr or Al), C and F as essential components (here, however, F is arbitrarily contained when the metal base member is Al), but the metal base member 51 is constituted by a metal material 51a and metal-plated layers 51b. The metal-plated layers S1b covering the metal material 51a occupying most of the base member 51 are those that play the role of enhancing the corrosion resistance of the metal material 51a as will be described later.

The surface-treated metal material 5 shown in FIG. 8 has inorganic surface-treating layers 52 containing M (at least any one of Ti, Zr or Al), O and F as essential components (here, however, F is arbitrarily contained when the metal base member is Al) formed on the metal base member 51, the inorganic surface-treating layers 52 containing SiO₂ particles 55.

### (Method of Treating the Surfaces)

### <Method of Treating the Surface of the Inorganic Surface-Treating Layers Containing Ti and Zr>

In the method of treating the surfaces of a metal material of the invention, it is an important feature to conduct the cathodic treatment in an aqueous solution containing Ti and/or Zr and F, having a phosphoric acid ion concentration calculated as PO₄ of smaller than 0.03 mols/liter and, preferably, without containing phosphoric acid.

As described above, the cathodic treatment makes it possible to greatly broaden the range of controlling the weight film thickness of Ti and/or Zr per a unit time as compared to the conventional formation-treated coatings, and makes it possible to form a coating that meets the use.

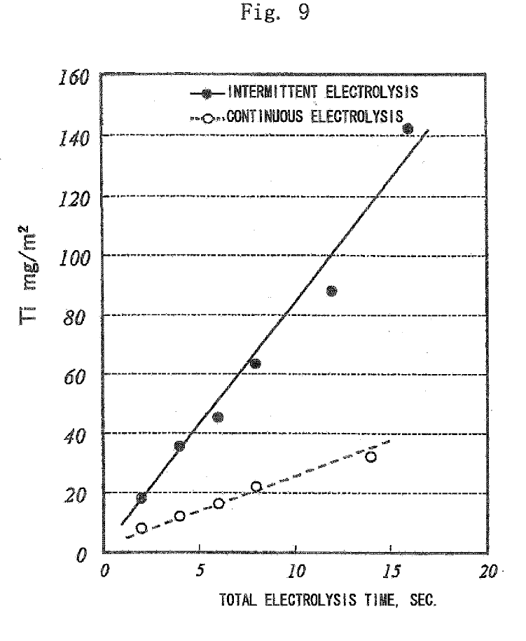

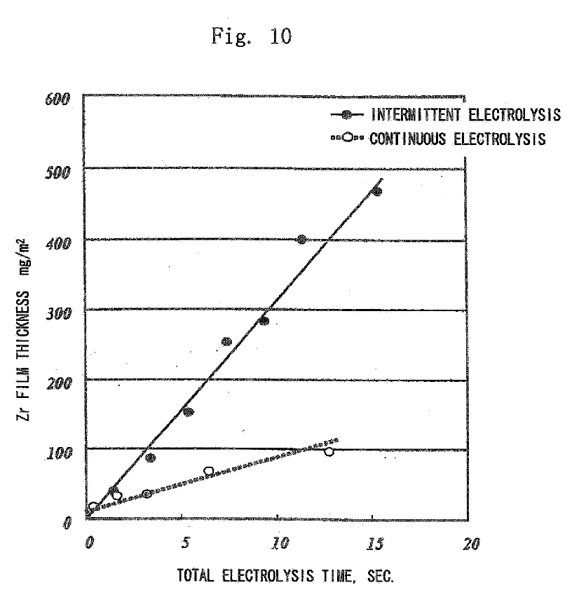

In the method of treating the surfaces of the invention, further, it is desired to conduct the cathodic treatment intermittently, i.e., to intermittently conduct the electrolysis by providing a halting time on the way of electrolysis and repeating many times a cycle of flowing and halting an electric current in an aqueous solution with stirring. FIGS. 9 and 10 illustrate relationships between the total electrolysis time which is the sum of current-flowing time and halting time and the weight film thickness of Ti or the weight film thickness of Zr. As will be obvious from FIGS. 9 and 10, it will be learned that the weight film thickness of Ti or Zr grows faster when the cathodic electrolysis is intermittently conducted than when the cathodic electrolysis is continuously conducted.

This is because, if the electrolysis is continuously conducted, the concentration is polarized near the cathode to impair the precipitation. Upon intermittently conducting the electrolysis, however, ions such as of Ti, O, OH and F are supplied to near the cathode due to the stirring effect while the electrolysis is being discontinued, and a film loosely formed on the cathode, i.e., a film having a large ratio O/Ti or O/Zr is removed. As a result, the weight film thickness of Ti or the weight film thickness of Zr grows faster, and a film of a high quality is provided.

Though there is no limitation, the cycle of flowing the current and halting the current is such that the flowing time is 0.1 to 0.8 seconds while the halting time is 0.3 to 1.5 seconds, and 2 to 10 cycles are conducted.

It is desired that the aqueous solution used for the method of treating the surfaces of the invention has a bath concentration, calculated as M (M is Ti or Ti and Zr), in a range of 0.010 to 0.050 mols/liter and, particularly, 0.015 to 0.035 mols/liter. In the cathodic treatment, the electrolysis locally concentrates when the metal sheet having an oxide film densely formed on the surface thereof is treated, making it difficult to form a uniform coating unless a particular pretreatment is effected. According to the present invention, however, the electrolytic treatment is conducted in a bath of a low concentration in order to form a surface-treating film which is as uniform as possible without effecting any particular pretreatment. That is, if the bath concentration is higher than the above range, nuclei are locally formed and where the electrolysis concentrates predominantly, resulting in the formation of a coating lacking, however, uniformity. If the bath concentration is lower than the above range, on the other hand, the electric conduction in the bath is low and an increased amount of electric power is required for the treatment, which is not desirable

It is desired that the aqueous solution used for the surface treatment has a pH of 3.0 to 8.0 and, more preferably, 3.5 to 6.5. As a Ti agent used for the treating solution, there can be used potassium titanium fluoride K₂TiF₆, ammonium titanium fluoride (NH₄)₂TiF₆, and sodium titanium fluoride Na₂TiF₆.

As the Zr agent, there can be used potassium zirconium fluoride KZrF₆, ammonium zirconium fluoride (NH₄)₂ZrF₆ and ammonium zirconium carbonate solution (NH₄)₂ZrO(CO₃)₂.

Further, the titanium ions, zirconium ions, and fluorine ions can be supplied using different agents. As the Ti agent, there can be used potassium titanium oxalate dihydrate K₂TiO(C₂O₄)₂.2H₂O, titanium chloride (III) solution TiCl₃, and titanium chloride (IV) solution TiCl₄. As the Zr agent, there cay be used zirconium oxynitrate ZrO(NO₃)₂ and zirconium oxyacetate ZrO(CH₃COO)₂. As the F agent, there can be used sodium fluoride NaF, potassium fluoride KF and ammonium fluoride NH₄F.

As for the F ion concentration in the bath, it is desired that the F concentration is in a range of 0.03 mols/liter to 0.35 mols/liter. If the fluorine ion concentration is lower than the above range, a gel-like substance is formed on the surface of the metal which is the cathode impairing the handling during the continuous production and causing properties in the surface to lose the stability under high-temperature and high-humidity conditions with the passage of time, which is not desirable. If the bath concentration is higher than the above range, the precipitation efficiency is impaired and precipitates form in the bath, which is not desirable.

It is particularly desired that the aqueous solution used for the surface treatment is blended with the water-dispersing silica. The water-dispersing silica is for improving the corrosion resistance and film formability as described above. Though there is no particular limitation, there can be exemplified spherical silica, chain-like silica and aluminum-modified silica. Concrete examples of the spherical silica are colloidal silica such as Snowtex N and Snowtex UP (both produced by Nissan Kagaku Kogyo Co.) and fumed silica such as Aerosil (produced by Nihon Aerosil Co.). As the chain-like silica, there can be used a silica gel such as Snowtex PS (produced by Nissan Kagaku Kogyo Co.). As the aluminum-modified silica, there can be used a commercially available silica gel such as Adelite AT-20A (produced by Asahi Denka Kogyo Co.). It is desired that the silica with which the treating solution is blended has a particle size in a range of 4 to 80 nm and, particularly, 4 to 30 nm. Particles smaller than this range are difficult to obtain whereas particles larger than this range cause cracking during the working and are not desirable. The blended amount of silica in the coating is desirably in a range of 3 to 100 mg/m² and, particularly, 20 to 80 mg/m² calculated as the amount of Si. If the amount is smaller than this range, the effect of being blended with silica is small. If the amount is larger than the above range, the film itself lacks cohesive force, which is not desirable.

As required, further, nitric acid ions, peroxide and complexing agent may be added to the aqueous solution used for the surface treatment.

The nitric acid ions are effective in maintaining stability in the state of precipitation when the electrolysis is conducted for extended periods of time, and nitric acid, sodium nitrate, potassium nitrate and ammonium nitrate can be used as ion sources. A peroxide generates oxygen in an aqueous solution, is effective in suppressing the polarization of concentration near the surface of the cathode and is, particularly, effective when the bath is poorly stirred. As the peroxide, there can be used hydrogen peroxide, ammonium peroxodisulfate, potassium peroxodisulfate, sodium peroxoborate, sodium peroxocarbonate or sodium peroxodisulfate. The complexing agent works to suppress the formation of precipitates in the bath, and there can be used ethylenediamine tetraacetate, ethylenediamine sodium tetraacetate, citric acid, sodium citrate, boric acid, nitrilo triacetate, nitrilosodium triacetate, cyclohexanediamine tetraacetate and glycin. Too high concentrations of nitric acid ions, peroxide and complexing agent tend to impair the efficiency of precipitation. It is desired that the concentrations of the nitric acid ions, peroxide and complexing agent are not higher than 0.2 mols/liter, respectively.

The metal base member is pretreated according to an established method, i.e., effecting the dewaxing, washing with water and, as required, washing with an acid and washing with water to clean the surfaces, subjecting the metal base member to the cathodic electrolysis relying on the intermittent electrolytic method in an aqueous solution maintained at a temperature of 30 to 65° C. with stirring at a current density of 0.1 to 50 A/dm² repeating the cycle of flowing a current and halting a current for a total electrolysis time of 0.3 to 20 seconds and, finally, effecting the washing with water to thereby obtain a desirable surface structure.

As the opposing electrode sheet corresponding to the anode side, a titanium sheet coated with iridium oxide is favorably used. Desired conditions for the opposing electrode sheet are that the opposing electrode material does not dissolve in the treating solution during the electrolysis and that it works as an insoluble anode having a small oxygen overvoltage.

### <Method of Treating the Surface of the Inorganic Surface-Treating Layer Containing Al>

In the method of treating the surfaces of the metal sheet of the invention, an important feature resides in the cathodic treatment in an aqueous solution having an Al ion concentration in a range of 0.001 to 0.05 mols/litter.

In the cathodic treatment, if electrolysis locally concentrates, the coating becomes nonuniform like in the method of treating the surfaces of the inorganic surface-treating layer containing Ti and Zr. Therefore, attention must be given such that the potential distribution becomes uniform. In particular, the electrolysis locally concentrates when the metal sheet having an oxide film densely formed on the surface thereof is treated or when the metal sheet that easily dissolves in an acidic region is treated, making it difficult to form a uniform coating. When, for example, an aluminum sheet is to be treated, therefore, a particular pretreatment is effected in many cases, such as a treatment with the zincate.

According to the present invention, the electrolytic treatment is conducted in a bath of a low concentration in order to form a surface-treating film which is as uniform as possible without effecting any particular pretreatment. That is, if the bath concentration is higher than the above range, the concentration tends to be polarized and the electrolysis concentrates predominantly in the portions where the polarization resistance is low, resulting in the formation of a coating lacking, however, uniformity. If the bath concentration is lower than the above range, on the other hand, the electric conduction in the bath is low and an increased amount of electric power is required for the treatment, which is not desirable.

In the method of treating the surfaces of the present invention, it is desired that the aqueous solution further contains F ions in addition to Al ions.

FIG. 11 compares the thicknesses of the Al-precipitated films by using a bath without containing F ion and a bath containing F ions in an amount of 0.024 mols/litter and conducting the electrolysis under the same conditions by using a tin-plated steel sheet as a cathode. The abscissa represents the total electrolysis time which is the sum of the halting time and the current-flowing time of when the electrolysis is intermittently conducted by repeating the cycle of flowing the current and halting the current a plural number of times It will be learned from FIG. 11 that the Al film is formed faster when the F ions are contained.

In the method of treating the surfaces of the invention, if the current density is not lower than about 5 A/dm², it is desired to intermittently execute the cathodic treatment, i.e. to intermittently execute the electrolysis by providing a halting time on the way of electrolysis and repeating the cycle of flowing the current and halting the current a plural number of times in an aqueous solution with stirring though the range of current density cannot be clearly specified since it varies depending upon the bath concentration, bath composition and the material of the base member. If the electrolysis continues, a loose film of a large O/Al ratio precipitates like a gel on the surface of the cathode causing the concentration to be polarized and impairing the formation of a film of good quality. By intermittently conducting the electrolysis, on the other hand, ions such as of Al, O, OH and F are fed to the vicinity of the cathode due to the effect of stirring while the electrolysis is halting, and the loose film, i.e., the film having a large O/Al ratio formed on the cathode is removed by stirring. As a result, the weight film thickness of Al is quickly formed to provide a film of higher quality.

Though not limited thereto only, it is desired that the cycle of flowing the current and halting the current is such that the current-flowing time is 0.1 to 0.8 seconds and the halting time is 0.3 to 1.5 seconds, and 2 to 30 cycles are carried out.

When the electrolysis is conducted at a low current density of, for example, about 0.5 A/dm², there is no difference in the precipitation efficiency between the continuous electrolysis and the intermittent electrolysis or the precipitation efficiency is better in the case of the continuous electrolysis. When the current density is low, the rate of precipitation is small and the concentration is little polarized making no difference between the continuous electrolysis and the intermittent electrolysis or, conversely, a high precipitation efficiency is accomplished in the case of the continuous electrolysis.

The aqueous solution used for the surface treatment has a pH of 2.0 to 7.0 and, more preferably, a pH of 2.3 to 6.0. As the Al agent used for the treating solution, there can be used aluminum nitrate Al(NO₃)₃.9H₂O, as well as aluminum potassium sulfate AlK(SO₄)₂.12H₂O, aluminum sulfate Al₂ (SO₄)₃.13H₂O, aluminum dihydrogenphosphate solution Al(H₂PO₄), aluminum phosphate AlPO₄, and aluminum lactate [CH₃CH(OH)COO]₃Al.

When Zr and Ti are used together with Al, there can be used the Ti agent, Zr agent or the F agent exemplified concerning the method of treating the surfaces of the inorganic surface-treating layer containing Ti and Zr.

Even when the Al agent is used without including Zr or Ti agent, it is desired that the aqueous solution contains F from the standpoint of precipitation efficiency. When Zr or Ti agent is used together with Al, in particular, it is desired that the aqueous solution contains F at a Concentration in a range of 0.03 mols/liter to 0.35 mols/liter. If the fluorine ion concentration is lower than the above range, the precipitation efficiency is low, and properties on the surface lose stability in a high-temperature and high-humidity environment with the passage of time, which is not desirable. If the fluorine ion concentration is higher than the above range, the precipitation efficiency is impaired and, besides, precipitates form in the bath, which is not desirable.

Further, the aqueous solution used for the surface treatment may contain, as required, nitric acid ions, peroxide and complexing agent described above concerning the method of treating the surfaces of the inorganic surface-treating layer containing Ti and Zr.

The method of pre-treating the metal base member and the conditions for the opposing electrode sheet corresponding to the anode side may be the same as those described above concerning the method of treating the surfaces of the inorganic surface-treating layer containing Ti and Zr.

### <Formation of the Organic Coating>

According to the method of treating the surfaces of the invention, it is particularly desired to form the above inorganic coating and, thereafter, apply the phenol-type water-soluble organic compound or the silane coupling agent, followed by drying to form an organic coating.

To form the organic coating on the inorganic surface-treating layer, the above phenol-type water-soluble organic compound or the silane coupling agent solution is applied onto the inorganic surface-treating layer, or the surface-treated metal material having the inorganic surface-treating layer formed thereon is immersed in the phenol-type water-soluble organic compound or in the silane coupling agent solution and, thereafter, an excess of the solution is removed by using squeeze rolls, followed by heating and drying under a condition of a temperature of 80 to 180° C.

### (Resin-Coated Metal Materials)

The resin-coated metal material of the invention is coated with an organic layer and, particularly, with a layer of a polyester resin on at least one surface of the surface-treated metal material. The surface-treated metal material features close adhesion to the resin coating and excellent adhesive property and, therefore, features excellent corrosion resistance and dent resistance.

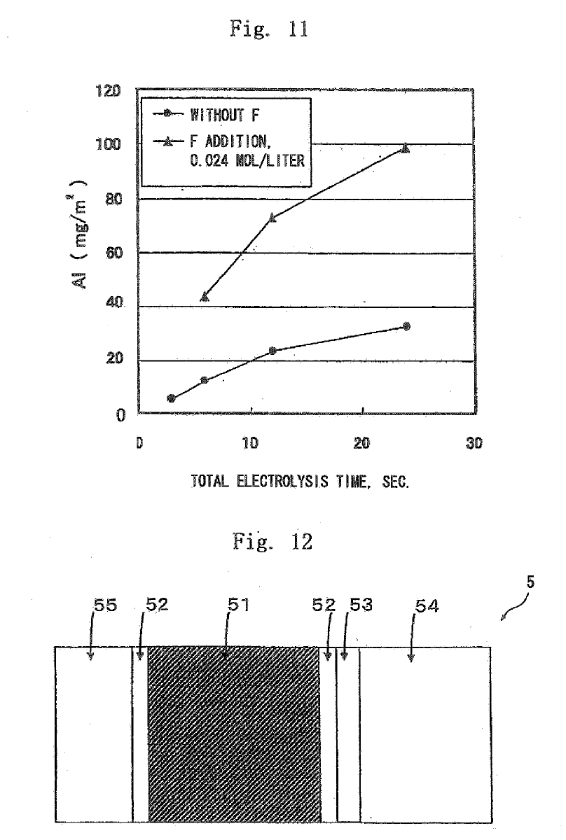

Referring to FIG. 12 which is a sectional view of a resin-coated metal material of the invention, if the inner side of the container (right side in the drawing) is viewed, the resin-coated metal material 5 has a multi-layer structure including a metal base member 51, an inorganic surf ace-treating layer 52 formed on the surface of the base member and containing M (M is at least any one of Ti, Zr or Al), O and F as essential components (here, however, F is arbitrarily contained when the metal base member is Al), an organic surface-treating layer 53 formed on the inorganic surface-treating layer 52, and a polyester resin coating layer 54 formed thereon. In the example of FIG. 12, the container has an outer resin protection layer 55 formed via the inorganic surface-treating layer 52 on the outer surface side (left side in the drawing). The outer resin protection layer 55 may be formed of the same polyester resin as the polyester resin coating layer 54 or may be formed of a different polyester resin, or may be formed of a different resin.

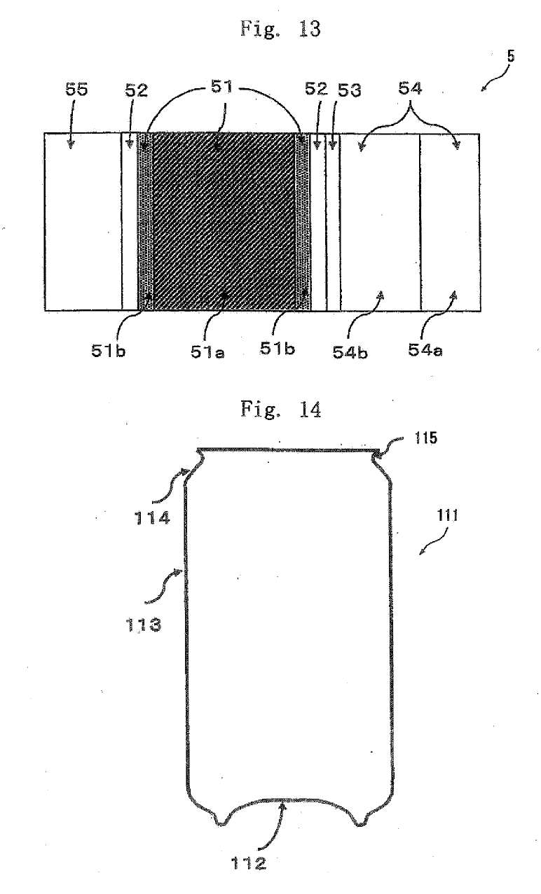

Referring to FIG. 13 illustrating another resin-coated metal material, the resin-coated metal material 5 is the same as the one shown in FIG. 12 with regard to that it has the surface-treating layer 52 containing M (M is at least any one of Ti, Zr or Al), O and F as essential components (here, however, F is arbitrarily contained when the metal base member is Al), an organic surface-treating layer 53 formed on the base member 51 which is on the inner surface side of the container, the polyester resin layer 54 and the outer resin protection layer 55 formed on the outer side. Here, however, the base member 51 is constituted by a metal sheet 51a and metal plated layers 51b, and the polyester resin layer 54 has a laminated structure of a surface polyester resin layer 54a and an underlying polyester resin layer 54b. It was mentioned already that the metal plated layers 51b covering the metal sheet 51a which occupies most of the base member 51 play the role of enhancing the corrosion resistance of the metal sheet S1a. It was further mentioned already that the underlying polyester resin layer 54b is the one that excellently adheres to the metal base member while the surface polyester resin layer 54a has excellent resistance against the content.

### (Organic Resin Coating Layer)

In the resin-coated metal material of the present invention, there is no particular limitation on the organic resin formed on the metal sheet, and there can be used various thermoplastic resins and thermosetting or thermoplastic resins.

Organic resins may be olefin-type resin films such as polyethylene, polypropylene, ethylene/propylene copolymer, ethylene/vinyl acetate copolymer, ethylene/acrylic ester copolymer and ionomer, polyester films such as polybutylene terephthalate and the like; polyamide films such as nylon 6, nylon 6,6, nylon 11 and nylon 12; or thermoplastic resin films such as polyvinyl chloride film and polyvinylene chloride film, which may not be drawn or may be biaxially drawn. As the adhesive used for laminating the layers, there can be used an urethane-type adhesive, epoxy-type adhesive, acid-modified olefin resin-type adhesive, copolyamide-type adhesive or copolyester-type adhesive (thickness: 0.1 to 5.0 μm). Further, a thermosetting coating material may be applied onto the side of the surface-treated metal material or onto the film side maintaining a thickness of 0.05 to 2 μm so as to work as an adhesive.

As the organic resin, there can be used thermoplastic or thermosetting coating materials such as modified epoxy coating materials like phenol-epoxy and amino-epoxy; and synthetic rubber-type coating materials like vinyl chloride/vinyl acetate copolymer, saponified product of a vinyl chloride/vinyl acetate copolymer, vinyl chloride/vinyl acetate/maleic anhydride copolymer, epoxy-modified, epoxyamino-modified or epoxyphenol-modified vinyl coating material, or modified vinyl coating material, acrylic coating material and styrene/butadiene copolymer, which may be used alone or in a combination of two or more kinds.

Among them, the polyester resin is most desired as a material for containers. As the polyester resin, there can be exemplified a thermoplastic polyester derived from an alcohol component comprising chiefly ethylene glycol or butylene glycol and an acid component such as an aromatic dibasic acid like terephthalic acid, isophthalic acid or naphthalenedicarboxylic acid.

As the polyester, a polyethylene terephthalate itself can be used as a matter of course. From the standpoint of shock resistance and workability, however, it is desired to lower the highest crystallization degree of the film that can be reached. For this purpose, it is desired to introduce a copolymerized ester unit other than the ethylene terephthalate into the polyester. It is particularly desired to use a copolymerized polyester comprising chiefly ethylene terephthalate units or butylene terephthalate units containing other ester units in small amounts and having a melting point of 210 to 252° C. The homopolyethylene terephthalate has a melting point of, generally, 255 to 265° C.

Generally, it is desired that not less than 70 mol % and, particularly, not less than 75 mol % of the dibasic acid component in the copolymerized polyester comprises a terephthalic acid component, not less than 70 mol % and, particularly, not less than 75 mol % of the diol component comprises ethylene glycol or butylene glycol, and 1 to 30 mol % and, particularly, 5 to 25 mol % of the dibasic acid component comprises a dibasic acid component other than the terephthalic acid.

As the dibasic acid other than the terephthalic acid, there can be exemplified aromatic dicarboxylic acids such as isophthalic acid, phthalic acid and naphthalene dicarboxylic acid; alicyclic dicarboxylic acids such as cyclohexanedicarboxylic acid; aliphatic dicarboxylic acids such as succinic acid, adipic acid, sebacic acid and dodecanedioic acid; which may be used in one kind or in a combination of two or more kinds. As the diol components other than the ethylene glycol or the butylene glycol, there can be exemplified propylene glycol, diethylene glycol, 1,6-hexylene glycol, cyclohexane dimethanol and ethylene oxide adduct of bisphenol A, which may be used in one kind or in a combination of two or more kinds. It is desired that the combination of these comonomers is such that the melting point of the copolymerized polyester lies in the above range, as a matter of course.

In order to improve melt-fluidizing properties at the time of forming, the polyester can contain at least one kind of branching or crosslinking component selected from the group consisting of multibasic acids which are trifunctional or more highly functional and polyhydric alcohols. It is desired that these branching or crosslinking components are contained in amounts of not larger than 3.0 mol % and, preferably, in a range of 0.05 to 3.0 mol %.

As the trifunctional or more highly functional polybasic acid and polyhydric alcohol, there can be exemplified such polybasic acids as trimellitic acid, pyromellitic acid, hemimellitic acid, 1,1,2,2-ethanetetracarboxylic acid, 1,1,2-ethanetricarboxylic acid, 1,3,5-pentanetricarboxylic acid, 1,2,3,4-cyclopentanetetracarboxylic acid, biphenyl-3,4,3′,4′-tetracarboxylic acid, and such polyhydric alcohols as pentaerythritol, glycerol, trimethylolpropane, 1,2,6-hexanetriol, sorbitol, and 1,1,4,4-tetrakis(hydroxymethyl)cyclohexane.

In the resin-coated metal material of the present invention, the polyester resin which can be particularly preferably used for the material for producing cans or can lids is represented by a polyethylene terephthalate/isophthalate containing an isophthalic acid component in an amount of 5 to 25 mol % and a polyethylene/cyclohexylenedimethylene terephthalate containing a cyclohexanedimethanol component in an amount of 1 to 10 mol %.

The homopolyester or the copolymerized polyester must have a molecular weight in a range for forming films, and the solvent has an intrinsic viscosity [η] in a range of 0.5 to 1.5 and, particularly, 0.6 to 1.5 as measured by using a phenol/tetrachloroethane mixed solvent.

The polyester resin layer used in the present invention may be formed using the above polyester or the copolyester alone, may be formed by using a blend of two or more kinds of polyesters or copolyesters, or may be formed by using a blend of the polyester or the copolyester and other thermoplastic resin. As the blend of two or more kinds of polyesters or copolyesters, there can be exemplified combinations of two or more kinds of polyethylene terephthalate, polybutylene terephthalate, polyethylene terephthalate/isophthalate, and polyethylene/cyclohexylenedimethylene terephthalate, to which only, however, the invention is not limited.

As other thermoplastic resins with which the polyester can be blended, there can be exemplified an ethylene-type monomer, thermoplastic elastomer, polyarylate and polycarbonate. Use of at least one of these reforming resin components makes it possible to further improve the resistance against high temperatures and high humidities, and the shock resistance. Usually, the reforming resin component is used in an amount of up to 50 parts by weight and, particularly preferably, in an amount of 5 to 35 parts by weight per 100 parts by weight of the polyester.

As the ethylene-type polymer, there can be exemplified low-, intermediate- and high-density polyethylenes, linear low-density polyethylene, linear ultra-low-density polyethylene, ethylene/propylene copolymer, ethylene/butene-1 copolymer, ethylene/propylene/butene-1 copolymer, ethylene/vinyl acetate copolymer, ionically crosslinked olefin copolymer (ionomer) and ethylene/acrylic acid ester copolymer. Among them, the ionomer is preferred. As a base polymer of the ionomer, there can be used an ethylene/(meth)acrylic acid copolymer and ethylene/(meth)acrylic acid ester/(meth)acrylic acid copolymer. As the ion species, there can be used Na, K, Zn, etc. As the thermoplastic elastomer, there can be used styrene/butadiene/styrene block copolymer, styrene/isoprene/styrene block copolymer, hydrogenated styrene/butadiene/styrene block copolymer and hydrogenated styrene/isoprene/styrene block copolymer.

The polyarylate is defined as a polyester derived from a divalent phenol and a dibasic acid. As the divalent phenol, bisphenols can be used, such as 2,2′-bis(4-hydroxyphenyl)propane (bisphenol A), 2,2′-bis(4-hydroxyphenyl)butane (bisphenol B), 1,1′-bis(4-hydroxyphenyl)ethane, bis(4-hydroxyphenyl)methane (bisphenol F), 4-hydroxyphenyl ether, and p-(4-hydroxy)phenol. Among them, bisphenol A and bisphenol B are preferred. As the dibasic acid, there can be used terephthalic acid, isophthalic acid, 2,2-(4-carboxyphenyl)propane, 4,4′-dicarboxydiphenyl ether, and 4,4′-dicarboxybenzophenone. The polyacrylate may be a homopolymer or a copolymer derived from the above monomer components.

Or, the polyarylate may be a copolymer of an aliphatic glycol and an ester unit derived from the dibasic acid in a range in which the essential properties thereof are not impaired. The polyacrylates are available as U-Series or AX-series of U-polymers produced by Unitika Co., as Arde ID-100 produced by UCC Co., as APE produced by Bayer Co., as Durel produced by Hoechst Co., as Arylon produced by Du Pont Co., and as NAP resin produced by Kanegafuchi Kagaku Co.

The polycarbonate is a carbonic acid ester resin derived from bicyclic and dihydric phenols and phosgene, and features a high glass transition point and heat resistance. The polycarbonate is desirably a polycarbonate derived from bisphenols such as 2,2′-bis(4-hydroxyphenyl)propane (bisphenol A), 2,2′-bis(4-hydroxyphenyl)butane (bisphenol B), 1,1′-bis(4-hydroxyphenyl)ethane, bis(4-hydroxyphenyl)methane (bisphenol F), 1,1-bis(4-hydroxyphenyl)cyclohexane, 1,1-bis(4-hydroxyphenyl)cyclopentane, 1,1-bis(4-hydroxyphenyl)-1-phenylmethane, 1,1-bis(4-hydroxyphenyl)-1-phenylethane and 1,2-bis(4-hydroxyphenyl)ethane.

The polyester resin layer used in the invention may be a single resin layer or a multiplicity of resin layers formed by the simultaneous extrusion. Use of the multiplicity of polyester resin layers is advantageous since a polyester resin of a composition having excellent adhesive property can be selected for the underlying layer, i.e., can be selected on the side of the surface-treated metal material, and a polyester resin of a composition having excellent resistance against the content, i.e., having excellent anti-extracting property and property for not adsorbing flavor components can be selected for the surface layer.

Examples of the multiplicity of polyester resin layers include, being expressed as the surface layer/lower layer, polyethylene terephthalate/polyethylene terephthalate.isophthalate, polyethylene terephthalate/polyethylene.cyclohexylenedimethylene terephthalate, polyethylene terephthalate containing isophthalate in a small amount .isophthalate/polyethylene terephthalate containing isophthalate in a large amount .isophthalate, polyethylene terephthalate.isophthalate/[a blend of polyethylene terephthalate.isophthalate and polybutylene terephthalate.adipate], to which only, however, the invention is not limited. The thickness ratio of the surface layer:lower layer is desirably in a range of 5:95 to 95:5.

The polyester resin layer can be blended with known blending agents for resins, such as an anti-blocking agent like amorphous silica, inorganic filler, various antistatic agents, lubricant, anti-oxidizing agent, and ultraviolet-ray absorber according to known recipe.

Among them, it is desired to use a tocopherol (vitamin E). It has heretofore been known that the tocopherol works as an anti-oxidizing agent preventing a decrease in the molecular weight due to degradation when the polyester resin is heat-treated to improve dent resistance. In particular, it the polyester composition of the polyester resin blended with the ethylene-type polymer as a reforming resin component is, further, blended with the tocopherol, there are obtained such effects that not only the dent resistance is improved but also corrosion is prevented from taking place through the cracks, and the corrosion resistance is conspicuously improved even in case the coating is cracked as a result of being subjected to severe conditions such as of the retort sterilization and the hot bender.

It is desired that the tocopherol is blended in an amount of 0.05 to 3% by weight and, particularly, 0.1 to 2% by weight.

In the present invention, the thickness of the organic resin layer is desirably in a range of 3 to 50 μm and, particularly, 5 to 40 μm. If the thickness is smaller than the above range, the corrosion resistance is not sufficient. If the thickness is larger than the above range, on the other hand, a problem arouses concerning the workability.

### (Production of the Resin-Coated Metal Material)

In the present invention, the polyester coating layer can be formed on the surface-treated metal material by any means such as extrusion coating method, cast film hot-adhesion method or biaxially drawn film hot-adhesion method. In the case of the extrusion coating method, the surface-treated metal material is coated with the polyester resin that is extruded in a molten state, and the polyester resin is heat-adhered thereto. That is, the polyester resin is melt-kneaded in an extruder, extruded from a T-die in the form of a thin film, and the extruded molten resin film is passed together with the surface-treated metal material through a pair of laminating rolls so as to be pressed and integrated together while being cooled, followed by quick quenching. When the multiplicity of polyester resin layers are to be extrusion-coated, there are used an extruder for the surface resin layer and an extruder for the lower resin layer. The resin flows from the extruders meet together in a multi-layer die. Thereafter, the extrusion-coating is effected in the same manner as the case of the single resin layer. Further, the surface-treated metal material is vertically passed through the pair of laminating rollers, and molten resin webs are supplied to both sides thereof in order to form coatings of the polyester resin on both surfaces of the base member.

Concretely speaking, the resin-coated metal material is produced by the extrusion coating method in a manner as described below. The surface-treated metal material (hereinafter often simply called metal sheet) is, as required, preheated through a heating device and is fed to a nipping position between the pair of laminating rolls. The polyester resin, on the other hand, is extruded into the form of thin film through the die head of the extruder, and is fed to among the laminating rolls and the metal sheet so as to be press-adhered onto the metal sheet by the laminating rolls. The laminating rolls are maintained at a predetermined temperature and work to press-adhere thin films of a thermoplastic resin such as the polyester onto the metal sheet to heat-adhere them together and, thereafter, work to cool them from both sides to obtain a resin-coated metal material. Generally, the thin-coated metal material that is formed is further guided into a water vessel for cooling in order to quickly quench it to prevent crystallization due to the heat.

According to the extrusion coating method, the polyester resin layers are suppressed to a crystallization degree of a low level which is different from the amorphous density by not more than 0.05 g/cm³ as a result of selecting the resin composition and due to being quickly quenched by the rolls and by the cooling vessel, and a sufficient degree of workability is guaranteed in a subsequent working for producing cans and lids. The quick quenching operation is not limited to the above example only, and may be such that the cooling water is sprayed onto the resin-coated metal material that is formed to quickly quench the laminated sheet.

The polyester resin is heat-adhered to the metal sheet relying upon a thermal capacity possessed by the molten resin layers and upon a thermal capacity possessed by the metal sheet. The heating temperature (TI) of the metal sheet is, usually, 90° C. to 290° C. and, particularly, 100° C. to 280° C. while the temperature of the laminating rolls is suitably in a range of 10° C. to 150° C.

The resin-coated metal material of the invention can be further produced by heat-adhering a polyester resin film formed in advance by a T-die method or an inflation film-forming method onto the metal sheet. As the film, there can be used an undrawn film obtained by quickly quenching the extruded film by a cast forming method or a biaxially drawn film obtained by biaxially drawing the above film successively or simultaneously at a drawing temperature and heat-setting the film after it has been drawn.

In the present invention, a variety of constitutions can be employed in addition to the above layer constitution. It is allowable, as a matter of course, to provide a known primer for adhesion between the surface-treated metal material and the polyester layer though it is not particularly needed when the organic surface-treating layer is formed. The adhesive primer exhibits excellent adhesion property to both the metal blank and the film. As the primer coating material featuring excellent adhesion property and corrosion resistance, there can be exemplified a phenol epoxy-type coating material comprising a resol-type phenol-aldehyde resin derived from various phenols and a formaldehyde, and a bisphenol-type epoxy resin, containing the phenol resin and the epoxy resin at a weight ratio of 50:50 to 1:99 and, particularly, at a weight ratio of 40:60 to 5:95. The primer layer for adhesion is, usually, formed maintaining a thickness of 0.01 to 10 μm. The primer layer for adhesion may be formed on the metal blank in advance or may be formed on the polyester film.

### (Metal Can and its Production)

The metal can of the present invention may be produced by any production method so far as it is formed by using the above resin-coated metal material. The metal can may be a three-piece can having seams in the side surface but is, usually, desired to be a seamless can (two-piece can). The seamless can is produced through known means such as draw/redraw working, bend-elongation (stretching) based on draw/redraw working, bend-elongation/ironing working based on the draw/redraw working, or draw-ironing in a manner that the surface of the surface-treated metal material coated with the polyester resin becomes the inside of the can. The seamless can may be a two-piece can used by wrap-seaming the lid after the neck is formed, or may be a bottle-type can used by effecting the capping after a multi-step necking work/threading work. Further, the bottle-type can may be a three-piece can having a shell lid wrap-seamed at the bottom and having a cap at the upper part of the can.

Referring to FIG. 14 showing a seamless can which is a metal can of the present invention, the seamless can 111 is formed by draw-ironing the resin-coated metal material, and includes a bottom portion 112 and a can wall 113. The bottom portion 112 and the can wall 113 are connected together seamlessly. The bottom portion 112 has a thickness at the central portion thereof substantially the same as that of the resin-coated metal material that is used, but the can wall 113 at least partly has a thickness that is reduced to 30% to 70% of the initial sheet thickness due to the working. The can wall 113 has at an upper part thereof a flange portion 115 for wrap-seaming with the can lid formed via a single-step or multi-step neck portion 114.

As described above, the seamless can is produced by drawing and ironing. Here, the drawing and the ironing may be simultaneously executed in one stroke or may be separately executed in separate strokes.

According to a preferred method of producing the seamless can, for example, the resin-coated metal material is cut in a circular shape, formed into a shallow-drawn cup by drawing using a drawing die and a drawing punch in combination, and is subjected to a step of effecting the drawing and the ironing simultaneously in the same metal mold, the step being repeated a plural number of times to form a cup having a small diameter and a large height. According to this forming method, the deformation for reducing the thickness is effected according to a combination of deformation (bend-elongation) by the load in the direction of can axis (direction of height) and deformation (ironing) by the load in the direction of thickness of the can, and in this order, offering an advantage of effectively imparting molecular orientation in the direction of can axis. Thereafter, the cup is subjected to the doming, heat treatment in order to remove residual distortion in the coating resin caused by the working, trimming for the open end, printing on the curved surface, necking and flanging to obtain a can.

The metal can of the present invention can be produced by a conventional production method such as a draw/ironing method disclosed in JP-A-4-231120 and a simultaneous draw/ironing method disclosed in JP-A-9-253772.

### (Can Lid and its Production)

The can lid of the present invention may be produced by any known method so far as it is formed by using the above-mentioned resin-coated metal material. Usually, the can lid will be an easy-to-open can lid of the stay-on-tab type or an easy-to-open can lid of the full-open type.

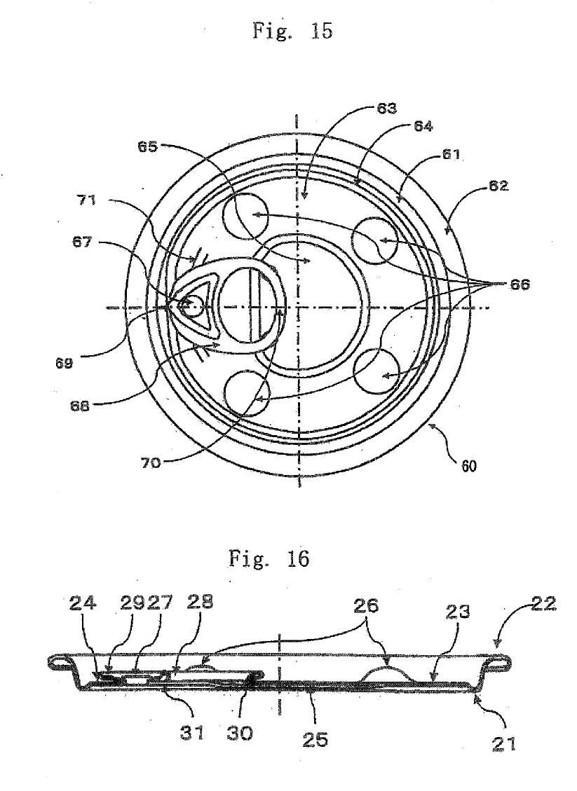

Referring to FIG. 15 which is a top view of the easy-to-open can lid of the invention and FIG. 16 which is a sectional view thereof on an enlarged scale, a lid 60 is formed by using the above resin-coated metal material, has a sealing groove 62 on the outer circumferential side via a ring-like rim portion (counter-sink) 61 to be fitted to the inner surface of the can wall, and a score 64 is formed on the inside of the ring-like rim portion 61 over the whole circumference to sectionalize a portion 63 that is to be opened. On the inside of the portion 63 that is to be opened, there are formed a recessed panel 65 of nearly a semicircular shape formed by pushing in nearly the central portion thereof, dimples 66 formed by protruding the lid member surrounding the recessed panel 65, and a rivet 67 formed by protruding the lid member toward the outer surface side of the can lid, and a tab 68 for opening is fixed by riveting by the rivet 67. The tab 68 for opening has at an end thereof a tip 69 for opening when it is pushed and broken and has at the other end thereof a ring 70 for holding. Near the rivet 67 on the side opposite to the score 64, a score 71 for initiating the breakage is formed being isolated from the score 64.

To open the lid, the ring 70 of tab 68 for opening is held and is lifted up. Therefore, the score 71 for initiating the breakage breaks, the tip 69 for opening of the tab 68 for opening is pushed down relatively greatly, and the score 64 starts to be partly broken.

Next, the ring 70 is pulled up, and the remaining portion of the score 64 is broken over the whole circumference and the lid is easily opened.

The lid concretely described above is of the so-called full-open type. The invention, however, can also be applied to the easy-to-open lid of the stay-on-tab type, as a matter of course.

According to a preferred method of producing the easy-to-open can lid, the resin-coated metal material is punched into a circular shape and into the shape of a lid through a step of press-forming, passed through a lining step where the sealing groove is lined with a compound followed by drying, passed through a score-engraving step where the score is engraved from the outer surface side of the lid so as to reach halfway the metal blank and, thereafter, a rivet is formed, a tab is attached to the rivet, and the tab is fixed by riveting to thereby form an easy-to-open can lid. A suitable example of the easy-to-open can lid has been disclosed in, for example, JP-A-2000-128168.

### EXAMPLES

Next, the invention will be concretely described to clarify the effect by way of Examples and Comparative Examples.

The metal container is placed in the severest environment from the standpoint of working the surface-treated metal material or the resin-coated metal material and the corrosion resistance. Therefore, Examples deal with the metal cans and can lids to which only, however, the invention is in no way limited, as a matter of course.

### [Preparation of the Treating Baths]

Treating baths were prepared by so adjusting the concentrations of titanium ions, zirconium ions and fluorine ions that the aqueous solutions acquired molar concentrations of Ti, Zr and F as shown in Table 2. As the titanium agent, however, a potassium titanium fluoride was used for the treating baths A, B, C and D, and a potassium titanium oxalate dihydride was used for the treating baths E and F. As the zirconium agent, a potassium zirconium fluoride was used for the treating baths B, C and D.

### [Formation of the Polyester Films]

Polyester resins of compositions shown in Table 3 were melt-extruded from the two extruders through a two-layer T-die, and were cooled by the cooling rolls. The thus obtained films were taken up to obtain cast films (a), (b), (c), (d), (e), (f) and (g) constituted as shown in Table 4.

### [Measuring the Surface Atomic Ratios]

In taking a measurement of surface atomic ratios, the inorganic surface-treated metal sheets of before being put to the organic treatment were measured when the organic treatment such as the treatment with a silane coupling agent or the treatment with a phenol-type organic compound is to be executed after the inorganic surface treatment. By using the X-ray photoelectric spectrometer (XPS), the metal materials after the inorganic surface treatment were measured for their peaks P2p, O1s, F1s, Ti3d, Zr3d and Al2p under the following conditions, and the atomic ratios of (P or P+S)/M, O/M and F/M (N is at least one or more of Ti, Zr and Al) were found from the atomic concentrations obtained by using an analytical software. In the case of the silica-dispersed samples, however, a dense silica film was formed on the surfaces. To find O/M, therefore, the peak Si2p was also measured simultaneously, the concentration of O corresponding to SiO₂ was found from the atomic concentration of Si, the atomic concentrations of the initial elements were calculated again excluding the SiO₂ component from the whole components, and the atomic ratio of O/M was found. Further, in the case of the chief element contained in the surface of the base member, e.g., in the case of the aluminum alloy base member, Al2p was also measured simultaneously with P2p, O1s, F1s, Ti3d, Zr3d and Si2p, and the atomic concentration was used when the contaminated layer was lightly removed by Ar sputtering until the atomic concentration of C1s has decreased down to 10% or smaller Concerning the surface exposure ratio, when the base member was, for example, a tin-plated steel sheet-, peaks of chief elements present in the surface, such as C1s, P2p, O1s, F1s, S1s, Al2p, Ti3d, Zr3d, Sn3d5 and Fe2p were measured, and the atomic concentration of tin found by using the analytical software was regarded to be the surface exposure ratio.
Apparatus: Quantum 2000 manufactured by PHI Co.
Exciting X-ray source: Al monochrometer 75W-17 kV
Measuring diameter: φ 100 μm
Photoelectron take-out angle: 90° (0° with respect to the normal of the sample)
Analytical software: MultiPak

### [Evaluation of the Adhesive Property]

The surface-treated metal material was cut into a short strip of a width of 5 mm and a length of 80 mm, and the cast film (c) shown in Table 4 was cut into a short strip of a width of 5 mm and a length of 80 mm. A cut piece of the above polyester film was held between the two pieces of surface-treated short strips obtained above, which was heated at 250° C. for 3 seconds under a pressure of 2.0 kg/cm² to obtain a T-peel test piece. Thereafter, a retort treatment was conducted at 110° C. for 60 minutes. Immediately after the retort treatment, the test piece was immersed in water, pulled out of water just prior to taking a measurement by using a tension tester, and was measured for its adhering strength at a tension speed of 10 mm/min.

### Example 1

### 1. Formation of a Surface-Treated Metal Sheet

As a metal sheet, an aluminum alloy sheet, JIS 5021H18, having a thickness of 0.25 mm was pretreated, i.e., treated with a dewaxing agent 322N8 (produced by Nihon Paint Co.) according to an established method in a bath maintained at 70° C. for 10 seconds, and was washed with water, immersed in 1% sulfuric acid maintained at 40° C. for 5 seconds, washed with water and, then, with pure water. Next, the cathodic electrolysis was intermittently conducted in the treating bath A shown in Table 2 maintained at a bath temperature of 45° C. with stirring, using a titanium sheet coated with iridium oxide disposed at a position maintaining an interelectrode distance of 17 mm as an anode at a current density of 10 A/dm² and flowing the current for 0.4 seconds and halting the current for 0.6 seconds repetitively 4 times. The aluminum alloy sheet was immediately subjected to the after-treatment, i.e., washing with flowing water, with pure water and drying to obtain a surface-treated aluminum sheet.

### 2. Formation of a Resin-Coated Metal Sheet

From the thus obtained surface-treated metal sheet, a resin-o ated metal sheet for producing lids was formed in a manner as described below. First, the lower layer side of the cast film (b) shown in Table 4 was thermally press-adhered onto one surface of the surface-treated metal sheet that has been heated at a temperature of 250° C. by using the laminating rolls, and was immediately cooled with water so as to form the coating on one surface. Next, an epoxyacrylic coating material was applied to the another one surface of the metal sheet that became the outer surface side of the lid by roll-coating, and was baked at 185° C. for 10 minutes.

### 3. Evaluation of the Surface-Treated Metal Plate

Part of the obtained surface-treated metal sheet was measured for its weight film thicknesses of Ti and Zr, and surface atomic ratios and was evaluated for its adhesive property. The results were as shown in Table 5.

In Table 5, the adhesive property was evaluated to be ⊚ when a maximum tensile strength was not smaller than 0.6 kg/5 mm, ◯ when the maximum tensile strength was not smaller than 0.3 kg/5 mm but was smaller than 0.6 kg/5 mm, and X when the maximum tensile strength was smaller than 0.3 kg/5 mm after the test pieces were exfoliated by more than 10 mm by using the tension tester.

### 4. Evaluation of the Openability of can Lids

From the obtained resin-coated metal sheet, full-open can lids of a 301-diameter were formed according to an established method, wrap-seamed with the can walls filled with water, put to the retort sterilization treatment at 110° C. for 60 minutes, cooled, and were immediately opened to observe the state of exfoliation of resin in the opening portions around the score portions to thereby evaluate the openability of the can lids. The results were as shown in Table 5.

In Table 5, the openability of the can lids was evaluated by observing the feathering around the opening portions, and was evaluated to be ⊚ when the feathering was not recognized at all, ◯ when the feathering was smaller than 0.5 mm and the resin was not exfoliated, and X when the feathering was not smaller than 0.5 mm.

### Example 2

The surface was treated, coated with the resin, and the lids were formed and evaluated in the same manner as in Example 1 but setting the current density to be 5 A/dm² and flowing the current for 0.6 seconds and halting the current for 0.4 seconds repetitively 8 times.

### Example 3

The surface was treated, coated with the resin, and the lids were formed and evaluated in the same manner as in Example 1 but using the treating bath B of Table 2 and setting the current density to be 7 A/dm².

### Example 4

The surface was treated, coated with the resin, and the lids were formed and evaluated in the same manner as in Example 1 but using the treating bath B of Table 2 and setting the current density to be 5 A/dm².

### Example 5

The surface was treated, coated with the resin, and the lids were formed and evaluated in the same manner as in Example 1 but using the treating bath C of Table 2 and setting the current density to be 14 A/dm².

### Example 6

The surface was treated, coated with the resin, and the lids were formed and evaluated in the same manner as in Example 1 but using the treating bath D of Table 2 and setting the current density to be 6 A/dm².

### Example 7

The surface Was treated, coated with the resin, and the lids were formed and evaluated in the same manner as in Example 1 but adding Snowtex C (produced by Nissan Kagaku Kogyo Co.) in an amount of 60 g/liter to the bath A of Table 2, setting the current density to be 5 A/dm², and flowing the current for 0.6 seconds and halting the current for 0.4 seconds repetitively 6 times.

### Example 8

### 1. Preparation of a Surface-Treating Agent Comprising Chiefly a Phenol-Type Water-Soluble Organic Compound

The following components were used as the surface-treating agent comprising chiefly the phenol-type water-soluble organic compound.

| | | |
|---|---|---|
| Hydrofluoric acid (HF) | 0.01 | g/liter |
| 75% Phosphoric acid (H₃PO₄) | 0.20 | g/liter |
| 20% zirconium hydrofluoride (H₂ZrF₆) | 1.30 | g/litter |
| Solid component of water-soluble | 0.40 | g/liter |
| polymer of the folowing formula (I) | | |

That is, a water-soluble polymer which is an aqueous phenol resin comprising recurring units represented by the formula (I),

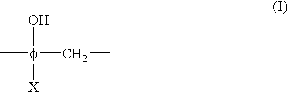

wherein X is a hydrogen atom or a group Z represented by the following formula (II),

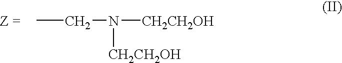

the group Z being introduced at a rate of 0.3 per a benzene ring.

### 2. Formation of the Surface-Treated Metal Sheet and Evaluation

The metal sheet was pretreated in the same manner as in Example 1, and a surface-treating agent comprising chiefly the phenol-type water-soluble organic compound prepared in 1. above was sprayed thereon at 40° C. for 20 seconds, followed by washing with water and, then, with pure water. Thereafter, the surface was treated, coated with the resin, lids were formed and evaluated in the same manner as in Example 1 but using the treating bath A shown in Table 2, setting the current density to be 5 A/dm², and flowing the current for 0.6 seconds and halting the current for 0.4 seconds repetitively 6 times.

### Example 9

The surface was treated, coated with the resin, and the lids were formed and evaluated in the same manner as in Example 1 but adding potassium dihydrogenphosphate in an amount of 0.002 mols/liter to the bath A of Table 2 and flowing the current for 0.6 seconds and halting the current 0.4 seconds repetitively 8 times.

### Example 10

The metal sheet was treated for its surfaces in the same manner as in Example 7, dipped in an aqueous solution containing 3% of γ-aminopropyltrimethoxysilane (product name: KBM903 produced by Shin-Etsu Kagaku Kogyo Co.), squeezed by the rolls, and was dried at 120° C. for one minute to obtain a surface-treated metal sheet having a silane coupling agent layer of a thickness of 5 mg/m² calculated as Si on the inorganic treating layer. In other respects, the surface was treated and coated with the resin, and the lids were formed and evaluated in the same manner as in Example 1. However, the surface atomic ratios were those values obtained before the organic treatment was effected.

### Example 11

The surface was treated, coated with the resin, and the lids were formed and evaluated in the same manner as in Example 1 but adding sodium fluoride in an amount of 0.05 mols/liter to the bath E of Table 2, setting the current density to be 5 A/dm² and flowing the current for 0.6 seconds and halting the a current 0.4 seconds repetitively 8 times.

### Comparative Example 1

The metal sheet was pretreated in the same manner as in Example 1, a bath was prepared according to an established method by using a commercially available titanium-type formation-treating solution (CT-K3795 produced by Nihon Perkalizing Co.) and was sprayed thereon maintaining a solution temperature of 40° for 15 seconds immediately followed by the after-treatments such as washing with water, then, with pure water and drying to obtain a surface-treated aluminum sheet. In other respects, the surface-treated aluminum sheet was coated with the resin, and the lids were formed and evaluated in the same manner as in Example.

### Comparative Example 2

The surface was treated in the same manner as in Example 1 but adjusting the treating bath F of Table 2 with ammonia to possess a pH of 2.3 and conducting the cathodic treatment at a current density of 5 A/dm² for 60 seconds without stirring. The obtained coating was removed if it was washed with flowing water. After the electrolysis, therefore, the surface-treated metal sheet was calmly immersed in a pool of water and was dried. The surface-treated metal sheet was coated with the resin, and the lids were formed and evaluated in the same manner as in Example 1.

### Comparative Example 3

The surface was treated in the same manner as in Comparative Example 2 but adding sodium fluoride in an amount of 0.4 mols/liter to the bath F of Table 2, setting the current density to be 5 A/dm², and flowing the current for 0.6 seconds and halting the current 0.4 seconds repetitively 4 times. The obtained coating was removed if it was washed with flowing water. After the electrolysis, therefore, the surface-treated metal sheet was calmly immersed in a pool of water and was dried. The surface-treated metal sheet was coated with the resin, and the lids were formed and evaluated in the same manner as in Comparative Example 2.

### Comparative Example 4

The surface was treated, coated with the resin, and the lids were formed and evaluated in the same manner as in Example 1 hut conducting the cathodic electrolysis by adding potassium dihydrogenphosphate in an amount of 0.005 mols/liter to the bath A of Table 2, and flowing the current for 0.6 seconds and halting the current 0.4 seconds repetitively 4 times.

### Comparative Example 5

The metal sheet was treated for its surfaces in the same manner as in Example 1, dipped in an aqueous solution containing 30% of γ-aminopropyltrimethoxysilane (product name: KBM903 produced by Shin-Etsu Kagaku Kogyo Co.) squeezed by the rolls, and was dried at 120° C. for one minute to obtain a surface-treated metal sheet having a silane coupling agent layer of a thickness of 50 mg/m² calculated as Si on the inorganic treating layer. In other respects, the surface was treated and coated with the resin, and the lids were formed and evaluated in the same manner as in Example 1. However, the surface atomic ratios were those values obtained before the organic treatment was effected.

### Example 12

### 1. Formation of a Surface-Treated Metal Sheet

As a metal sheet, an aluminum alloy sheet, JIS 3004H19, having a thickness of 0.26 mm was used. In other respects, the surface was treated in the same manner as in Example 1.

### 2. Formation of a Resin-Coated Metal Sheet

The thus obtained surface-treated metal sheet was, first, heated at 250° C. The lower layer side of the cast film (b) shown in Table 4 was thermally press-adhered onto one surface of the metal sheet and the cast film (a) shown in Table 4 was thermally press-adhered onto the another one surface that became the outer surface side of the can by using the laminating rolls so as to cover the surfaces in a contacted manner. The cast films were immediately cooled with water to obtain a resin-coated metal sheet.

### 3. Formation of a Metal Can

A paraffin wax was electrostatically applied onto both surfaces of the obtained resin-coated metal sheet which was, then, punched into a circular shape of a diameter of 154 mm and from which a shallowly drawn cup was formed relying on an established method. The thus drawn cup was subjected to the simultaneous draw/ironing working two times repetitively to form a cup having a small diameter and a large height. The thus obtained cup possessed the following characteristics.

| | |
|---|---|
| Cup diameter | 66 mm |
| Cup height | 128 mm |
| Thickness of can wall relative to the | −60% |
| initial sheet thickness | |

After subjected to the doming, the cup was heat-treated at 220° C. for 60 seconds to remove distortion from the resin film followed by trimming for the opening end, printing on the curved surface, necking for forming a 206-diameter, flanging and re-flanging to obtain a 350-g seamless can.

### 4. Evaluation of the Surface-Treated Metal Sheet

Part of the obtained surface-treated metal sheet was measured for its weight film thicknesses, surface atomic ratios and was evaluated for its adhesive property in the same manner as in Example 1. The results were as shown in Table 5.

### 5. Evaluation of Retort Close Adhesion of the Metal Can

The inner surface of the can after re-flanging was scratched over the whole circumference thereof so as to reach the metal blank at a portion 5 mm lower than the opening end. The can in an empty state was held in the hot steam of 125° C. for 30 minutes to observe the degree of exfoliation of the coated resin on the inner surface of the can near the scratch and to evaluate the retort close adhesion. The results were as shown in Table 5.

In Table 5, the retort close adhesion of the metal cans was evaluated to be ⊚ when no can has developed exfoliation among 20 cans, ◯ when no can has developed exfoliation on the inner surface side among 20 cans but when not more than two cans have partly developed exfoliation on the outer surface side of the cans, and X when the cans have developed exfoliation on the inner surface side of the cans or when not less than three cans have developed exfoliation on the outer surface side of the cans.

### 6. Evaluation of Corrosion Resistance of the Metal Cans

Metal cans packed with carbonated water such that the pressure in the cans at 25° C. was 3.5 kg/cm² were preserved at 37° C. for one week and, thereafter, the can temperature was lowered down to 5° C. The metal cans in an erected state were allowed to fall on a steel plate of a thickness of 10 mm tilted by 15° with respect to the horizontal direction from a height of 50 cm, so that the bottom radius portions were deformed. Thereafter, the bottom portions of the cans inclusive of the bottom radius portions were cut out in the circumferential direction, and were immersed in a 0.1% sodium chloride aqueous solution maintained at 50° C. for 2 weeks. Thereafter, the portions near the deformed bottom radius portions were observed for their corrosion to evaluate the corrosion resistance. The results were as shown in Table 5. In Table 5, the deformed bottom radius portions were observed through a stereomicroscope, and the corrosion resistance of the metal cans was evaluated to be ◯ when no corrosion was observed and X when the metal cans were corroded even to a small extent.

### Example 13

The surface was treated, coated with the resin, and the lids were formed and evaluated in the same manner as in Example 12 but using the treating bath B of Table 2 and setting the current density to be 7 A/dm².

### Example 14

The surface was treated in the same manner as in Example 8 but using an aluminum alloy sheet, JIS 3004H₁₉ having a thickness of 0.26 mm. Thereafter, the surface was treated, coated with the resin, and the lids were formed and evaluated in the same manner as in Example 12.

### Example 15

The metal sheet was treated for its surfaces in the same manner as in Example 1, dipped in an aqueous solution containing 3% of γ-aminopropyltrimethoxysilane (product name: KBM903 produced by Shin-Etsu Kagaku Kogyo Co.), squeezed by the rolls, and was dried at 120° C. for one minute to obtain a surface-treated metal sheet having a silane coupling agent layer formed on the inorganic treating layer. In other respects, the surface was treated and coated with the resin, and the lids were formed and evaluated in the same manner as in Example 1. However, the surface atomic ratios were those values obtained before the organic treatment was effected.

### Example 16

A surface-treating agent was prepared by removing the hydrofluoric acid from the surface-treating agent comprising chiefly the phenol-type water-soluble organic compound used in Example 8. The metal sheet of which the surfaces were treated in the same manner as in Example 1 was dipped in the surface-treating agent, squeezed by the rolls, and was dried at 120° C. for one minute to obtain a surface-treated metal sheet having an organic surface-treating layer comprising chiefly the phenol-type water-soluble organic compound on the inorganic treating layer. In other respects, the surface was treated and coated with the resin, and the lids were formed and evaluated in the same manner as in Example 1. However, the surface atomic ratios were those values obtained before the organic treatment was effected.

### Comparative Example 6

The surface was treated in the same manner as in Comparative Example 1 but using an aluminum alloy sheet, JIS 3004H19 having a thickness of 0.26 mm as the metal sheet. Thereafter, the surface was coated with the resin, and the lids were formed and evaluated in the same manner as in Example 12.

### Example 17

### 1. Formation of a Surface-Treated Metal Sheet

As a metal sheet, a cold-rolled steel sheet having a thickness of 0.22 mm and a tempering degree of DR8 was pre-treated, i.e., electrolytically dewaxed, washed with an acid, washed with water, and washed with pure water. Next, the steel sheet was treated in the same manner as in Example 1 but conducting the cathodic electrolysis in the treating bath A of Table 2 at a current density of 1 A/dm², and flowing the current 0.6 seconds and halting the current 0.4 seconds repetitively 12 times. Thereafter, the steel sheet was dipped in an aqueous solution containing 3% of γ-aminopropyltrimethoxysilane (product name: KBM903 produced by Shin-Etsu Kagaku Kogyo Co.), squeezed by the rolls, and was dried at 120° C. for one minute to obtain a surface-treated metal sheet having a silane coupling agent layer of a thickness of 5 mg/m² calculated as Si on the inorganic treating layer.

### 2. Formation of a Resin-Coated Metal Sheet

The thus obtained surface-treated metal sheet was, first, heated at 250° C. The lower layer side of the cast film (b) shown in Table 4 was thermally press-adhered onto one surface of the metal sheet and the cast film (d) shown in Table 4 was thermally press-adhered onto the another one surface that became the outer surface side by using the laminating rolls. The cast films were immediately cooled with water to obtain a resin-coated metal sheet

### 3. Formation of can Walls and can Lids

A lubricating agent for working was applied onto the obtained resin-coated metal sheet which was, then, re-drawn (drawing ratio of 2.5) to form a can wall of an inner diameter of 65.3 mm. Thereafter, the can wall was heat-treated at 220° C. for 60 seconds to remove distortion from the resin film, followed by trimming for the opening end and flanging to obtain a deeply drawn can having a height of 101.1 mm. Further, part of the thus obtained resin-coated metal sheet was formed into a full-open lid of a 211-diameter relying on an established method.

### 4. Content Filling Test

To test the thus formed can wall and can lid, the can wall was filled with a meat sauce, the full-open lid was double-seamed therewith, and the retort sterilization treatment was conducted at 120° C. for 30 minutes.

### 5. Evaluation of the Surface-Treated Metal Sheet

Part of the obtained surface-treated metal sheet was measured for its weight film thicknesses and surface atomic ratios in the same manner as in Example 1. The results were as shown in Table 6.

### 6. Evaluation of the Containers

After the containers were formed, the organic coating was examined if there were abnormal conditions such as exfoliation and pitting. After preserved at 37° C. for 6 months, the containers containing the content were opened and examined for corrosion or floating of organic coating on the inner surface side of the containers. The results were as shown in Table 6.

### Example 18

### 1. Formation of a Surface-Treated Metal Sheet

As a metal sheet, a cold-rolled steel sheet having a thickness of 0.17 mm and a tempering degree of DR8 was pre-treated, i.e., electrolytically dewaxed, washed with an acid, washed with water, and washed with pure water and was, then, plated with nickel in an amount of 0.3 g/m² on each surface, plated with tin in an amount of 0.6 g/m² on each surface, and was reflow-treated to form a nickel-tin-iron alloy layer on each surface. Next, the steel sheet was cathodically electrolyzed in the treating bath A of Table 2 and was treated with the silane coupling agent in the same manner as in Example 17 to obtain a surface-treated metal sheet.

### 2. Formation of a Resin-Coated Metal Sheet

The thus obtained surface-treated metal sheet was roll-coated on both surfaces thereof with an epoxyacryl-type aqueous coating material in a manner that the thickness of coating after baked was 10 μm followed by baking at 200° C. for 10 minutes to obtain a resin-coated metal sheet.

### 3. Formation of Can Walls and Can Lids

A lubricating agent for working was applied onto the obtained resin-coated metal sheet which was, then, re-drawn (drawing ratio of 1.3) to form a can wall of an inner diameter of 83.3 mm. The can wall was, thereafter, subjected to the trimming for the opening end and flanging to obtain a drawn can having a height of 45.5 mm. Further, part of the thus obtained resin-coated metal sheet was formed into a full-open lid of a 307-diameter relying on an established method.

### 4. Content Filling Test

To test the thus formed can wall and can lid, the can wall was filled with a tuna pickle in oil, the full-open lid was double-seamed therewith, and the retort sterilization treatment was conducted at 115° C. for 60 minutes.

### 5. Evaluation of the Surface-Treated Metal Sheet

The surface-treated metal sheet was measured for its weight film thicknesses and surface atomic ratios in the same manner as in Example 17.

### 6. Evaluation of the Containers

The containers were evaluated in the same manner as in Example 17 but further checking any discoloration due to vulcanization after the containers were opened

### Example 19

### 1. Formation of a Surface-Treated Metal Sheet

As a metal sheet, a cold-rolled steel sheet having a thickness of 0.22 mm and a tempering degree of T4 was pre-treated, i.e., electrolytically dewaxed, washed with an acid, washed with water, washed with pure water and was, then, plated with tin in an amount of 2.0 g/m² on each surface, and was reflow-treated, followed by the cathodic electrolysis in the treating bath A of Table 2 by setting the current density to be 0.6 A/dm² and flowing the current for 0.6 seconds and halting the current for 0.4 seconds repetitively 8 times. In other respects, the cathodic treatment was conducted in the same manner as in Example 1 to obtain the surface-treated metal sheet for producing can walls.

Further, a cold-rolled steel sheet having a thickness of 0.21 mm and a tempering degree of T4 was also treated in the same manner as described above to obtain a surface-treated metal sheet for producing can lids.

### 2. Formation of a Resin-Coated Metal Sheet, Can Walls and Can Lids

The surface-treated metal sheet for producing can walls was marginally coated with the epoxyacrylic aqueous coating material excluding those portions corresponding to the seam portions of the can wall in a manner that the film thicknesses after baking were 5 μm on the inner surface side and 3 μm on the outer surface side, and was cured by baking in a hot air drying furnace heated at 200° C. for 10 minutes to obtain a resin-coated metal sheet. The resin-coated metal sheet was cut into a blank which was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness when dried was 40 μm, followed by baking in the hot air drying furnace heated at 250° C. for 3 minutes in order to obtain a welded can wall (can diameter of 65.4 mm and a can wall height of 122 mm) coating the seamed portions.

The surface-treated metal sheet for producing can lids, on the other hand, was roll-coated on both surfaces thereof with an epoxyacryl-type aqueous coating material in a manner that the thickness of coating after baked was 10 μm followed by baking at 200° C. for 10 minutes to form a shell lid having a 209-diameter relying on an established method.

One open end of the can wall was subjected to the flanging and the necking, and the above lid of the 209-diameter was wrap-seamed therewith while the other open end thereof was subjected to the triple necking and flanging.

### 3. Content Filling Test

The can wall was filled with a coffer at 50° C., a 206-diameter aluminum SOT lid placed in the market was double-seamed therewith, and the retort sterilization treatment was conducted at 125° C. for 25 minutes.

### 4. Evaluation of the Surface-Treated Metal Sheet

The surface-treated metal sheet was measured for its weight film thicknesses and surface atomic ratios in the same manner as in Example 17.

### 6. Evaluation of the Containers

The containers were evaluated in the same manner as in Example 17 but further measuring the amount of iron elution after the containers were opened.

### Example 20

### 1. Formation of a Surface-Treated Metal Sheet

As a metal sheet, a cold-rolled steel sheet having a thickness of 0.22 mm and a tempering degree of T4 was pre-treated, i.e., electrolytically dewaxed, washed with an acid, washed with water, washed with pure water and was, then, plated with nickel in an amount of 0.03 g/m² on each surface, plated with tin in an amount of 1.3 g/m2 on each surface and was reflow-treated, followed by the cathodic treatment in the treating bath A of Table 2 in the same manner as in Example 19 to obtain a surface-treated metal sheet for producing can walls.

Further, a cold-rolled steel sheet having a thickness of 0.21 mm and a tempering degree of T4, too, was treated in the same manner as described above to obtain a surface-treated metal sheet for producing can lids.

### 2. Formation of a Resin-Coated Metal Sheet, Can Walls and Can Lids

The surface-treated metal sheet for producing can walls was marginally coated with an epoxyphenol solvent-type coating material excluding those portions corresponding to the seam portions of the can wall in a manner that the film thicknesses after baking were 5 μm on the inner surface side and 3 μm on the outer surface side, and was cured by baking in a hot air drying furnace heated at 200° C. for 10 minutes to obtain a resin-coated metal sheet. The resin-coated metal sheet was cut into a blank which was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness when dried was 40 μm, followed by baking in the hot air drying furnace heated at 250° C. for 3 minutes in order to obtain a welded can wall (can diameter of 65.4 mm and a can wall height of 122 mm) coating the seamed portions.

The surface-treated metal sheet for producing can lids, on the other hand, was roll-coated on both surfaces thereof with an epoxyphenol-type solvent-type coating material in a manner that the thickness of coating after baked was 10 μm followed by baking at 200° C. for 10 minutes to form a shell lid having a 209-diameter relying on an established method.

One open end of the can wall was subjected to the flanging and the necking, and the above lid of 209-diameter was wrap-seamed therewith while the other open end thereof was subjected to the triple necking and flanging.

### 3. Content Filling Test

The can wall was hot-packed with an orange juice at 93° C., and a 206-diameter aluminum SOT lid placed in the market was double-seamed therewith to seal.

### 4. Evaluation of the Surface-Treated Metal Sheet

The surface-treated metal sheet was measured for its weight film thicknesses and surface atomic ratios in the same manner as in Example 17.

### 5. Evaluation of the Containers

The containers were evaluated in the same manner as in Example 19.

### Example 21

### 1. Formation of a Surface-Treated Metal Sheet

As a metal sheet, a cold-rolled steel sheet having a thickness of 0.195 mm and a tempering degree of T3 was pre-treated, i.e., electrolytically dewaxed, washed with an acid, washed with water, washed with pure water and was, then, plated with tin in an amount of 1.0 g/m² on each surface followed by the cathodic treatment in the treating bath A of Table 2 in the same manner as in Example 19 to obtain a surface-treated metal sheet for producing can walls.

Further, as a metal sheet, an aluminum alloy sheet, JIS 5182H19 having a thickness of 0.285 mm was also cathodically electrolyzed in the treating bath A of FIG. 2 by setting the current density to be 5 A/dm² and flowing the current for 0.6 seconds and holding the current for 0.4 seconds repetitively 8 times. In other respects, the treatment was conducted in the same manner as in Example 1 to obtain a surface-treated metal sheet for obtaining can lids.

### 2. Formation of a Resin-Coated Metal Sheet

The thus obtained surface-treated metal sheet for producing can walls and can lids was, first, heated at 250° C. The lower layer side of the cast film (e) shown in Table 4 was thermally press-adhered onto one surface of the metal sheet and the cast film (d) shown in Table 4 was thermally press-adhered onto the another one surface that became the outer surface side using the laminating rolls. The cast films were immediately cooled with water to obtain a resin-coated metal sheet.

### 3. Formation of Metal Cans and Can Lids

A paraffin wax was electrostatically applied onto both surfaces of the resin-coated metal sheet for producing can walls which was, then, punched into a circular shape of a diameter of 140 mm and from which a shallowly drawn cup was formed relying on an established method. The thus drawn cup was subjected to the simultaneous draw/ironing working two times repetitively to form a deeply drawn and ironed cup having a small diameter and a large height. The thus obtained cup possessed the following characteristics.

| | |
|---|---|
| Cup diameter | 52 mm |
| Cup height | 138 mm |
| Thickness of can wall relative to the | −50% |
| initial sheet thickness | |

After subjected to the doming, the cup was heat-treated at 220° C. for 60 seconds to remove distortion from the resin film, followed by trimming for the opening end, printing on the curved surface, necking for forming a 200-diameter, flanging and re-flanging to obtain a 250-g seamless can.

From the resin-coated metal sheet for producing can lids, further, SOT lids of a 200-diameter were formed.

### 4. Content Filling Test

The above 250-g can wall was cold-packed with a coke at 5° C., and the above SOT Lid was double-seamed therewith to seal.

### 5. Evaluation of the Surface-Treated Metal Sheet

The surface-treated metal sheet was measured for its weight film thicknesses and surface atomic ratios in the same manner as in Example 17.

### 6. Evaluation of the Containers

The containers were evaluated in the same manner as in Example 19

### Example 22

### 1. Formation of a Surface-Treated Metal Sheet and a Resin-Coated Metal Sheet

An aluminum alloy sheet, JIS 3004H19, having a thickness of 0.28 mm was used as a metal sheet for producing can walls and an aluminum alloy sheet, JIS 5182H₁₉, having a thickness of 0.25 mm was used as a metal sheet for producing can lids. These aluminum alloy sheets were pre-treated, treated for their surfaces and were coated with the resin in the same manner as in Example 2 with the exception of being coated on their both surfaces with the cast film (a) of Table 4.

A paraffin wax was electrostatically applied onto both surfaces of the resin-coated metal sheet for producing can walls which was, then, punched into a circular shape of a diameter of 166 mm and from which a shallowly drawn cup was formed relying on an established method. The thus drawn cup was subjected to the redraw/ironing working and to the deep-draw/ironing working to form a can body. The thus obtained can body possessed the following characteristics.

| | |
|---|---|
| Can body diameter | 66 mm |
| Can body height | 128 mm |
| Thickness of can wall relative to the | −63% |
| initial sheet thickness | |

After subjected to the doming, the can body was heat-treated at 220° C. for 60 seconds to remove distortion from the resin film, followed by trimming for the opening end, printing on the curved surface, necking for forming a 206-diameter, flanging and re-flanging to obtain a 350-g seamless can according to the established method. From the resin-coated metal sheet for producing can lids, further, SOT lids of a 206-diameter were formed according to the established method.

### 2. Content Filling Test

The above 350-g can was cold-packed with a beer at 5° C., and the above SOT lid was double-seamed therewith to seal.

### 3. Evaluation of the Surface-Treated Metal Sheet

The surface-treated metal sheet was measured for its weight film thicknesses and surface atomic ratios in the same manner as in Example 17.

### 4. Evaluation of the Containers

The containers were evaluated in the same manner as in Example 17 but further measuring the amount of aluminum elution after the containers were opened.

### Table 2.

TABLE 2

| Treating | Ti | Zr | F |
|---|---|---|---|
| bath | mol/l | mol/l | mo/l |
| A | 0.025 | — | 0.15 |
| B | 0.011 | 0.011 | 0.132 |
| C | 0.022 | 0.011 | 0.198 |
| D | 0.011 | 0.003 | 0.084 |
| E | 0.003 | 0.025 | 0.168 |
| F | 0.011 | — | 0 |

TABLE 3

| | Polyester component | | | | To- | Titanium |
|---|---|---|---|---|---|---|
| | | Ratio of | | Ionomer | copherol | dioxide |
| | Copolymer | copolymer | Content | Content | Content | Content |
| | component | (mol %) | (wt %) | (wt %) | (wt %) | (wt %) |
| A | isophthalic | 12 | 100 | — | — | — |
| | acid | | | | | |
| B | isophthalic | 5 | 100 | — | — | — |
| | acid | | | | | |
| C | isophthalic | 5 | 84 | 15 | 1 | — |
| | acid | | | | | |
| D | isophthalic | 12 | 75 | — | — | 25 |
| | acid | | | | | |
| E | isophthalic | 15 | 84 | 15 | 1 | — |
| | acid | | | | | |
| F | isophthalic | 15 | 100 | — | — | — |
| | acid | | | | | |

TABLE 4

| | |
|---|---|
| Surface layer | Lower layer |

| | Resin | Thickness | Resin | Thickness |
|---|---|---|---|---|
| | composition | (μm) | composition | (μm) |
| (a) | A | 12 | — | — |
| (b) | B | 5 | C | 25 |
| (c) | C | 30 | — | — |
| (d) | A | 5 | D | 10 |
| (e) | B | 5 | E | 25 |
| (f) | B | 5 | E | 10 |
| (g) | B | 5 | F | 10 |

TABLE 5

| | Evaluation of surface-treated metal sheets | | | | | | | | |
|---|---|---|---|---|---|---|---|---|---|
| | Weight film | | | | | | | | |
| | thickness | | | | Surface | | | Surface | |
| | (mg/m²) | | | | atomic ratio | | | covering | Adhesive |
| | Ti | Zr | Si | C | O/M | F/M | P/M | ratio of Si | property |
| Ex. 1 | 23 | — | — | — | 2.68 | 0.23 | 0.00 | — | ◯ |
| Ex. 2 | 65 | — | — | — | 2.37 | 0.36 | 0.00 | — | ◯ |
| Ex. 3 | 15 | 54 | — | — | 2.37 | 0.37 | 0.00 | — | ⊚ |
| Ex. 4 | 14 | 59 | — | — | 2.72 | 0.44 | 0.00 | — | ⊚ |
| Ex. 5 | 36 | 49 | — | — | 2.76 | 0.47 | 0.00 | — | ⊚ |
| Ex. 6 | 18 | 7 | — | — | 2.65 | 0.35 | 0.00 | — | ⊚ |
| Ex. 7 | 42 | — | 33 | — | 2.63 | 0.60 | 0.00 | 20 | ◯ |
| Ex. 8 | 43 | 10 | — | 20 | 3.05 | 0.46 | 0.14 | — | ⊚ |
| Ex. 9 | 52 | — | — | — | 3.80 | 0.72 | 0.20 | — | ◯ |
| Ex. 10 | 40 | — | 38 | — | 2.72 | 0.80 | 0.00 | 20 | ⊚ |
| Ex. 11 | 78 | — | — | — | 3.90 | 0.70 | 0.00 | — | ◯ |
| Ex. 12 | 27 | — | — | — | 2.75 | 0.27 | 0.00 | — | ◯ |
| Ex. 13 | 17 | 48 | — | — | 2.42 | 0.38 | 0.00 | — | ◯ |
| Ex. 14 | 51 | 8 | — | 20 | 3.12 | 0.49 | 0.12 | — | ◯ |
| Ex. 15 | 22 | — | 5 | — | 2.68 | 0.23 | 0.00 | — | ⊚ |
| Ex. 16 | 20 | — | — | 15 | 2.68 | 0.23 | 0.00 | — | ⊚ |
| Comp. Ex. 1 | 14 | — | — | — | 12.3 | 0.42 | 1.20 | — | X |
| Comp. Ex. 2 | 342 | — | — | — | 19.0 | 0.00 | 0.00 | — | X |
| Comp. Ex. 3 | 28 | — | — | — | 125 | 18.5 | 0.00 | — | X |
| Comp. Ex. 4 | 38 | — | — | — | 4.52 | 1.48 | 1.20 | — | X |
| Comp. Ex. 5 | 25 | — | 50 | — | 2.68 | 0.23 | 0.00 | — | X |
| Comp. Ex. 6 | 17 | — | — | — | 11.2 | 0.38 | 1.23 | — | X |

Evaluation of containers

Can

| | Lid | Close | Corrosion |
|---|---|---|---|
| | openability | adhesion | resistance |
| Ex. 1 | ◯ | — | — |
| Ex. 2 | ◯ | — | — |
| Ex. 3 | ⊚ | — | — |
| Ex. 4 | ⊚ | — | — |
| Ex. 5 | ⊚ | — | — |
| Ex. 6 | ⊚ | — | — |
| Ex. 7 | ◯ | — | — |
| Ex. 8 | ⊚ | — | — |
| Ex. 9 | ◯ | — | — |
| Ex. 10 | ⊚ | — | — |
| Ex. 11 | — | ◯ | ◯ |
| Ex. 12 | — | ◯ | ◯ |
| Ex. 13 | — | ◯ | ◯ |
| Ex. 14 | — | ◯ | ◯ |
| Ex. 15 | — | ⊚ | ◯ |
| Ex. 16 | — | ⊚ | ◯ |
| Comp. Ex. 1 | X | — | — |
| Comp. Ex. 2 | X | — | — |
| Comp. Ex. 3 | X | — | — |
| Comp. Ex. 4 | X | — | — |
| Comp. Ex. 5 | X | — | — |
| Comp. Ex. 6 | — | X | X |

TABLE 6

| | | Evaluation of | | | | | Evaluation of | | | |
|---|---|---|---|---|---|---|---|---|---|---|
| | | metal sheet | | | | | container property | | | |
| | | Ti wt. | | | | Container | Inner surface of container | | | |
| | | film | Surface atomic | | | formability | | State | Color of | Metal |
| | | thickness | ratio | | | State of | State of | of org. | inner | elution |
| | Use | (mg/m²) | O/Ti | F/Ti | P/Ti | org. film | corrosion | film | surface | (ppm) |
| Ex. 17 | can wall, | 35 | 1.7 | 1.2 | 0 | normal | normal | normal | — | — |
| | lid | | | | | | | | | |
| Ex. 18 | can wall, | 33 | 2.1 | 0.7 | 0 | normal | normal | normal | normal | — |
| | lid | | | | | | | | | |
| Ex. 19 | wall | 24 | 2.3 | 0.6 | 0 | normal | normal | normal | — | 0.00 |
| | lid | 26 | 2.8 | 0.5 | 0 | | | | | |
| Ex. 20 | wall | 26 | 2.7 | 0.7 | 0 | normal | normal | normal | — | 0.12 |
| | lid | 28 | 2.6 | 0.6 | 0 | | | | | |
| Ex. 21 | wall | 28 | 2.9 | 0.5 | 0 | normal | normal | normal | — | 0.03 |
| | lid | 63 | 2.4 | 0.4 | 0 | | | | | |
| Ex. 22 | wall | 58 | 2.4 | 0.5 | 0 | normal | normal | normal | — | 0.00 |
| | lid | 52 | 2.5 | 0.6 | 0 | | | | | |

### [Preparation of Treating Baths]

Treating baths were prepared by so adjusting the concentrations of zirconium ions and fluorine ions as to obtain aqueous solutions having the molar concentrations of Zr and F as shown in Table 7. As the zirconium agent, however, a potassium bromozirconate was used for the treating baths G and H, a zirconium oxynitrate was used for the treating baths I and J, and an ammonium fluorozirconate was used for the treating bath K. As the fluorine agent, further, a sodium fluoride was used for part of the treating bath H and for the whole of the treating baths I and J.

### [Phenol-Type Aqueous Organic Compound]

The water-soluble polymer of the above formula (1) was used as the phenol-type water-soluble organic compound.

### [Formation of Polyester Films]

Polyester resins of compositions shown in Table 3 were melt-extruded by using two extruders through a 2-layer T-die, were cooled by the cooling rollers, and were taken up to obtain cast films of constitutions shown in Table 4.

The surface-treated metal material was cut into a short strip of a width of 5 mm and a length of 80 mm, and the cast film (c) shown in Table 4 was cut into a short strip of a width of 5 mm and a length of 80 mm. A cut piece of the above polyester film was held between the two pieces of surface-treated short strips, which was heated at 250° C. for 3 seconds under a pressure of 2.0 kg/cm² to obtain a T-peel test piece. Thereafter, a retort treatment was conducted at 110° C. for 60 minutes. Immediately after the retort treatment, the test piece was immersed in water, pulled out of water just prior to taking a measurement by using a tension tester, and was measured for its adhering strength at a tension speed of 10 mm/min.

### Example 23

### 1. Formation of a Surface-Treated Metal Sheet

As a metal sheet, an aluminum alloy sheet, JIS 5021H18, having a thickness of 0.25 mm was pretreated, i.e., treated with a dewaxing agent 322N8 (produced by Nihon Paint Co.) according to an established method in a bath maintained at 70° C. for 10 seconds, and was washed with water, immersed in 1% sulfuric acid maintained at 40° C. for 5 seconds, washed with water and, then, with pure water. Next, the cathodic electrolysis was intermittently conducted in the treating bath G shown in Table 7 maintained at a bath temperature of 45° C. with stirring, using a titanium sheet coated with iridium oxide disposed at a position maintaining an interelectrode distance of 17 mm as an anode at a current density of 5 A/dm² and flowing the current for 0.4 seconds and halting the current for 0.6 seconds repetitively 3 times. Immediately thereafter, the aluminum alloy sheet was after-treated, i.e., washed with flowing water, then, with pure water and was dried. Thereafter, the metal sheet was dipped in an aqueous solution containing 3% of γ-aminopropyltrimethoxysilane (product name: KBM903 produced by Shin-Etsu Kagaku Kogyo Co.), squeezed by the rolls, and was dried at 120° C. for one minute to obtain a surface-treated metal sheet having a silane coupling agent layer formed on the inorganic treating layer.

### 2. Formation of a Resin-Coated Metal Sheet

From the thus obtained surface-treated metal sheet, a resin-coated metal sheet for producing lids was formed in a manner as described below. First, the lower layer side of the cast film (b) shown in Table 4 was thermally press-adhered onto one surface of the surface-treated metal sheet that has been heated at a temperature of 250° C. by using the laminating rolls, and was immediately cooled with water so as to form the coating on one surface. Next, an epoxyacrylic coating material was applied to the another one surface of the metal sheet that became the outer surface side of the lid by roll-coating, and was baked at 185° C. for 10 minutes.

### 3. Evaluation of the Surface-Treated Metal Sheet

Part of the obtained surface-treated metal sheet was measured for its weight film thicknesses of Zr and the like, and surface atomic ratios to the evaluate the adhesive property. The results were as shown in Table 8.

In Table 8, the adhesive property was evaluated to be ⊚ when a maximum tensile strength was not smaller than 1.0 kg/5 mm, ◯ when the maximum tensile strength was not smaller than 0.4 kg/5 mm but was smaller than 1.0 kg/5 mm, and X when the maximum tensile strength was smaller than 0.4 kg/5 mm after the test pieces were exfoliated by more than 10 mm by using the tension tester.

### 4. Evaluation of the Openability of Can Lids

From the obtained resin-coated metal sheet, full-open can lids of a 301-diameter were formed according to an established method, wrap-seamed with the can walls filled with water, put to the retort sterilization treatment at 110° C. for 60 minutes, cooled, and were immediately opened to observe the state of exfoliation of resin in the opening portions around the score portions to thereby evaluate the openability of the can lids. The results were as shown in Table 8.

In Table 8, the openability of the can lids was examined by observing the feathering around the opening portions, and was evaluated to be ⊚ when the feathering was not recognized at all, ◯ when the feathering was smaller than 0.5 mm and the resin was not exfoliated, and X when the feathering was not smaller than 0.5 mm.

### Example 24

An inorganic coating was formed in the same manner as in Example 23 but using a treating bath H of Table 7, setting the current density to be 7 A/dm², flowing the current for 0.6 seconds and halting the current for 0.4 seconds repetitively 4 times, and without conducting the treatment with the silane coupling agent. Thereafter, the metal sheet was dipped in an aqueous solution containing the solid component of the phenol-type water-soluble polymer of the above formula (I) in an amount of 1 g/litter, squeezed by the rolls and dried at 12° C. for one minute to obtain a surface-treated metal sheet having a phenol-type organic surface-treating layer on the inorganic treating layer. The surface-treated metal sheet was coated with the resin, and the lids were formed and evaluated in the same manner as in Example 23,

### Example 25

An aqueous solution containing:

| | |
|---|---|
| Solid component of the phenol-type water-soluble | 0.4 g/liter |
| polymer of the above formula (I): | |
| Hydrofluoric acid (HF) | 0.01 g/liter |
| 75% Phosphoric acid (H₃PO₄) | 0.20 g/liter |
| 20% Zirconium hydrogenfluoride (H₂ZrF₆) | 1.3 g/liter |

was prepared and used as the surface-treating agent.

The metal sheet was pretreated in the same manner as in Example 23, was, thereafter, sprayed with the above surface-treating agent at 40° C. for 20 seconds, and was washed with water and, then, with pure water. Thereafter, the metal sheet was subjected to the inorganic surface treatment, coated with the resin, and the lids were formed therefrom and evaluated in the same manner as in Example 23 but without conducting the treatment with the silane coupling agent.

### Example 26

The metal sheet was treated with the silane coupling agent, coated with the resin, and the lids were formed and evaluated in the same manner as in Example 23 but conducting the inorganic surface treatment by adding a potassium dihydrogenphosphate in an amount of 0.001 mol/liter to the bath G of Table 7, setting the current density to be 10 A/dm² and flowing the current for 0.6 seconds and halting the current for 0.4 seconds repetitively 4 times.

### Example 27

The metal sheet was treated with the silane coupling agent, coated with the resin, and the lids were formed and evaluated in the same manner as in Example 23 but using the treating bath J of Table 7, setting the current density to be 10 A/dm² and flowing the current for 0.6 seconds and halting the current for 0.4 seconds repetitively 4 times.

### Example 28

The metal sheet was subjected to the inorganic surface treatment, to the treatment with the silane coupling agent, and was coated with the resin, and the lids were formed and evaluated in the same manner as in Example 23 but using a bath obtained by adding the Snowtex C (produced by Nissan Kagaku Kogyo Co.) in an amount of 6.0 g/liter to the bath G of Table 7.

### Comparative Example 7

The metal sheet was subjected to the inorganic surface treatment, was coated with the resin, and the lids were formed and evaluated in the same manner as in Example 23 but conducting the inorganic surface treatment at a current density of 2.5 A/dm² and flowing the current for 0.6 seconds and halting the current for 0.4 seconds repetitively 5 times without conducting the treatment with the silane coupling agent.

### Comparative Example 8

The metal sheet was treated with the silane coupling agent, coated with the resin, and the lids were formed and evaluated in the same manner as in Example 23 but without conducting the inorganic surface treatment after the metal sheet has been pre-treated in the same manner as in Example 23.

### Comparative Example 9

The metal sheet was coated with the resin, and the lids were formed and evaluated in the same manner as in Example 25 by pre-treating the metal sheet and treating the surfaces with the phenol-type organic compound in the same manner as in Example 23 but without conducting the inorganic surface treatment.

### Comparative Example 10

The metal sheet was pretreated in the same manner as in Example 23. Thereafter, a bath was prepared according to an established method by using a commercially available zirconium-type formation-treating solution (Alodine 404 manufactured by Nihon Parkalizing Co.), and was sprayed thereon at a solution temperature of 40° C. for 15 seconds. Immediately thereafter, the metal sheet was after-treated, i.e., washed with water and, then, with pure water and was dried. Thereafter, the metal sheet was treated with the salane coupling agent, coated with the resin, and the lids were formed and evaluated in the same manner as in Example 23.

### Comparative Example 11

The pretreatment and the inorganic surface treatment were conducted in the same manner as in Comparative Example 10 but spraying a commercially available zirconium-type formation-treating solution (Alodine-404 manufactured by Nihon Parkalizing Co.) for 18 seconds. Thereafter, the metal sheet was subjected to the surface treatment with the phenol-type organic compound, coated with the resin, and the lids were formed and evaluated in the same manner as in Example 24.

### Comparative Example 12

The metal sheet was treated with the silane coupling agent, coated with the resin, and the lids were formed and evaluated in the same manner as in Example 23 but conducting the inorganic surface treatment by using a treating bath I of Table 7 at a current density of 10 A/dm² and flowing the current for 0.6 seconds and halting the current for 10.4 seconds repetitively 4 times. However, the coating obtained by the inorganic surface treatment was removed if it was washed with flowing water. After the electrolysis, therefore, the surface-treated metal sheet was calmly immersed in a pool of water and was dried.

### Comparative Example 13

The metal sheet was subjected to the inorganic surface treatment, treated with the silane coupling agent, was coated with the resin, and the lids were formed and evaluated in the same manner as in Example 23 but conducting the cathodic electrolysis by adding the potassium dihydrogenphosphate in an amount of 0.005 mols/liter to the bath G of Table 7, and flowing the current for 0.6 seconds and halting the current for 0.4 seconds repetitively 4 times.

### Example 29

### 1. Formation of a Surface-Treated Metal Sheet and a Resin-Coated Metal Sheet

An aluminum alloy sheet, JIS 3104H1.9, having a thickness of 0.28 mm was used as a metal sheet, and both surfaces thereof were coated with the lower layer sides of the cast films (g) and (f) of Table 4. Thereafter, the metal sheet was subjected to the pretreatment, inorganic surface treatment, treatment with the silane coupling agent, and was coated with the resin in the same manner as in Example 23.

A paraffin wax was electrostatically applied onto both surfaces of the resin-coated metal sheet which was, then, punched into a circular shape of a diameter of 166 mm and from which a shallowly drawn cup was formed relying on an established method in such a manner that the surface coated with the film (f) of Table 4 was on the inner surface side. Next, the shallowly drawn cup was subjected to the redraw/ironing working to obtain a deeply drawn and ironed can body. The thus obtained can body possessed the following characteristics.

| | |
|---|---|
| Can body diameter | 66 mm |
| Can body height | 128 mm |
| Thickness of can wall relative to the | −63% |
| initial sheet thickness | |

After subjected to the doming, the can body was heat-treated at 220° C. for 60 seconds to remove distortion from the resin film, followed by trimming for the opening end, printing on the curved surface, necking for forming a 206-diameter, flanging and re-flanging to obtain a 350-g seamless can according to the established method.

### 2. Evaluation of the Retort Close Adhesion of the Metal Can

The inner surface of the can and the outer surface of the can after re-flanging were scratched over the whole circumference thereof so as to reach the metal blank at portions 5 mm lower than the opening end. The can in an empty state was held in the hot steam of 125° C. for 30 minutes to observe the degree of exfoliation of the coated resin on the inner and outer surfaces of the can near the scratch and to evaluate the retort close adhesion. The results were as shown in Table 8.

In Table 8, the retort close adhesion of the metal cans was evaluated to be ⊚ when no can has developed exfoliation among 20 cans, ◯ when no can has developed exfoliation on the inner surface side among 20 cans but when not more than two cans have partly developed exfoliation on the outer surface side of the cans, and X when the cans have developed exfoliation on the inner surface side of the cans or when not less than three cans have developed exfoliation on the outer surface side of the cans.

### 3. Evaluation of Corrosion Resistance of the Metal Cans

Metal cans packed with carbonated water such that the pressure in the cans at 25° C. was 3.5 kg/cm² were preserved at 37° C. for one week and, thereafter, the can temperature was lowered down to 5° C. The metal cans in an erected state were allowed to fall on a steel plate of a thickness of 10 mm tilted by 15° with respect to the horizontal direction from a height of 50 cm, so that the bottom radius portions were deformed. Thereafter, the bottom portions of the cans inclusive of the bottom radius portions were cut out in the circumferential direction, and were immersed in a 0.1% sodium chloride aqueous solution maintained at 50° C. for 2 weeks. Thereafter, the portions near the deformed bottom radius portions were observed for their corrosion to evaluate the corrosion resistance. The results were as shown in Table 8. In Table 8, the deformed bottom radius portions were observed through a stereomicroscope, and the corrosion resistance of the metal cans was evaluated to be ◯ when no corrosion was observed and X when the metal cans were corroded even to a small extent.

### Example 30

A resin-coated metal sheet was prepared, the retort close adhesion of the cans was evaluated and the corrosion resistance was evaluated in the same manner as in Example 29 but conducting the surface treatment in the same manner as in Example 24.

### Example 31

A resin-coated metal sheet was prepared, the retort close adhesion of the cans was evaluated and the corrosion resistance was evaluated in the same manner as in Example 29 but conducting the surface treatment in the same manner as in Example 25.

### Example 32

A resin-coated metal sheet was prepared, the retort close adhesion of the cans was evaluated and the corrosion resistance was evaluated in the same manner as in Example 29 but conducting the surface treatment in the same manner as in Example 28.

### Example 33

A resin-coated metal sheet was formed, the retort close adhesion of the cans was evaluated and the corrosion resistance was evaluated in the same manner as in Example 29 but conducting the inorganic surface treatment by using a bath obtained by adding the Snowtex C (produced by Nissan Kagaku Kogyo Co.) to the bath G of Table 7, setting the current density to be 1 A/dm², and flowing the current for 0.6 seconds and halting the current for 0.4 seconds repetitively 3 times without conducting the organic treatment.

### Comparative Example 14

A resin-coated metal sheet was formed, the retort close adhesion of the cans was evaluated and the corrosion resistance was evaluated in the same manner as in Example 29 but conducting the surface treatment in the same manner as in Comparative Example 7.

### Comparative Example 15

A resin-coated metal sheet was formed, the retort close adhesion of the cans was evaluated and the corrosion resistance was evaluated in the same manner as in Example 29 but conducting the surface treatment in the same manner as in Comparative Example 8.

### Comparative Example 16

A resin-coated metal sheet was formed, the retort close adhesion of the cans was evaluated and the corrosion resistance was evaluated in the same manner as in Example 29 but conducting the surface treatment in the same manner as in Comparative Example 9.

### Example 34

### 1. Formation of a Surface-Treated Metal Sheet

As a metal sheet, a cold-rolled steel sheet having a thickness of 0.195 mm and a tempering degree of T3 was pre-treated, i.e., electrolytically dewaxed, washed with an acid, washed with water, washed with pure water and was, then, plated with tin in an amount of 1.0 g/m² on each surface followed by the cathodic treatment in the treating bath K of Table 7 at a current density of 0.6 A/dm² flowing the current for 0.6 seconds and halting the current for 0.4 seconds repetitively 8 times. In other respects, the inorganic surface treatment was conducted followed by the treatment with the silane coupling agent in the same manner as in Example 23 to obtain a surface-treated metal sheet.

### 2. Formation of a Resin-Coated Metal Sheet

The Thus Obtained Surface-Treated Metal Sheet was, First, heated at 250° C. The lower layer side of the cast film (e) shown in Table 4 was thermally press-adhered onto one surface of the metal sheet and the cast film (d) shown in Table 4 was thermally press-adhered onto the another one surface that became the outer surface side using the laminating rolls. The cast films were immediately cooled with water to obtain a resin-coated metal sheet.

### 3. Formation of a Can Wall

A paraffin wax was electrostatically applied onto both surfaces of the resin-coated metal sheet which was, then, punched into a circular shape of a diameter of 140 mm and from which a shallowly drawn cup was formed relying on an established method. The thus drawn cup was subjected to the redraw/ironing working two times repetitively to form a deeply drawn and ironed cup having a small diameter and a large height. The thus obtained cup possessed the following characteristics.

| | |
|---|---|
| Cup diameter | 52 mm |
| Cup height | 138 mm |
| Thickness of can wall relative to the | −50% |
| initial sheet thickness | |

After subjected to the doming, the cup was heat-treated at 220° C. for 60 seconds to remove distortion from the resin film, followed by trimming for the opening end, printing on the curved surface, necking for forming a 200-diameter, flanging and re-flanging to obtain a 250-g seamless can.

### 4. Evaluation of the Surface-Treated Metal Sheet

The surface-treated metal sheet was measured for its weight film thicknesses and surface atomic ratios in the same manner as in Example 24.

### 5. Evaluation of the Close Adhesion at the Time of Forming

After the shallowly drawn cup was formed, the resin at the end of the cup was observed for its follow-up state. The adhesion was evaluated to be X when the resin was hanging down by more than 0.5 mm from the end of the cup, Δ when the resin was hanging down by not more than 0.5 mm but not less than 0.1 mm from the end of the cup, and ◯ when the resin was hanging down by less than 0.1 mm.

### 6. Evaluation of the Retort Close Adhesion

The outer surface of the can after re-flanging was scratched over the whole circumference thereof so as to reach the metal blank at a portion 5 mm lower than the opening end. The can in an empty state was held in the hot steam of 125° C. for 30 minutes to observe the degree of exfoliation of the coated resin on the outer surface of the can near the scratch and to evaluate the retort close adhesion. The results were as shown in Table 9.

In Table 9, the retort close adhesion of the metal cans was evaluated to be ◯ when there was no exfoliation at all, Δ when the coating was exfoliated partly, and X when the coating was exfoliated over the whole circumference.

### Example 35

The steel sheet was plated with tin in the same manner as in Example 34, was subjected to the inorganic surface treatment by using a bath obtained by adding the Snowtex C (produced by Nissan Kagaku Kogyo Co.) in an amount of 60 g/liter to the bath K of Table 7 at a current density of 1 A/dm² by flowing the current for 0.6 seconds and halting the current for 0.4 seconds repetitively 3 times, and was subjected to the treatment with the silane coupling agent, coated with the resin, and the cans were formed and evaluated in the same manner as in Example 34.

### Example 36

The steel sheet same as that of Example 34 was plated with tin, was subjected to the inorganic surface treatment by cathodic electrolysis and was subjected to the surface treatment with the phenol-type organic compound in the same manner as in Example 24 to obtain a surface-treated metal sheet having an organic surface-treating layer formed on the inorganic surface-treating layer. Thereafter, the surface-treated metal sheet was coated with the resin, and the cans were formed and evaluated in the same manner as in Example 34.

### Comparative Example 17

The steel sheet was subjected to the surface treatment, coated with the resin, and the cans were formed and evaluated in the same manner as in Example 34 but without conducting the treatment with the silane coupling agent,

### Comparative Example 18

After plated with tin, the steel sheet was subjected to the surface treatment, coated with the resin, and the cans were formed and evaluated in the same manner as in Example 34 but effecting neither the inorganic surface treatment nor the treatment with the silane coupling agent, i.e., coating the tin plating directly with the resin.

### Comparative Example 19

The steel sheet was plated with tin and was subjected to the cathodic electrolysis in an aqueous solution containing sodium dichromate in an amount of 30 g/liter to form an inorganic coating of chromium oxide in an amount of 5 mg/m² to thereby obtain a surface-treated metal sheet which was, then coated with the resin, and from which the cans were formed and evaluated in the same manner as in Example 34.

### Comparative Example 20

The steel sheet was plated with tin and was subjected to the inorganic surface treatment in the same manner as in Example 34. Thereafter, the metal sheet was dipped in an aqueous solution containing 30% of γ-aminopropyltrimethoxysilane (product name: KBM903 produced by Shin-Etsu Kagaku Kogyo Co.), squeezed by the rolls, and was dried at 120° C. for one minute to obtain a surface-treated metal sheet having a silane coupling agent layer of a thickness of 50 mg/m² calculated as Si on the inorganic treating layer. Thereafter, the surface-treated metal sheet was coated with the resin and from which the cans were formed and evaluated in the same manner as in Example 34.

### Comparative Example 21

The steel sheet was plated with tin and was subjected to the inorganic surface treatment in the same manner as in Example 34. Thereafter, the metal sheet was dipped in an aqueous solution containing 0.5% of γ-aminopropyltrimethoxysilane (product name, KBM903 produced by Shin-Etsu Kagaku Kogyo Co.), squeezed by the rolls, and was dried at 120° C. for one minute to obtain a surface-treated metal sheet having a silane coupling agent layer of a thickness of 0.3 mg/m² calculated as Si on the inorganic treating layer. Thereafter, the surface-treated metal sheet was coated with the resin and from which the cans were formed and evaluated in the same manner as in Example 34.

### Comparative Example 22

The steel sheet was plated with tin in the same manner as in Example 34. Without conducting the inorganic surface treatment, however, the steel sheet was subjected to the surface treatment with the phenol-type organic compound in the same manner as in Example 36 to obtain a surface-treated metal sheet. Thereafter, the surface-treated metal sheet was coated with the resin and from which the cans were formed and evaluated in the same manner as in Example 34.

### Example 37

### 1. Formation of a Surface-Treated Metal Sheet

As a metal sheet, a cold-rolled steel sheet having a thickness of 0.17 mm and a tempering degree of DR8 was pre-treated, i.e., electrolytically dewaxed, washed with an acid, washed with water, washed with pure water and was, then, plated with nickel in an amount of 0.3 g/m² on each surface and with tin in an amount of 0.6 g/m² on each surface followed by the reflow treatment to form a nickel-tin-iron alloy layer on each surface. Thereafter, the cathodic electrolysis was conducted in the treating bath K of Table 7 followed by the treatment with the silane coupling agent in the same manner as in Example 34 to obtain a surface-treated metal sheet.

### 2. Formation of a Resin-Coated Metal Sheet

The thus obtained surface-treated metal sheet was roll-coated on its both surfaces with an epoxyacrylic aqueous coating material such that the film thickness after baking was 10 μm, and was baked at 200° C. for 10 minutes to obtain a resin-coated metal sheet.

### 3. Formation of Can Walls and Can Lids

A lubricating agent for working was applied onto the obtained resin-coated metal sheet which was, then, drawn (drawing ratio of 1.3) to form a can wall of an inner diameter of 83.3 mm. Next, the open end was trimmed. Thereafter, the flanging was effected to form a drawn can of a height of 45.5 mm. By using part of the thus obtained resin-coated metal sheet, further, full-open lids of a 307-diameter were formed according to the established method.

### 4. Content Filling Test

To test the thus formed can wall and can lid, the can wall was filled with a tuna pickle in oil, the full-open lid was double-seamed therewith, and the retort sterilization treatment was conducted at 115° C. for 60 minutes.

### 5. Evaluation of the Vulcanization Resistance

After filled with the contents and retort-sterilized, the containers were preserved at 37° C. for 6 months, and were opened to examine any discoloration by vulcanization on the inner surface sides of the can wall and the can lid. The containers were evaluated to be X when they had been discolored conspicuously, and ◯ when they had not been greatly discolored. The results were as shown in Table 9.

### Comparative Example 23

The steel sheet was plated with nickel and with tin, and was subjected to the reflow treatment to form a nickel-tin-iron alloy layer in the same manner as in Example 37. The thus treated steel sheet was, thereafter, treated with the silane coupling agent in the same manner as in Example 37 without, however, conducting the inorganic surface treatment to thereby obtain a surface-treated metal sheet. Thereafter, the steel sheet was coated with the resin and from which the can walls and can lids were formed and evaluated in the same manner as in Example 37.

### Example 38

### 1. Formation of a Surface-Treated Metal Sheet

As a metal sheet, a cold-rolled steel sheet having a thickness of 0.22 mm and a tempering degree of T4 was pre-treated, i.e., electrolytically dewaxed, washed with an acid, washed with water, washed with pure water and was, then, plated with nickel in an amount of 0.03 g/m² on each surface, plated with tin in an amount of 1.3 g/m² on each surface and was reflow-treated, followed by the inorganic surface treatment and the treatment with the silane coupling agent to obtain a surface-treated metal sheets for producing can walls.

Further, a cold-rolled steel sheet having a thickness of 0.21 mm and a tempering degree of T4, too, was treated in the same manner as described above to obtain a surface-treated metal sheet for producing can lids.

### 2. Formation of a Resin-Coated Metal Sheet, Can Walls and Can Lids

The surface-treated metal sheet for producing can walls was marginally coated with an epoxyphenol solvent-type coating material except those portions corresponding to the seam portions of the can wall in a manner that the film thicknesses after baking were 5 μm on the inner surface side and 3 μm on the outer surface side, and was cured by baking in a hot air drying furnace heated at 200° C. for 10 minutes to obtain a resin-coated metal sheet. The resin-coated metal sheet was cut into a blank which was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness when dried was 40 μm, followed by baking in the hot air drying furnace heated at 250° C. for 3 minutes in order to obtain a welded can wall (can diameter of 65.4 mm and a can wall height of 122 mm) coating the seamed portions.

The surface-treated metal sheet for producing can lids, on the other hand, was roll-coated on both surfaces thereof with an epoxyphenol solvent-type coating material in a manner that the thickness of coating after baked was 10 μm followed by baking at 200° C. for 10 minutes to form a shell lid having a 209-diameter relying on an established method.

One open end of the can wall was subjected to the flanging and necking, and the above lid of the 209-diameter was wrap-seamed therewith while the other open end thereof was subjected to the triple necking and flanging.

### 3. Content Filling Test

The can wall was hot-packed with an orange juice at 93° C., and a 206-diameter aluminum SOT lid placed in the market was double-seamed therewith to seal.

### 4. Evaluation of the Corrosion Resistance

After filled with the contents, the containers were preserved at 37° C. for 6 months, and were opened to also examine the amount of iron that has eluted out. The containers were evaluated to be X when the amount of elution was not smaller than 0.2 ppm, ◯ when the amount of elution was not smaller than 0.1 pp but was smaller than 0-2 ppm, and ⊚ when the amount of elution was smaller than 0.1 ppm. The results were as shown in Table 9.

### Example 39

The steel sheet was plated with nickel and tin, and was reflow-treated in the same manner as in Example 38. Thereafter, the steel sheet was subjected to the inorganic surface treatment by using a bath obtained by adding the Snowtex C (produced by Nissan Kagaku Kogyo Co.) in an amount of 60 g/liter to the bath K of Table 7 at a current density of 5 A/dm² by flowing the current for 0.6 seconds and halting the current for 0.4 seconds repetitively 3 times, and was subjected to the treatment with the silane coupling agent, coated with the resin, and the cans and lids were formed and evaluated in the same manner as in Example 38.

### Comparative Example 24

The steel sheet was plated with nickel and tin, and was reflow-treated in the same manner as in Example 38. Thereafter, the steel sheet was subjected to the inorganic surface treatment by using the bath K of Table 7, setting the current density to be 0.6 A/dm² and flowing the current for 0.6 seconds and halting the current for 0.4 seconds repetitively 8 times. Without conducting the treatment with the silane coupling agent, however, the above treated steel sheet was coated with the resin, and the cans and lids were formed and evaluated in the same manner as in Example 38.

### Example 40

### 1. Formation of a Surface-Treated Metal Sheet

As a metal sheet, a cold-rolled steel sheet having a thickness of 0.22 mm and a tempering degree of DR8 was pre-treated, i.e., electrolytically dewaxed, washed with an acid, washed with water and washed with pure water. The thus treated steel sheet was subjected to the inorganic surface treatment and to the treatment with the silane coupling agent in the same manner as in Example 23 but conducting the cathodic electrolysis in the treating bath K of Table 7 at a current density of 0.6 A/dm² flowing the current for 0.6 seconds and halting the current for 0.4 seconds repetitively 8 times.

### 2. Formation of a Resin-Coated Metal Sheet

The thus obtained surface-treated metal sheet was, first, heated at 250° C. The lower layer side of the cast film (b) shown in Table 4 was thermally press-adhered onto one surface of the metal sheet and the cast film (d) shown in Table 4 was thermally press-adhered onto the another one surface that became the outer surface side using the laminating rolls. The cast films were immediately cooled with water to obtain a resin-coated metal sheet.

### 3. Formation of Can Walls and Can Lids

A lubricating agent for working was applied onto the obtained resin-coated metal sheet which was, then, redrawn (drawing ratio of 2.5) to form a can wall of an inner diameter of 65.3 mm. Next, the can wall was heat-treated at 220° C. for 60 seconds to remove distortion from the resin film, followed by trimming for the opening end and flanging to form a deeply drawn can having a height of 101.1 mm. By using part of the thus obtained resin-coated metal sheet, on the other hand, a full-open lid of a 211-diameter was formed according to an established method.

### 4. Content Filling Test

To test the thus formed can wall and can lid, the can wall was filled with a meat sauce, the full-open lid was double-seamed therewith, and the retort sterilization treatment was conducted at 120° C. for 30 minutes.

### 5. Evaluation of the Inner Surface State of the Containers

The containers that were formed were examined for their state of organic coating to observe any abnormal condition such as exfoliation and pitting. Further, after filled with the contents, the containers were preserved stored at 37° C. for 6 months, and were opened to examine the corrosion and floating of the organic coating on the inner surface side of the containers. The results were as shown in Table 9.

TABLE 7

| Treating | Zr | F |
|---|---|---|
| bath | mol/l | mo/l |
| G | 0.022 | 0.132 |
| H | 0.011 | 0.090 |
| I | 0.100 | 0.400 |
| J | 0.020 | 0.050 |
| K | 0.022 | 0.132 |

TABLE 8

| | Evaluation of metal sheet | | | | | | | |
|---|---|---|---|---|---|---|---|---|
| | Wt. film | | | | | | Si | |
| | thickness | | | Surface | | | surface | Ad- |
| | (mg/m²) | | | atomic ratio | | | covering | hesive |
| | Zr | Si | C | O/Zr | F/Zr | P/Zr | ratio | property |
| Ex. 23, 29 | 67 | 5 | — | 2.4 | 0.4 | 0.0 | — | ◯ |
| Ex. 24, 30 | 42 | — | 10 | 2.8 | 0.9 | 0.0 | — | ◯ |
| Ex. 25, 31 | 71 | — | 12 | 3.1 | 0.5 | 0.2 | — | ◯ |
| Ex. 26 | 79 | 6 | — | 2.8 | 1.1 | 0.2 | — | ◯ |
| Ex. 27 | 23 | 6 | — | 3.8 | 0.7 | 0.0 | — | ◯ |
| Ex. 28, 22 | 74 | 30 | — | 2.6 | 0.5 | 0.0 | 23 | ⊚ |
| Ex. 33 | 48 | 26 | — | 5.5 | 1.0 | 0.0 | 25 | — |
| Comp. | 82 | — | — | 2.6 | 1.3 | 0.0 | — | ◯ |
| ex. 7, 14 | | | | | | | | |
| Comp. | — | 5 | — | — | — | — | — | X |
| ex. 8, 15 | | | | | | | | |
| Comp. | 5 | — | 13 | 6.0 | 0.5 | 1.2 | — | X |
| ex. 9, 16 | | | | | | | | |
| Comp. Ex. | 9 | 6 | — | 9.1 | 0.5 | 1.1 | — | X |
| 10 | | | | | | | | |
| Comp. Ex. | 13 | — | 15 | 11 | 0.3 | 0.9 | — | X |
| 11 | | | | | | | | |
| Comp. Ex. | 69 | 5 | — | 593 | 22 | 0.0 | — | X |
| 12 | | | | | | | | |
| Comp. Ex. | 70 | 5 | — | 5.5 | 2.1 | 1.1 | — | ◯ |
| 13 | | | | | | | | |

Evaluation of containers

Can

| | Lid | Close | Corrosion |
|---|---|---|---|
| | openability | adhesion | resistance |
| Ex. 23, 29 | ⊚ | ⊚ | ◯ |
| Ex. 24, 30 | ⊚ | ⊚ | ◯ |
| Ex. 25, 31 | ⊚ | ⊚ | ◯ |
| Ex. 26 | ⊚ | — | — |
| Ex. 27 | ⊚ | — | — |
| Ex. 28, 32 | ⊚ | ⊚ | ◯ |
| Ex. 33 | — | ◯ | ◯ |
| Comp. ex. 7, 14 | ◯ | ◯ | ◯ |
| Comp. ex. 8, 15 | X | ◯ | X |
| Comp. ex. 9, 16 | X | ◯ | X |
| Comp. Ex. 10 | X | — | — |
| Comp. Ex. 11 | X | — | — |
| Comp. Ex. 12 | X | — | — |
| Comp. Ex. 13 | ◯ | — | — |

TABLE 9

| | Evaluation of metal sheet | | | | | | |
|---|---|---|---|---|---|---|---|
| | Wt. film thickness | | | Surface | | | Si surface |
| | (mg/m²) | | | atomic ratio | | | covering |
| | Zr | Si | C | O/Zr | F/Zr | P/Zr | ratio |
| Ex. 34, 37, 38, 40 | 20 | 5 | — | 3.7 | 0.4 | 0.0 | — |
| Ex. 35, 39 | 33 | 52 | — | 5.8 | 0.5 | 0.0 | 20 |
| Ex. 36 | 24 | — | 13 | 2.5 | 1.1 | 0.0 | — |
| Comp. ex. 17, 24 | 54 | — | — | 2.8 | 0.6 | 0.0 | — |
| Comp. Ex. 18 | — | — | — | — | — | — | — |
| Comp. Ex. 19 | — | — | — | — | — | — | — |
| Comp. Ex. 20 | 29 | 50 | — | 2.5 | 0.7 | 0.0 | — |
| Comp. Ex. 21 | 20 | 0.3 | — | 2.7 | 0.6 | 0.0 | — |
| Comp. Ex. 22 | — | — | 15 | — | — | — | — |
| Comp. Ex. 23 | — | 5 | — | — | — | — | — |

| | Evaluation of container property | | | | | |
|---|---|---|---|---|---|---|
| | Deep-draw/ironed can | | | | Deep-drawn can | |
| | Close | Close | | | State of | |
| | adhesion | adhesion | Drawn can | Welded can | inner surface | |
| | when | when | Vulcanization | Corrosion | After | After |
| | formed | retorted | resistance | resistance | formed | preserved |
| Ex. 34, 37, 38, 40 | ◯ | ◯ | ◯ | ◯ | normal | normal |
| Ex. 35, 39 | ◯ | ◯ | — | ⊚ | — | — |
| Ex. 36 | ◯ | ◯ | — | — | — | — |
| Comp. ex. 17, 24 | ◯ | Δ | — | ◯ | — | — |
| Comp. Ex. 18 | Δ | X | — | — | — | — |
| Comp. Ex. 19 | ◯ | Δ | — | — | — | — |
| Comp. Ex. 20 | Δ | Δ | — | — | — | — |
| Comp. Ex. 21 | ◯ | Δ | — | — | — | — |
| Comp. Ex. 22 | Δ | Δ | — | X | — | — |
| Comp. Ex. 23 | ◯ | — | X | X | — | — |

### [Preparation of the Treating Bath]

Treating baths were prepared by so adjusting the concentrations of aluminum ions, titanium ions, zirconium ions and fluorine ions that the aqueous solutions acquired molar concentrations of Al, Ti, Zr and F as shown in Table 10. As the aluminum agent, however, an aluminum nitrate Al(NO₃)₃.9H₂O was used for the treating baths L, M, N, O, P, Q, U, V, W, Xr Y and Z, an aluminum sulfate Al₂ (SO₄)₃.13H₂O was used for the treating bath R and an aluminum dihydrogenphosphate solution Al(H₂PO₄)₃ was used for the treating bath S. For the treating bath T, an agent was used that was obtained by mixing the aluminum dihydrogenphosphate solution Al(H₂PO₄)₃ and an aluminum dihydrogenphosphate aluminum nitrate solution Al(H₂PO₄)₃Al (NO₃)₃.9H₂O at a molar ratio of 2 to 8. As the zirconium agent, an ammonium zirconium fluoride (NH₄)₂ZrF₆ was used for the treating baths U and W. As the titanium agent, an ammonium titanium fluoride (NH₄)₂TiF₆ was used for the treating baths V and W. As a fluorine source, further, a sodium fluoride NaF was used for the treating baths M, O, Q, T and X, an ammonium fluoride NH₄F was used for the treating baths P and Z, and a boric acid H₃BO₃ was used as a buffer agent for the treating baths M and O.

### [Formation of the Polyester Films]

Polyester resins of compositions shown in Table 11 were melt-extruded from the two extruders through a two-layer T-die, and were cooled by the cooling rolls. The thus obtained films were taken up to obtain cast films (h), (i), (j), (k), (l), (m) and (n) constituted as shown in Table 12.

### <Evaluation of the Steel Members>

### [Evaluation of the Adhesive Property]

The surface-treated metal material was cut into a short strip of a width of 5 mm and a length of 80 mm, and the cast film (n) shown in Table 12 was cut into a short strip of a width of 5 mm and a length of 80 mm. A cut piece of the above polyester film was held between the two pieces of surface-treated short strips, which was heated at 220° C. for 3 seconds under a pressure of 2.0 kg/cm² to obtain a T-peel test piece. Thereafter, a retort treatment was conducted at 110° C. for 60 minutes. Immediately after the retort treatment, the test piece was immersed in water, pulled out of water just prior to taking a measurement by using a tension tester, and was measured for its adhering strength at a tension speed of 10 mm/min.

### [Evaluation of the Corrosion Resistance]

The surface-treated metal material was cut into a short strip of a width of 70 mm and a length of 150 mm, and the cut portions were protected over a width of 3 mm with a tape. The surface-treated metal material was sprayed with a 5% NaCl aqueous solution maintained at 35° C. for 6 hours to observe the occurrence of iron rust.

### [Evaluation of the Vulcanization Resistance]

The surface-treated metal material was cut into a square of 70 mm and was protruded by using the Erichsen tester. Next, the cut portions were protected over a width of 3 mm with a tape, and the surface-treated metal material was immersed in a model solution of a mixture of 4.5 g/liter of a potassium dihydrogenphosphate KH₂PO₄.12 g/liter of a sodium hydrogenphosphate Na₂HPO₄.12H₂O and a 2 g/liter of an L-cystine hydrochlorate monohydrate, and was retort-treated in a sealed container at 115° C. for 60 minutes.

### [Evaluation of Discoloration]

The surface-treated metal material was cut into a square of 70 mm, heated at 200° C. for one hour to compare the degree of discoloration after having been heated.

### Example 41

### 1. Formation of a Surface-Treated Metal Sheet

As a metal sheet, a cold-rolled steel sheet having a thickness of 0.195 mm and a tempering degree of T3 was pre-treated, i.e., electrolytically dewaxed, washed with an acid, washed with water, washed with pure water and was, then, plated with tin in an amount of 1.3 g/m² on each surface, reflow-treated and was, then, subjected to the cathodic electrolysis in the treating bath L of Table 10 at a bath temperature of 45° C. with stirring using, as an anode, a titanium sheet coated with iridium oxide disposed at a position of an interelectrode distance of 17 mm at a current density of 2 A/m² for 12 seconds immediately followed by the after-treatment, i.e., washing with flowing water, washing with pure water and drying.

### 2. Evaluation of the Surface-Treated Metal Material

Part of the obtained surface-treated metal material was measured for its weight film thicknesses such as of Al, Ti and Zr, surface atomic ratios, surface exposure ratios, and was evaluated for its corrosion resistance and adhesive property. The results were as shown in Table 13.

In Table 13, the adhesive property was evaluated to be ⊚ when a maximum tensile strength was not smaller than 0.6 kg/5 mm, ◯ when the maximum tensile strength was not smaller than 0.3 kg/5 mm but was smaller than 0.6 kg/5 mm, Δ when the maximum tensile strength was not smaller than 0.2 kg/5 mm but was smaller than 0.3 kg/5 mm and X when the maximum tensile strength was smaller than 0.2 kg/5 mm after the test pieces were exfoliated by more than 10 mm by using the tension tester.

Further, the corrosion resistance was evaluated to be ⊚ when almost no rust was developing, ◯ when rust was slightly recognized, Δ when rust was developing not less than 10% but less than 20% of the surface areas, and X when rust was developing not less than 20% of the surface areas.

Further, the vulcanization resistance was evaluated to be ⊚ when the worked portions had not been discolored, ◯ when the worked portions had been discolored not more than 25% as the area ratio, and X when the worked portions had been further discolored.

The discoloration was evaluated by eyes to be ◯ when there was almost no discoloration or when the discolored portions occupied less than 20% as the area ratio, and X when the discolored portions occupied more than 20% as the area ratio.

### Example 42

The evaluation was conducted in the same manner as in Example 41 but using a surface-treated metal material obtained by plating tin in an amount of 5.6 g/m² and intermittently conducting the cathodic electrolysis in the treating bath M of Table 10 at a current density of 2 A/dm² and flowing the current for 0.6 seconds and halting the current for 0.4 seconds repetitively 8 times.

### Example 43

The evaluation was conducted in the same manner as in Example 41 but using a surface-treated metal material obtained by conducting the cathodic electrolysis in the treating bath N in Table 10 at a current density of 1 A/dm² for 24 seconds.

### Example 44

The inorganic surface-treating layer was formed in the same manner as in Example 43 but plating tin in an amount of 0.4 g/m², and forming an alloy layer by reflowing, so that there was no free tin on the surfaces, and the surface-treated metal material was evaluated in the same manner as in Example 40.

### Example 45

The evaluation was conducted in the same manner as in Example 41 but using a surface-treated metal material obtained by conducting the cathodic electrolysis in the treating bath M in Table 10 at a current density of 1 A/dm² for 12 seconds.

### Example 46

The evaluation was conducted in the same manner as in Example 41 but using a surface-treated metal material obtained by plating tin in an amount of 0.4 g/m², forming an alloy layer by reflowing, so that there was no free tin on the surfaces, and conducting the cathodic electrolysis in the treating bath M of Table 10 at a current density of 1 A/dm² for 4 seconds.

### Example 47

The evaluation was conducted in the same manner as in Example 41 but using a surface-treated metal material obtained by plating tin in an amount of 2.8 g/m² and intermittently conducting the cathodic electrolysis in the treating bath M of Table 1) at a current density of 1.2 A/dm² and flowing the current for 0.6 seconds and halting the current for 0.4 seconds repetitively 16 times.

### Example 48

The evaluation was conducted in the same manner as in Example 41 but using a surface-treated metal material obtained by plating tin in the same amount as that of Example 41 without conducting the reflow treatment, and conducting the cathodic electrolysis in the treating bath O of Table 10 at a current density of 1 A/dm² for 4 seconds.

### Example 49

The evaluation was conducted in the same manner as in Example 41 but using a surface-treated metal material obtained by plating tin in an amount of 0.9 g/m² and intermittently conducting the cathodic electrolysis in the treating bath P of Table 10 at a current density of 1 A/dm² and flowing the current for 0.6 seconds and halting the current for 0.4 seconds repetitively 6 times.

### Example 50

The evaluation was conducted in the same manner as in Example 41 but using a surface-treated metal material obtained by conducting the cathodic electrolysis in the treating bath Q of Table 10 at a current density of 1 A/dm² for 8 seconds.

### Example 51

The evaluation was conducted in the same manner as in Example 41 but using a surface-treated metal material obtained by intermittently conducting the cathodic electrolysis in the treating bath R of Table 10 at a current density of 2 A/dm² and flowing the current for 0.6 seconds and halting the current for 0.4 seconds repetitively 8 times.

### Example 52

The evaluation was conducted in the same manner as in Example 41 but using a surface-treated metal material obtained by conducting the cathodic electrolysis in the treating bath S of Table 10 at a current density of 2 A/dm² for 24 seconds.

### Example 53

The evaluation was conducted in the same manner as in Example 41 but using a surface-treated metal material obtained by conducting the cathodic electrolysis in the treating bath T of Table 10 at a current density of 1 A/dm² for 8 seconds.

### Example 54

The evaluation was conducted in the same manner as in Example 41 but using a surface-treated metal material obtained by plating tin in an amount of 0.7 g/m² and intermittently conducting the cathodic electrolysis in the treating bath U of Table 10 at a current density of 1 A/dm² and flowing the current for 0.6 seconds and halting the current for 0.4 seconds repetitively 8 times.

### Example 55

The evaluation was conducted in the same manner as in Example 41 but using a surface-treated metal material obtained by plating tin in an amount of 2.8 mg/m² without conducting the reflow treatment, and conducting the cathodic electrolysis in the treating bath V of Table 10 at a current density of 2 A/dm² for 8 seconds.

### Example 56

The evaluation was conducted in the same manner as in Example 41 but using a surface-treated metal material obtained by intermittently conducting the cathodic electrolysis in the treating bath W of Table 10 at a current density of 2 A/dm² flowing the current for 0.6 seconds and halting the current for 0.4 seconds repetitively 16 times.

### Example 57

The evaluation was conducted in the same manner as in Example 41 but using a surface-treated metal material obtained by conducting the cathodic electrolysis in the treating bath X in Table 10 at a current density of 2 A/dm² for 8 seconds.

### Example 58

The evaluation was conducted in the same manner as in Example 41 but using a surface-treated metal material obtained by plating tin in an amount of 11.2 g/m² and intermittently conducting the cathodic electrolysis in the treating bath P of Table 10 at a current density of 1 A/dm² flowing the current for 0.6 seconds and halting the current for 0.4 seconds repetitively 4 times.

### Comparative Example 25

The evaluation was conducted in the same manner as in Example 41 but using a surface-treated metal material obtained by conducting the cathodic electrolysis in the treating bath Q in Table 10 at a current density of 1 A/dm² for 16 seconds.

### Comparative Example 26

The evaluation was conducted in the same manner as in Example 41 but using a surface-treated metal material obtained by plating tin in an amount of 0.4 g/m², forming an alloy layer by reflowing, so that there was no free tin on the surfaces, and intermittently conducting the cathodic electrolysis in the treating bath S of Table 10 at a current density of 2 A/dm² flowing the current for 0.6 seconds and halting the current for 0.4 seconds repetitively 4 times.

### Comparative Example 27

The evaluation was conducted in the same manner as in Example 41 but using a surface-treated metal material obtained by conducting the cathodic electrolysis in the treating bath S in Table 10 at a current density of 2 A/dm² for 4 seconds.

### Comparative Example 28

The evaluation was conducted in the same manner as in Example 41 but using a surface-treated metal material obtained by plating tin in an amount of 0.4 g/m², forming an alloy layer by reflowing, so that there was no free tin on the surfaces, and intermittently conducting the cathodic electrolysis in the treating bath Z of Table 10 at a current density of 2 A/dm² flowing the current for 0.6 seconds and halting the current for 0.4 seconds repetitively 4 times.

### Comparative Example 29

The evaluation was conducted in the same manner as in Example 41 but using a surface-treated metal material obtained by plating tin in an amount of 2.8 g/m², conducting the cathodic treatment in an aqueous solution of sodium dichromate, and conducting the chrome-type surface treatment using chromium oxide in an amount of 3 mg/m² relying on an established method.

### Comparative Example 30

The evaluation was conducted in the same manner as in Example 41 but using a surface-treated metal material obtained by conducting the cathodic treatment in an aqueous solution of anhydrous chromic acid and sulfuric acid, and conducting the chrome-type surface treatment using metal chromium in an amount of 7 mg/m² and chromium oxide in an amount of 12 mg/m² relying on an established method.

### Comparative Example 31

A surface-treated metal material was obtained by conducting the plating with tin and reflow treatment in the same manner as in Example 41, and intermittently conducting the cathodic electrolysis in an aqueous solution containing 0.025 mols/liter of ammonium fluorozirconate and 0.005 mols/liter of potassium nitrate at a current density of 7.5 A/dm² flowing the current for 0.6 seconds and halting the current for 0.4 seconds repetitively 4 times. Discoloration occurred conspicuously with the passage of time, and no other properties were evaluated except discoloration.

### Example 59

### 1. Preparation of a Surface-Treating Agent Comprising Chiefly a Phenol-Type Water-Soluble Organic Compound

A compound of the formula (1) above was used as the phenol-type water-soluble organic compound.

### 2. Formation of a Surface-Treated Metal Material and its Evaluation

The surface-treating agent comprising chiefly the phenol-type water-soluble organic compound prepared in 1. above was sprayed at 40° C. for 20 seconds onto the inorganic surface-treating layer formed in Example 41, and was washed with water and, then, with pure water to obtain a surface-treated metal material having an organic surface-treating layer formed on the inorganic surface-treating layer. The adhesive property, corrosion resistance and vulcanization resistance were evaluated in the same manner as in Example 41 to obtain results as shown in Table 14.

### Example 60

The treatment and evaluation were conducted in the same manner as in Example 59 but forming a phenol-type water-soluble organic compound layer on the inorganic surface-treating layer formed in Example 42. Further, the surfaces were analyzed by XPS before and after the organic surface treatment. A peak N1s was confirmed that was not existing before the organic surface treatment.

### Example 61

The treatment and evaluation were conducted in the same manner as in Example 59 but forming the phenol-type water-soluble organic compound layer on the inorganic surface-treating layer formed in Example 43.

### Example 62

The inorganic surface-treating layer formed in Example 41 was dipped in an aqueous solution of 3% of γ-aminopropyltrimethoxysilane (product name, KBM903, produced by Shin-Etsu Kagaku Kogyo Co.), squeezed by the rolls, and was dried at 120° C. for one minute to obtain a surface-treated metal material having a silane coupling agent layer of a film thickness calculated as Si of 5 mg/m² formed on the inorganic-treating layer. The surface-treated metal material was evaluated in the same manner as in Example 59.

### Example 63

The treatment and evaluation were conducted in the same manner as in Example 62 but forming a silane coupling agent layer on the inorganic surface-treating layer formed in Example 42. Further the surfaces were analyzed by XPS before and after the organic surface treatment. A peak N1s was confirmed that was not existing before the organic surface treatment.

### Example 64

The treatment and evaluation were conducted in the same manner as in Example 62 but forming a silane coupling agent layer on the inorganic surface-treating layer formed in Example 46.

### Example 65

The treatment and evaluation were conducted in the same manner as in Example 62 but forming a silane coupling agent layer on the inorganic surface-treating layer formed in Example 51. Further, the surfaces were analyzed by XPS before and after the organic surface treatment. A peak N1s was confirmed that was not existing before the organic surface treatment.

### Example 66

The treatment and evaluation were conducted in the same manner as in Example 62 but forming a silane coupling agent layer on the inorganic surface-treating layer formed in Example 51.

### Example 67

The treatment and evaluation were conducted in the same manner as in Example 62 but forming a silane coupling agent layer on the inorganic surface-treating layer formed in Comparative Example 25.

### Example 68

The treatment and evaluation were conducted in the same manner as in Example 62 but forming a silane coupling agent layer on the inorganic surface-treating layer formed in Comparative Example 26.

### Example 69

The treatment and evaluation were conducted in the same manner as in Example 62 but forming a silane coupling agent layer on the inorganic surface-treating layer formed in Comparative Example 27.

### Example 70

The treatment and evaluation were conducted in the same manner as in Example 62 but forming a silane coupling agent layer on the inorganic surface-treating layer formed in Comparative Example 28.

### Comparative Example 32

The inorganic surface-treating layer formed in Example 41 was dipped in an aqueous solution of 30% of γ-aminopropyltrimethoxysilane (product name, KBM903, produced by Shin-etsu Kagaku Kogyo Co.), squeezed by the rolls, and was dried at 120° C. for one minute to obtain a surface-treated metal material having a silane coupling agent layer of a film thickness calculated as Si of 50 mg/m² formed on the inorganic-treating layer. The surface-treated metal material was evaluated in the same manner as in Example 59.

### <Evaluation of Aluminum Material>

### Example 71

### 1. Formation of a Surface-Treated Metal Material

As a metal sheet, an aluminum alloy sheet, JIS 5021H18, having a thickness of 0.25 mm was pretreated, i.e., treated with a dewaxing agent 322N8 (produced by Nihon Paint Co.) in a bath maintained at 70° C. for 10 seconds, and was washed with water, immersed in 1% sulfuric acid maintained at 40° C. for 5 seconds, washed with water and, then, with pure water according to an established method. Next, in the treating bath Q shown in Table 10, the aluminum alloy sheet was subjected to the intermittent cathodic electrolysis at a current density of 7 A/dm² flowing the current for 0.4 seconds and halting the current for 0.6 seconds repetitively 4 times to thereby obtain a surface-treated aluminum sheet.

### 2. Formation of a Resin-Coated Metal Material

From the thus obtained surface-treated metal material, a resin-coated metal material for producing lids was formed in a manner as described below. First, the lower layer side of the cast film (h) shown in Table 12 was thermally press-adhered onto one surface of the surface-treated metal material that has been heated at a temperature of 250° C. by using the laminating rolls, and was immediately cooled with water so as to form the coating on one surface. Next, an epoxyacrylic coating material was applied to the another one surface of the metal sheet that became the outer surface side of the lid by roll-coating, and was baked at 185° C. for 10 minutes.

### 3. Evaluation of the Surface-Treated Metal Material

Part of the obtained inorganic surface-treated metal material was measured for its weight film thicknesses, surface atomic ratios and was evaluated for its adhesive property. The results were as shown in Table 15.

The film (i) of Table 12 was press-adhered to the adhesion test pieces at 250° C. to obtain T-peel test pieces in the same manner as in Example 41. The adhesive property was evaluated to be ⊚ when a maximum tensile strength was not smaller than 0.6 kg/5 mm, ◯ when the maximum tensile strength was not smaller than 0.3 kg/5 mm but was smaller than 0.6 kg/5 mm, and X when the maximum tensile strength was smaller than 0.3 kg/5 mm after the test pieces were exfoliated by more than 10 mm by using the tension tester.

### 4. Evaluation of the Openability of can Lids

From the obtained resin-coated metal material, full-open can lids of a 301-diameter were formed according to an established method, wrap-seamed with the can walls filled with water, put to the retort sterilization treatment at 110° C. for 60 minutes, cooled, and were immediately opened to observe the state of exfoliation of resin in the opening portions around the score portions to thereby evaluate the openability of the can lids. The results were as shown in Table 15.

In Table 15, the openability of the can Lids was examined by observing the feathering around the opening portions, and was evaluated to be ⊚ when the feathering was not recognized at all, ◯ when the feathering was smaller than 0.5 mm and the resin was not exfoliated, and X when the feathering was not smaller than 0.5 mm.

### Example 72

### 1. Formation of a Surface-Treated Metal Material

The surface was treated in the same manner as in Example 71 but using, as a metal sheet, an aluminum alloy sheet, JIS 3004H19, having a thickness of 0.26 mm.

### 2. Formation of a Resin-Coated Metal Material

The thus obtained surface-treated metal material was heated at 250° C., the lower layer side of the cast film (h) shown in Table 12 was thermally press-adhered onto one surface of the metal sheet, the cast film (m) of Table 12 was thermally press-adhered onto another one surface thereof that became the outer surface side of the can by using the laminating rolls, and the films were immediately cooled with water to obtain a resin-coated metal material.

### 3. Formation of the Metal Cans

A paraffin wax was electrostatically applied onto both surfaces of the resin-coated metal material which was, then, punched into a circular shape of a diameter of 154 mm and from which a shallowly drawn cup was formed relying on an established method. The thus drawn cup was subjected to the simultaneous draw/ironing working two times repetitively to form a cup having a small diameter and a large height. The thus obtained cup possessed the following characteristics.

| | |
|---|---|
| Cup diameter | 66 mm |
| Cup height | 128 mm |
| Thickness of can wall relative to the | −60% |
| initial sheet thickness | |

After subjected to the doming, the cup was heat-treated at 220° C. for 60 seconds to remove distortion from the resin film, followed by trimming for the opening end, printing on the curved surface, necking for forming a 206-diameter, flanging and re-flanging to obtain a 350-g seamless can.

### 4. Evaluation of the Surface-Treated Metal Material

The thus obtained inorganic surface-treated metal sheet was measured for its weight film thicknesses and surface atomic ratios in the same manner as in Example 41 to obtain the results as shown in Table 15.

### 5. Evaluation of the Retort Close Adhesion of the Metal Cans

The outer surface of the can after re-flanging was scratched over the whole circumference thereof so as to reach the metal blank at a portion 5 mm lower than the opening end. The can in an empty state was held in the hot steam of 125° C. for 30 minutes to observe the degree of exfoliation of the coated resin on the inner surface side of the can near the scratch and to evaluate the retort close adhesion. The results were as shown in Table 15.

In Table 15, the retort close adhesion of the metal cans was evaluated to be ◯ when quite no can developed exfoliation even partly among 20 cans, and X when there was a can that developed exfoliation even partly among 20 cans.

### 6. Evaluation of Corrosion Resistance of the Metal Cans

Metal cans packed with carbonated water such that the pressure in the cans at 25° C. was 3.5 kg/cm² were preserved at 37° C. for one week and, thereafter, the can temperature was lowered down to 5° C. The metal cans in an erected state were allowed to fall on a steel plate of a thickness of 10 mm tilted by 15° with respect to the horizontal direction from a height of 50 cm, so that the bottom radius portions were deformed. Thereafter, the bottom portions of the cans inclusive of the bottom radius portions were cut out in the circumferential direction, and were immersed in a 0.1% sodium chloride aqueous solution maintained at 50° C. for 2 weeks. Thereafter, the portions near the deformed bottom radius portions were observed for their corrosion to evaluate the corrosion resistance. The results were as shown in Table 15.

In Table 15, the deformed bottom radius portions were observed through a stereomicroscope, and the corrosion resistance of the metal cans was evaluated to be ◯ when no corrosion was observed and X when the metal cans were corroded even to a small extent.

### Example 73

The surface-treated metal material was coated with the resin, and from which the lids were formed and evaluated in the same manner as in Example 71 but treating the metal sheet and forming the inorganic surface-treating layer thereon in the same manner as in Example 71, and forming a silane coupling agent layer having a thickness calculated as Si of 5 mg/m² on the inorganic-treating layer in the same manner as in Example 62.

### Example 74

The surface-treated metal material was coated with the resin, and from which the lids were formed and evaluated in the same manner as in Example 72 but treating the metal sheet and forming the inorganic surface-treating layer thereon in the same manner as in Example 72, and forming a silane coupling agent layer having a thickness calculated as Si of 5 mg/m² on the inorganic-treating layer in the same manner as in Example 62.

### Comparative Example 33

The aluminum alloy sheet, JIS 5021H18, having a thickness of 0.25 mm was pre-treated in the same manner as in Example 71 but was not subjected to the inorganic surface treatment. The metal sheet was, thereafter, subjected to the phenol-type organic surface treatment in the same manner as in Example 59 and was, thereafter, coated with the resin and from which the lids were formed and evaluated in the same manner as in Example 71. The weight film thickness formed by the organic surface treatment was 13 mg/m² as calculated as the amount of C and was 5 mg/m² as calculated as the amount of Zr.

### Comparative Example 34

The aluminum alloy sheet, JIS 5021H18, having a thickness of 0.25 mm was pre-treated in the same manner as in Example 71. A bath was prepared according to an established method by using a commercially available zirconium-type formation-treating solution (Alodine 404, produced by Nihon Parkalizing Co.), was sprayed thereon at a solution temperature of 40° C. for 15 seconds, and was, immediately thereafter, subjected to the after-treated, i.e., washed with water, washed with pure water and was dried. Thereafter, the surface-treated metal sheet was coated with the resin, and from which the lids were formed and evaluated in the same manner as in Example 71.

### Comparative Example 35

The aluminum alloy sheet, JIS 3004H19, having a thickness of 0.26 mm was pre-treated in the same manner as in Example 72, subjected to the phenol-type organic surface treatment in the same manner as in Example 59 and was, thereafter, coated with the resin and from which the lids were formed and evaluated in the same manner as in Example 72. Here, however, the surface-treated metal material was evaluated after it has been subjected to the phenol-type organic surface treatment

### Comparative Example 36

The aluminum alloy sheet, JIS 3004H19, having a thickness of 0.26 mm was pre-treated in the same manner as in Example 72, subjected to the inorganic surface treatment in the same manner as in Comparative Example 34 and was, thereafter, coated with the resin and from which the lids were formed and evaluated in the same manner as in Example 72.

### Comparative Example 37

The metal material was coated with the resin and from which the lids were formed and evaluated in the same manner as in Example 71 but using a surface-treated metal material obtained by conducting the cathodic electrolysis in the treating bath Y of Table 10 at a current density of 2 A/dm² for 9 seconds

### Comparative Example 38

The metal material was coated with the resin and from which the lids were formed and evaluated in the same manner as in Example 72 but using the surface-treated metal material obtained by conducting the cathodic electrolysis in the treating bath Y of Table 10 at a current density of 2 A/dm² for 9 seconds.

### Comparative Example 3.9

The surface-treated metal material was coated with the resin, and from which the lids were formed and evaluated in the same manner as in Example 71 but treating the metal sheet and forming the inorganic surface-treating layer thereon in the same manner as in Example 71, and forming a silane coupling agent layer having a thickness calculated as Si of 50 mg/m² on the inorganic-treating layer in the same manner as in Comparative Example 32.

### Comparative Example 40

The surface-treated metal material was coated with the resin, and from which the lids were formed and evaluated in the same manner as in Example 72 but treating the metal sheet and forming the inorganic surface-treating layer thereon in the same manner as in Example 72, and forming a silane coupling agent layer having a thickness calculated as Si of 50 mg/m² on the inorganic-treating layer in the same manner as in Comparative Example 32.

### Comparative Example 41

The metal sheet was coated with the resin and from which the lids were formed and evaluated in the same manner as in Example 71 but forming an aqueous solution containing sulfuric acid in an amount of 15% by weight, forming an opposing electrode by using an aluminum sheet, conducting the anodic oxidation treatment at a solution temperature of 40° C. for 15 seconds maintaining a voltage of 15 V, immediately followed by the after-treatment, i.e., washing with waters with pure water and drying.

### Comparative Example 42

The surface-treated metal material was coated with the resin, and from which the lids were formed and evaluated in the same manner as in Example 72 but conducting the anodic oxidation treatment in the same manner as in Comparative Example 41.

### Evaluation of Real Cans

### Example 75

### 1. Formation of a Surface-Treated Metal Material

As a metal sheet, a cold-rolled steel sheet having a thickness of 0.22 mm and a tempering degree of DR8 was pretreated, i.e., treated with an acid, washed with water and, then, with pure water. The metal sheet was further treated in the same manner as in Example 41 but conducting the cathodic electrolysis in a treating bath O of Table 10 at a current density of 1 A/dm² flowing the current for 0.6 seconds and halting the current for 0.4 seconds repetitively 12 times. Thereafter, the metal sheet was dipped in an aqueous solution of 3% γ-aminopropyltrimethoxysilane (product name, KBM903, produced by Shin-Etsu Kagaku Kogyo Co.), squeezed by using the rolls and was dried at 120° C. for one minute to obtain a surface-treated metal material having a silane coupling agent layer of a thickness calculated as Si of 5 mg/m² formed on the inorganic-treating layer.

### 2. Formation of a Resin-Coated Metal Material

The thus obtained surface-treated metal material was heated at 250° C., the lower layer side of the cast film (h) shown in Table 12 was thermally press-adhered onto one surface of the metal sheet, the cast film (j) of Table 12 was thermally press-adhered onto another one surface thereof that became the outer surface side by using the laminating rolls, and the films were immediately cooled with water to obtain a resin-coated metal material.

### 3. Formation of Can Walls and Can Lids

A lubricating agent for working was applied onto the obtained resin-coated metal sheet which was, then, redrawn (drawing ratio of 2.5) to form a can wall of an inner diameter of 65.3 mm. Next, the can wall was heat-treated at 220° C. for 60 seconds to remove distortion from the resin film, followed by trimming for the opening end and flanging to form a deeply drawn can having a height of 101.1 mm. By using part of the thus obtained resin-coated metal sheet, on the other hand, a full-open lid of a 211-diameter was formed according to an established method.

### 4. Content Filling Test

To test the thus formed can wall and can lid, the can wall was filled with a meat sauce, the full-open lid was double-seamed therewith, and the retort sterilization treatment was conducted at 120° C. for 30 minutes.

### 5. Evaluation of the Surface-Treated Metal Material

Part of the inorganic surface-treated metal material of before being subjected to the organic surface treatment was measured for its weight film thickness and surface atomic ratios in the same manner as in Example 41. The results were as shown in Table 16.

### 6. Evaluation of the Containers

The containers that were formed were examined for their state of organic coating to observe any abnormal condition such as exfoliation and pitting. Further, after filled with the contents, the containers were preserved at 37° C. for 6 months, and were opened to examine the corrosion and floating of the organic coating on the inner surface side of the containers. The results were as shown in Table 16.

### Example 76

### 1. Formation of a Surface-Treated Metal Material

As a metal sheet, a cold-rolled steel sheet having a thickness of 0.17 mm and a tempering degree of DR8 was pretreated, i.e., electrolytically dewaxed, washed with water and, then, with pure water. The metal sheet was, then, plated with nickel in an amount of 0.3 g/m² on each surface, plated with tin in an amount of 0.6 g/m² on each surface, and was reflow-treated to form a nickel-tin-iron alloy layer. Thereafter, the metal sheet was subjected to the cathodic electrolysis in the treating bath O of Table 10 and to the treatment with the silane coupling agent in the same manner as in Example 75 to obtain a surface-treated metal material.

### 2. Formation of a Resin-Coated Metal Material

The thus obtained surface-treated metal material was roll-coated on both surfaces thereof with the epoxyacrylic aqueous coating material in such a manner that the thickness of the coating after baked was 10 μm, and was baked at 200° C. for 10 minutes to obtain a resin-coated metal material.

### 3. Formation of Can Walls and Can Lids

A lubricating agent for working was applied onto the obtained resin-coated metal material which was, then, drawn (drawing ratio of 1.3) to form a can wall of an inner diameter of 83.3 mm, which was, thereafter, followed by trimming for the opening end and flanging to form a drawn can having a height of 45.5 mm. By using part of the thus obtained resin-coated metal sheet, on the other hand, a full-open lid of a 307-diameter was formed according to an established method.

### 4. Content Filling Test

To test the thus formed can wall and can lid, the can wall was filled with a tuna pickle in oil, the full-open lid was double-seamed therewith, and the retort sterilization treatment was conducted at 115° C. for 60 minutes.

### 5. Evaluation of the Surface-Treated Metal Material

The inorganic surface-treating layer was measured for its weight film thickness and surface atomic ratios in the same manner as in Example 75.

### 6. Evaluation of the Containers

The containers were evaluated in the same manner as in Example 75 but, further, examining for their discoloration due to vulcanization after the cans were opened

### Example 77

### 1. Formation of a Surface-Treated Metal Sheet

As a metal sheet, a cold-rolled steel sheet having a thickness of 0.22 mm and a tempering degree of T4 was pre-treated, i.e., electrolytically dewaxed, washed with an acid, washed with water, washed with pure water and was, then, plated with tin in an amount of 2.0 g/m² on each surface and was reflow-treated, followed by the cathodic treatment in the same manner as in Example 41 but conducting the cathodic electrolysis in the treating bath L of Table 10 at a current density of 0.6 A/dm² flowing the current for 0.6 seconds and halting the current for 0.4 seconds repetitively 16 times to thereby obtain a surface-treated metal material for producing can walls.

Further, a cold-rolled steel sheet having a thickness of 0.21 mm and a tempering degree of T4, too, was treated in the same manner as described above to obtain a surface-treated metal sheet for producing can lids.

### 2. Formation of a Resin-Coated Metal Material, Can Walls and Can Lids

The surface-treated metal sheet for producing can walls was marginally coated with an epoxyacrylic aqueous coating material except those portions corresponding to the seam portions of the can wall in a manner that the film thicknesses after baking were 5 μm on the inner surface side and 3 μm on the outer surface side and was cured by baking in a hot air drying furnace for 10 minutes to obtain a resin-coated metal material. The resin-coated metal material was cut into a blank which was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness after dried was 40 μm, followed by baking in the hot air drying furnace for 3 minutes in order to obtain a welded can wall (can diameter of 65.4 mm and a can wall height of 122 mm) coating the seamed portions.

The surface-treated metal material for producing can lids, on the other hand, was roll-coated on both surfaces thereof with an epoxyacrylic aqueous coating material in a manner that the thickness of coating after baked was 10 μm followed by baking at 200° C. for 10 minutes to form a shell lid having a 209-diameter relying on an established method.

One open end of the can wall was subjected to the flanging and the necking, and the above lid of the 209-diameter was wrap-seamed therewith while the other open end thereof was subjected to the triple necking and flanging.

### 3. Content Filling Test

The can wall was filled with a coffee at 50° C., and a 206-diameter aluminum SOT lid was double-seamed therewith, and the retort sterilization treatment was conducted at 125° C. for 25 minutes.

### 4. Evaluation of the Surface-Treated Metal Material

The surface-treated metal material was measured for its weight film thicknesses and surface atomic ratios in the same manner as in Example 75.

### 5. Evaluation of the Containers

The containers were evaluated in the same manner as in Example 75 but, further, measuring the amount of iron elution after the cans were opened.

### Example 78

### 1. Formation of the Surface-Treated Metal Material

A surface-treated steel sheet for producing can walls was obtained by treating the steel sheet in the same manner as in Example 77 but plating tin in an amount of 11.2 g/m² on each surface and effecting the reflow-treatment. On the other hand, the surface-treated metal material for producing can lids was the same sheet as the sheet treated in Example 77.

### 2. Formation of a Resin-Coated Metal Material, Can Walls and Can Lids

The surface-treated metal sheet for producing can walls was cut into a blank without being coated. The blank was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness after dried was 40 μm, followed by baking in the hot air drying furnace for 3 minutes in order to obtain a can wall (can diameter of 74.1 mm and a can wall height of 81.2 mm) coating the seamed portions.

The surface-treated metal material for producing can lids, on the other hand, was roll-coated on both surfaces thereof with an epoxyacrylic aqueous coating material in a manner that the thickness of coating after baked was 10 μm followed by baking at 200° C. for 10 minutes to form a shell lid having a 301-diameter relying on an established method.

One open end of the can wall was subjected to the flanging and the necking, and the above lid of the 301-diameter was wrap-seamed therewith while the other open end thereof was subjected to the triple necking and flanging.

### 3. Content Filling Test

The can wall was hot-packed with an orange preserved in syrup, and the 301-diameter lid was double-seamed therewith, and the hot-water sterilization treatment was conducted.

### 4. Evaluation of the Surface-Treated Metal Material

The surface-treated metal material was measured for its weight film thicknesses and surface atomic ratios in the same manner as in Example 75.

### 5. Evaluation of the Containers

After preserved at 37° C. for 6 months, the containers were evaluated in the same manner as in Example 75 but further evaluating if the inner surfaces of the containers were non-uniformly discolored and if the contents were turning into brown color.

### Example 79

### 1. Formation of a Surface-Treated Metal Sheet

As a metal sheet, a cold-rolled steel sheet having a thickness of 0.22 mm and a tempering degree of T4 was pre-treated, i.e., electrolytically dewaxed, washed with an acid, washed with water, washed with pure water and was, then, plated with nickel in an amount of 0.03 g/m² on each surface, was plated with tin in an amount of 1.3 g/m² on each surface, and was reflow-treated, followed by the cathodic treatment in the treating bath L of Table 10 in the same manner as in Example 77 to thereby obtain a surface-treated metal material for producing can walls.

Further, a cold-roiled steel sheet having a thickness of 0.21 mm and a tempering degree of T4, too, was treated in the same manner as described above to obtain a surface-treated metal sheet for producing can lids.

### 2. Formation of a Resin-Coated Metal Material, Can Walls and Can Lids

The surface-treated metal material for producing can walls was marginally coated with an epoxyphenol solvent-type coating material except those portions corresponding to the seam portions of the can wall in a manner that the film thicknesses after baking were 5 μm on the inner surface side and 3 μm on the outer surface side, and was cured by baking in a hot air drying furnace for 10 minutes to obtain a resin-coated metal material. The resin-coated metal material was cut into a blank which was welded into a cylindrical shape by using a commercially available electric-resistance welding machine that uses a wire electrode. Next, the inner and outer surfaces of the weld-seamed portions of the can wall were spray-coated with a solvent-type epoxyurea repairing material in a manner that the film thickness after dried was 40 μm, followed by baking in the hot air drying furnace for 3 minutes in order to obtain a welded can wall (can diameter of 65.4 mm and a can wall height of 122 mm) coating the seamed portions

The surface-treated metal material for producing can lids, on the other hand, was roll-coated on both surfaces thereof with an epoxyphenol solvent-type coating material in a manner that the thickness of coating after baked was 10 μm followed by baking at 200° C. for 10 minutes to form a shell lid having a 209-diameter relying on an established method.

One open end of the can wall was subjected to the flanging and the necking, and the above lid of the 209-diameter was wrap-seamed therewith while the other open end thereof was subjected to the triple necking and flanging.

### 3. Content Filling Test

The can wall was hot-packed with an orange juice at 93° C., and a commercially available 206-diameter aluminum SOT lid was double-seamed therewith to seal.

### 4. Evaluation of the Surface-Treated Metal Material

The surface-treated metal material was measured for its weight film thicknesses and surface atomic ratios in the same manner as in Example 75.

### 5. Evaluation of the Containers

The containers were evaluated in the same manner as in Example 77.

### Example 80

### 1. Formation of a Surface-Treated Metal Sheet

As a metal sheet, a cold-rolled steel sheet having a thickness of 0.195 mm and a tempering degree of T3 was pre-treated, i.e., electrolytically dewaxed, washed with an acid, washed with water, washed with pure water and was, then, plated with tin in an amount of 1.0 g/m² on each surface, followed by the cathodic treatment in the treating bath L of Table 10 in the same manner as in Example 77 to thereby obtain a surface-treated metal material for producing can walls.

Further, a surface-treated metal material for producing can lids was obtained in the same manner as in Example 71 but using, as a metal sheet, an aluminum alloy sheet, JIS 5182H19, having a thickness of 0.285 mm and conducting the cathodic electrolysis in the treating bath L of Table 10 at a current density of 5 A/dm² flowing the current for 0.6 seconds and halting the current for 0.4 seconds repetitively 8 times.

### 2. Formation of a Resin-Coated Metal Material

The thus obtained surface-treated metal material for producing can walls and can lids was heated at 220° C., the lower layer side of the cast film (1) shown in Table 12 was thermally press-adhered onto one surface of the metal material, the cast film (k) of Table 12 was thermally press-adhered onto another one surface thereof that became the outer surface side by using the laminating rolls, and the films were immediately cooled with water to obtain a resin-coated metal material.

### 3. Formation of the Can Walls and Can Lids

A paraffin wax was electrostatically applied onto both surfaces of the resin-coated metal material for producing can walls, which was, then, punched into a circular shape of a diameter of 140 mm and from which a shallowly drawn cup was formed relying on an established method. The thus drawn cup was subjected to the redraw/ironing working two times repetitively to form a deeply drawn and ironed cup having a small diameter and a large height. The thus obtained cup possessed the following characteristics.

| | |
|---|---|
| Cup diameter | 52 mm |
| Cup height | 138 mm |
| Thickness of can wall relative to the | −50% |
| initial sheet thickness | |

After subjected to the doming, the cup was heat-treated at 220° C. for 60 seconds to remove distortion from the resin film, followed by trimming for the opening end, printing on the curved surface, necking for forming a 200-diameter, flanging and re-flanging to obtain a 250-g seamless can.

From the resin-coated metal material for producing can lids, further, SOT lids of a 200-diameter were formed.

### 4. Content Filling Test

The above 250-g can was cold-packed with a coke at 5° C., and, immediately thereafter, the above SOT lid was double-seamed therewith to seal.

### 5. Evaluation of the Surface-Treated Metal Material

The surface-treated metal material was measured for its weight film thicknesses and surface atomic ratios in the same manner as in Example 75.

### 5. Evaluation of the Containers

The containers were evaluated in the same manner as in Example 77.

### Example 81

### 1. Formation of a Surface-Treated Metal Material and a Resin-Coated Metal Material

An aluminum alloy sheet, JIS 3004H19, having a thickness of 0.28 mm was used as a metal sheet for producing can walls and an aluminum alloy sheet, JIS 5182H19, having a thickness of 0.25 mm was used as a metal sheet for producing can lids. These aluminum alloy sheets were pre-treated in the same manner as in Example 72 but intermittently conducting the cathodic electrolysis in the treating bath L of Table 10 at a current density of 10 A/dm² and flowing the current for 0.4 seconds and halting the current for 0.6 seconds repetitively 2 times to obtain a surface-treated aluminum sheet. The resin coatings were formed in the same manner as in Example 75 but coating both surfaces with the cast film (m) of Table 12.

A paraffin wax was electrostatically applied onto both surfaces of the resin-coated metal material for producing can walls, which was, then, punched into a circular shape of a diameter of 166 mm and from which a shallowly drawn cup was formed relying on an established method. The thus shallowly drawn cup was subjected to the redraw/ironing working and to the deep-draw/ironing working to form a can body. The thus obtained can body possessed the following characteristics.

| | |
|---|---|
| Can body diameter | 66 mm |
| Can body height | 128 mm |
| Thickness of can wall relative to the | −63% |
| initial sheet thickness | |

After subjected to the doming, the can body was heat-treated at 220° C. for 60 seconds to remove distortion from the resin film, followed by trimming for the opening end, printing on the curved surface, necking for forming a 206-diameter, flanging and re-flanging to obtain a 350-g seamless can according to an established method. From the resin-coated metal material for producing can lids, further, SOT lids of a 206-diameter were formed according to an established method.

### 2. Content Filling Test

The above 350-g can was cold-packed with a beer at 5° C., and the above SOT was double-seamed therewith to seal.

### 3. Evaluation of the Surface-Treated Metal Material

The surface-treated metal material was measured for its weight film thicknesses and surface atomic ratios in the same manner as in Example 75.

### 4. Evaluation of the Containers

The containers were evaluated in the same manner as in Example 72 but further measuring the amount of aluminum elution after the containers were opened.

### Table 10.

TABLE 10

| Treating | Al | Zr | Ti | F | B |
|---|---|---|---|---|---|
| bath | mol/l | mol/l | mo/l | mo/l | mo/l |
| L | 0.02 | — | — | — | — |
| M | 0.02 | — | — | 0.02 | 0.05 |
| N | 0.01 | — | — | — | — |
| O | 0.01 | — | — | 0.02 | 0.05 |
| P | 0.01 | — | — | 0.15 | — |
| Q | 0.01 | — | — | 0.07 | — |
| R | 0.02 | — | — | — | — |
| S | 0.02 | — | — | — | — |
| T | 0.01 | — | — | 0.01 | — |
| U | 0.01 | 0.003 | — | — | — |
| V | 0.01 | — | 0.004 | — | — |
| W | 0.02 | 0.003 | 0.003 | — | — |
| X | 0.04 | — | — | 0.01 | — |
| Y | 0.07 | — | — | — | — |
| Z | 0.01 | — | — | 0.25 | — |

TABLE 11

| | Polyester component | | | | | Titanium |
|---|---|---|---|---|---|---|
| | | Copolymerized | | Ionomer | Tocopherol | dioxide |
| | Copolymerrizable | ratio | Content, | Content, | Content, | Content, |
| | component | mol % | wt % | wt % | wt % | wt % |
| G | isophthalic | 12 | 100 | — | — | — |
| | acid | | | | | |
| H | isophthalic | 5 | 100 | — | — | — |
| | acid | | | | | |
| I | isophthalic | 5 | 84 | 15 | 1 | 1 |
| | acid | | | | | |
| J | isophthalic | 12 | 75 | — | — | — |
| | acid | | | | | |
| K | isophthalic | 15 | 84 | 15 | 1 | 1 |
| | acid | | | | | |
| L | Isophthalic | 15 | 100 | — | — | — |
| | acid | | | | | |

TABLE 12

| | |
|---|---|
| Surface layer | Lower layer |

| | Resin | Thickness | Resin | Thickness |
|---|---|---|---|---|
| | composition | (μm) | composition | (μm) |
| (h) | B | 5 | C | 25 |
| (i) | C | 30 | — | — |
| (j) | A | 5 | D | 10 |
| (k) | B | 5 | E | 25 |
| (l) | B | 5 | E | 10 |
| (m) | B | 5 | F | 10 |
| (n) | F | 30 | — | — |

TABLE 13

| | Wt. | | | | | | Surface |
|---|---|---|---|---|---|---|---|
| | film thickness | | | Surface | | | exposure |
| | (mg/m²) | | | atomic ratio | | | ratio |
| | Al | Zr | Ti | O/M | F/M | (P + S)/M | (Sn %) |
| Ex. 41 | 14 | — | — | 2.23 | 0.11 | 0.00 | 1.5 |
| Ex. 42 | 28 | — | — | 1.80 | 0.60 | 0.00 | 1.2 |
| Ex. 43 | 15 | — | — | 2.36 | 0.06 | 0.00 | 1.3 |
| Ex. 44 | 15 | — | — | 2.25 | 0.06 | 0.00 | 0.5 |
| Ex. 45 | 37 | — | — | 1.90 | 1.02 | 0.00 | 0.3 |
| Ex. 46 | 9 | — | — | 1.92 | 0.76 | 0.00 | 0.3 |
| Ex. 47 | 42 | — | — | 1.74 | 0.42 | 0.00 | 0.2 |
| Ex. 48 | 14 | — | — | 1.65 | 1.10 | 0.00 | 0.6 |
| Ex. 49 | 42 | — | — | 1.83 | 2.25 | 0.00 | 0.3 |
| Ex. 50 | 75 | — | — | 2.23 | 1.92 | 0.00 | 0.1 |
| Ex. 51 | 30 | — | — | 3.06 | 0.03 | 0.18 | 1.6 |
| Ex. 52 | 50 | — | — | 5.13 | 0.00 | 1.00 | 0.9 |
| Ex. 53 | 25 | — | — | 3.28 | 0.36 | 0.19 | 0.2 |
| Ex. 54 | 12 | 6 | — | 2.85 | 0.42 | 0.00 | 1.2 |
| Ex. 55 | 18 | — | 5 | 3.12 | 0.35 | 0.00 | 1.7 |
| Ex. 56 | 26 | 10 | 8 | 3.32 | 0.56 | 0.00 | 0.8 |
| Ex. 57 | 43 | — | — | 4.25 | 0.32 | 0.00 | 3.5 |
| Ex. 58 | 25 | — | — | 1.76 | 1.92 | 0.00 | 0.8 |
| Comp. Ex. 25 | 175 | — | — | 3.22 | 1.85 | 0.00 | 0.1 |
| Comp. Ex. 26 | 15 | — | — | 5.73 | 0.00 | 1.19 | 7.0 |
| Comp. Ex. 27 | 10 | — | — | 6.07 | 0.02 | 1.30 | 5.5 |
| Comp. Ex. 28 | 12 | — | — | 2.85 | 3.33 | 0.00 | 4.5 |
| Comp. Ex. 29 | — | — | — | — | — | — | — |
| Comp. Ex. 30 | — | — | — | — | — | — | — |
| Comp. Ex. 31 | — | 26 | — | 4.17 | 0.95 | 0.00 | 22.0 |

| | Properties | | | | |
|---|---|---|---|---|---|
| | Adhesive | Corrosion | Vulcanization | | Kind of |
| | property | resistance | resistance | Color | treatment |
| Ex. 41 | ◯ | ◯ | ◯ | ◯ | non-chrome |
| Ex. 42 | ⊚ | ⊚ | ◯ | ◯ | non-chrome |
| Ex. 43 | ◯ | ◯ | ⊚ | ◯ | non-chrome |
| Ex. 44 | ◯ | ◯ | ⊚ | ◯ | non-chrome |
| Ex. 45 | ⊚ | ◯ | ⊚ | ◯ | non-chrome |
| Ex. 46 | ◯ | ◯ | ⊚ | ◯ | non-chrome |
| Ex. 47 | ⊚ | ⊚ | ◯ | ◯ | non-chrome |
| Ex. 48 | ⊚ | ◯ | ⊚ | ◯ | non-chrome |
| Ex. 49 | ⊚ | ◯ | ⊚ | ◯ | non-chrome |
| Ex. 50 | ◯ | ◯ | ◯ | ◯ | non-chrome |
| Ex. 51 | ◯ | ◯ | ◯ | ◯ | non-chrome |
| Ex. 52 | ◯ | ◯ | ◯ | ◯ | non-chrome |
| Ex. 53 | ◯ | ◯ | ◯ | ◯ | non-chrome |
| Ex. 54 | ◯ | ◯ | ◯ | ◯ | non-chrome |
| Ex. 55 | ◯ | ⊚ | ◯ | ◯ | non-chrome |
| Ex. 56 | ◯ | ◯ | ◯ | ◯ | non-chrome |
| Ex. 57 | Δ | ◯ | ◯ | ◯ | non-chrome |
| Ex. 58 | ◯ | ⊚ | ◯ | ◯ | non-chrome |
| Comp. | Δ | ◯ | ◯ | ◯ | non-chrome |
| Ex. 25 | | | | | |
| Comp. | Δ | Δ | ◯ | ◯ | non-chrome |
| Ex. 26 | | | | | |
| Comp. | Δ | Δ | ◯ | ◯ | non-chrome |
| Ex. 27 | | | | | |
| Comp. | Δ | Δ | ◯ | ◯ | non-chrome |
| Ex. 28 | | | | | |
| Comp. | ◯ | Δ | ◯ | ◯ | chrome |
| Ex. 29 | | | | | |
| Comp. | ◯ | ◯ | ◯ | ◯ | chrome |
| Ex. 30 | | | | | |
| Comp. | — | — | — | X | non-chrome |
| Ex. 31 | | | | | |

TABLE 14

| | Properties | | |
|---|---|---|---|
| | Adhesive | Corrosion | Vulcanization |
| | property | resistance | resistance |
| Ex. 59 | ◯ | ◯ | ⊚ |
| Ex. 60 | ⊚ | ⊚ | ⊚ |
| Ex. 61 | ⊚ | ⊚ | ⊚ |
| Ex. 62 | ◯ | ◯ | ⊚ |
| Ex. 63 | ⊚ | ⊚ | ⊚ |
| Ex. 64 | ⊚ | ◯ | ⊚ |
| Ex. 65 | ⊚ | ◯ | ⊚ |
| Ex. 66 | ⊚ | ◯ | ⊚ |
| Ex. 67 | ◯ | ◯ | ⊚ |
| Ex. 68 | ◯ | ◯ | ⊚ |
| Ex. 69 | ◯ | ◯ | ⊚ |
| Ex. 70 | ◯ | ◯ | ⊚ |
| Comp. ex. 32 | ⊚ | X | ◯ |

TABLE 15

| | |
|---|---|
| Film | |
| thickness | Surface |
| (mg/m²) | atomic ratio |

| | Al | Zr | O/M | F/M | (P + S)/M |
|---|---|---|---|---|---|
| Ex. 71, 72 | 32 | — | 1.83 | 1.73 | 0.00 |
| Ex. 73, 74 | 32 | — | 1.83 | 1.73 | 0.00 |
| Comp. Ex. 33, 35 | — | 5 | 6.00 | 0.50 | 1.20 |
| Comp. Ex. 34, 36 | — | 9 | 9.10 | 0.50 | 1.10 |
| Comp. Ex. 37, 38 | 55 | — | 5.67 | 0.02 | 0.00 |
| Comp. Ex. 39, 40 | 32 | — | 1.83 | 1.73 | 0.00 |
| Comp. Ex. 41, 42 | 23 | — | 2.20 | 0.03 | 0.09 |

M is an element (Al or Zr) representing the film thickness.

| | Properties | | | |
|---|---|---|---|---|
| | | | Close | |
| | | | adhesion | |
| | Adhesive | Lid | in hot water | Corrosion |
| | property | openability | water | resistance |
| Ex. 71, 72 | ◯ | ◯ | ⊚ | ◯ |
| Ex. 73, 74 | ⊚ | ⊚ | ⊚ | ◯ |
| Comp. Ex. 33, 35 | X | X | X | X |
| Comp. Ex. 34, 36 | X | X | X | X |
| Comp. Ex. 37, 38 | X | X | X | X |
| Comp. Ex. 39, 40 | ◯ | X | X | ◯ |
| Comp. Ex. 41, 42 | X | X | X | X |

TABLE 16

| | | Al film | | | |
|---|---|---|---|---|---|
| | | thickness | Surface atomic ratio | | |
| | Use | (mg/m²) | O/Al | F/Al | (P + S)/Al |
| Ex. 75 | can wall, | 42 | 1.54 | 1.06 | 0.00 |
| | lid | | | | |
| Ex. 76 | can wall, | 35 | 1.66 | 1.16 | 0.00 |
| | lid | | | | |
| Ex. 77 | wall | 22 | 2.08 | 0.12 | 0.00 |
| | lid | 31 | 1.92 | 0.11 | 0.00 |
| Ex. 78 | wall | 15 | 1.97 | 0.13 | 0.00 |
| | lid | 31 | 1.92 | 0.11 | 0.00 |
| Ex. 79 | wall | 35 | 2.33 | 0.15 | 0.00 |
| | lid | 43 | 2.47 | 0.11 | 0.00 |
| Ex. 80 | wall | 30 | 1.83 | 0.14 | 0.00 |
| | lid | 45 | 2.26 | 0.12 | 0.00 |
| Ex. 81 | wall | 21 | 2.45 | 0.14 | 0.00 |
| | lid | 45 | 2.38 | 0.16 | 0.00 |

| | | Evaluation of | | | | |
|---|---|---|---|---|---|---|
| | | container property | | | | |
| | Container | Inner surface of container | | | | |
| | formability | | State | Color of | Color | Metal |
| | State of | State of | of org. | inner | of the | elution |
| | org. film | corrosion | film | surface | content | (ppm) |
| Ex. 75 | normal | normal | normal | — | — | — |
| Ex. 76 | normal | normal | normal | normal | — | — |
| Ex. 77 | normal | normal | normal | — | — | 0.00 |
| Ex. 78 | normal | normal | — | — | normal | — |
| Ex. 79 | normal | normal | normal | — | — | 0.05 |
| Ex. 80 | normal | normal | normal | — | — | 0.00 |
| Ex. 81 | normal | normal | normal | — | — | 0.00 |

### INDUSTRIAL APPLICABILITY

The surface-treated metal material and the resin-coated metal material of the present invention can be effectively used, particularly, for the metal cans and can lids, as well as for automobiles, household electric appliances and building materials.

The surface treating method of the invention can also be applied to such surface-treated steel sheets as tin-plated steel sheets and zinc-plated steel sheets in addition to aluminum sheets and steel sheets. By applying to, for example, the zinc-plated steel sheets and the tin-plated steel sheets, for example, there can be obtained such synergistic effects as preventing zinc and tin from corroding while imparting close adhesion and corrosion resistance due to the non-chrome surface treatment. Therefore, a variety of kinds of base members can be treated to offer surface-treated steel sheets that can be used in a wide range of applications.

1. A surface-treated metal material having, formed on the surf ace of a metal base member, a surface-treating layer that contains inorganic components, the inorganic surface-treating layer containing at least Ti, O and F but without containing phosphoric acid ions.

2. The surface-treated metal material according to claim 1, wherein said surface-treating layer contains Zr.

3. The surface-treated metal material according to claim 1, wherein the atomic ratio of P and M (M is Ti or Ti and Zr) contained in the most surface portion of said surface-treating layer is 0≦P/M<0.6.

4. The surface-treated metal material according to claim 1, wherein the atomic ratio of 0 and M (M is Ti or Ti and Zr) contained in the most surface portion of said surface-treating layer is 1<O/M<10.

5. The surface-treated metal material according to claim 1, wherein the atomic ratio of F and M (M is Ti or Ti and Zr) contained in the most surface portion of said surface-treating layer is 0.1<F/M<2.5.

6. A surface-treated metal material having, formed on the surface of a metal base member, a surface-treating layer that contains inorganic components, the inorganic surface-treating acid ions.

7. A surface-treated metal material having, formed on the surface of a metal base member, a surface-treating layer (A) that contains inorganic components and an organic surface-treating layer (B) that contains organic components, the inorganic surface-treating layer (A) containing M (M is Ti and/or Zr), O and F.

8. The surface-treated metal material according to claim 7, wherein said inorganic surface-treating layer (A) contains no phosphoric acid ion.

9. The surface-treated metal material according to claim 7, wherein the atomic ratio of P and M (M is Ti and/or Zr) contained in the most surface portion of said inorganic surface-treating layer (A) is 0≦P/M<0.6.

10. The surface-treated metal material according to claim 7, wherein the atomic ratio of 0 and M (M is Ti and/or Zr) contained in the most surface portion of said inorganic surface-treating layer (A) is 1<O/M<10.

11. The surface-treated metal material according to claim 7, wherein the atomic ratio of F and M (M is Ti and/or Zr) contained in the most surface portion of said inorganic surface-treating layer (A) is 0.1<F/M<2.5.

12. The surface-treated metal material according to claim 7, wherein the inorganic surface-treating layer (A) contains SiO₂ particles.

13. The surface-treated metal material according to claim 7, wherein said organic surface-treating layer (B) is a silane coupling agent treating layer containing Si in an amount of 0.8 to 30 mg/m².

14. The surface-treated metal material according to claim 7, wherein said organic surface-treating layer (B) is an organic surface-treating layer comprising a phenol-type water-soluble organic compound.

15. A method of treating the surfaces of a metal base member by forming an inorganic coating on the surfaces of the metal base member by the cathodic treatment in an aqueous solution containing Ti and F, and having a phosphoric acid ion concentration calculated as PO₄ of smaller than 0.003 mols/liter.

16. The method of treating the surfaces according to claim 15, wherein said aqueous solution contains Zr.

17. The method of treating the surfaces according to claim 15, wherein said aqueous solution contains M (M is Ti or Ti and Zr) in an amount of 0.010 to 0.050 mols/liter and F in an amount of 0.03 to 0.35 mols/liter as bath concentrations.

18. The method of treating the surfaces according to claim 15, wherein said aqueous solution contains water-dispersing silica.

19. The method of treating the surfaces according to claim 15, wherein the cathodic treatment is intermittently conducted.

20. A method of treating the surfaces of a metal base member by forming an inorganic coating on the surfaces of the metal base member by the cathodic treatment in an aqueous solution containing Zr, F and water-dispersing silica, and having a phosphoric acid ion concentration calculated as PO₄ of smaller than 0.003 mols/liter.

21. The method of treating the surfaces according to claim 20, wherein said aqueous solution contains Zr in an amount of 0.010 to 0.050 mols/liter and F in an amount of 0.03 to 0.35 mols/liter as bath concentrations.

22. The method of treating the surfaces according to claim 20, wherein said cathodic treatment is intermittently conducted.

23. A surface-treated metal material having, formed on the surface of a metal base member (excluding the case when the metal base member is Al), an inorganic surface-treating layer that contains at least Al and O.

24. A surface-treated metal material having an inorganic surface-treating layer formed on the surface of a metal base member by the precipitation from an aqueous solution by cathodic electrolysis, said inorganic surface-treating layer containing at least Al, O and F, and the atomic ratio of F and M (M is Al or Al and at least one of Ti or Zr) contained in the most surface portion of the inorganic surface-treating layer being 0.1<F/N.

25. The surface-treated metal material according to claim 23, wherein said inorganic surface-treating layer contains a hydroxide of aluminum or an oxyhydroxide thereof.

26. The surface-treated metal material according to claim 23, wherein said inorganic surface-treating layer contains at least one of Zr or Ti.

27. The surface-treated metal material according to claim 23, wherein the atomic ratio of O and M (M is Al or Al and at least one of Ti or Zr) contained in the most surface portion of the inorganic surface-treating layer is 1<O/M<5.5.

28. The surface-treated metal material according to claim 23, wherein the atomic ratio of F and M (M is Al or Al and at least one of Ti or Zr) contained in the most surface portion of the inorganic surface-treating layer is F/M<2.5.

29. The surface-treated metal material according to claim 23, wherein the atomic ratio of (P+S) and M (M is Al or Al and at least one of Ti or Zr) contained in the most surface portion of the inorganic surface-treating layer is (P+S)/M<0.25.

30. The surface-treated metal material according to claim 23, wherein said inorganic surface-treating layer has a thickness, calculated as a weight film thickness of Al, of 5 to 100 mg/m².

31. The surface-treated metal material according to claim 23, wherein said metal base member is a surface-treated steel sheet having a plated layer containing one or more of tin, nickel, zinc and iron.

32. The surface-treated metal material according to claim 23, wherein said metal base member has a surface exposure ratio of chief elements of smaller than 5%.

33. The surface-treated metal material according to claim 23, wherein an organic surface-treating layer comprising chiefly a silane coupling agent is formed in an amount calculated as Si of 0.8 to 30 mg/m² on said inorganic surface-treating layer.

34. The surface-treated metal material according to claim 23, wherein an organic surface-treating layer comprising chiefly a phenol-type water-soluble organic compound is formed on said inorganic surface-treating layer.

35. A method of treating the surfaces of a metal base member by forming a coating containing a hydroxide of aluminum or an oxyhydroxide thereof on the surface of the metal base member by the cathodic treatment in an aqueous solution having an Al 3.5 ion concentration in a range of 0.001 to 0.05 mols/liter.

36. The method of treating the surfaces according to claim 35, wherein said aqueous solution contains F ions.

37. A resin-coated metal material obtained by coating at least one surface of a surface-treated metal material with an organic resin, the surface-treated metal material having, formed on the surface of a metal base member, an inorganic surface-treating layer containing Ti and/or Al, O and F.

38. The resin-coated metal material according to claim 37, wherein said inorganic surface-treating layer contains Zr.

39. A resin-coated metal material obtained by coating at least one surface of a surface-treated metal material with an organic resin, the surface-treated metal material having an inorganic surface-treating layer containing at least any one of Ti, Zr or Al, as well as O and F, and having an organic surface-treating layer comprising chiefly a silane coupling agent formed in an amount, calculated the amount of Si, of 0.8 to 30 mg/m² on said inorganic surface-treating layer or having an organic surface-treating layer comprising chiefly a phenol-type water-soluble organic compound formed on said inorganic surface-treating layer.

40. A metal can formed by using the resin-coated metal material of any one of claims 37 to 39.

41. A can lid formed by using the resin-coated metal material of any one of claims 37 to 39.
